(19) United States
(12) Patent Application Publication
(10) Pub. No.: US 2013/0013685 A1
(43) Pub. Date: Jan. 10, 2013

(54) Social Networking Environment with Representation of a Composite Emotional Condition for a User and/or Group of Users

(75) Inventors: Jon J. Moses, New York, NY (US); John James, Long Island City, NY (US)

(73) Assignee: Bagooba, Inc., New York, NY (US)

(21) Appl. No.: 13/439,339

(22) Filed: Apr. 4, 2012

Related U.S. Application Data
(60) Provisional application No. 61/471,562, filed on Apr. 4, 2011.
(60) Provisional application No. 61/522,200, filed on Aug. 10, 2011.

(51) Int. Cl. G06F 15/16

(52) U.S. Cl. 709/204

(57) ABSTRACT

A social networking method, implemented over a computer network and using a computer process, generates a digital output that is representative of a composite emotional condition for a first user based on data representative of the first user's emotional condition and data representative of such another user's emotional condition.

### PRIORITY

This patent application claims priority from provisional U.S. provisional patent application No. 61/471,562 , filed Apr. 4, 2011, entitled, “Social Networking Environment with Representation of a Composite Emotional Condition for a User” and naming Jon J Moses as inventor, and also claims priority from provisional U.S. provisional patent application No. 61/522,200, filed Aug. 10, 2011, entitled, “Social Networking Environment with Representation of a Composite Emotional Condition for a User” and naming Jon J Moses and John James as inventors, the disclosures of which are incorporated herein, in their entirety, by reference.

### TECHNICAL FIELD

The present invention relates to social networks established using web servers.

### BACKGROUND ART

It is known in the prior art to establish social networks using web servers. Representative networks include Facebook having a URL of facebook.com and LinkedIn, having a URL of linkedin.com. Social networks allow participants to share information. Some social networks, like Twitter, having a URL of twitter.com, emphasize sharing of information in real time.

### SUMMARY OF THE EMBODIMENTS

In a first embodiment of the invention there is provided a social networking method, implemented over a computer network with respect to (a) a first user operating a client coupled to the network and (b) a set of other users in the user's social network, the set having at least one member, each member of the set operating a client coupled to the network, the method using computer processes. The method includes the steps of receiving over the network, from the first user's client, first user data representative of the first user's emotional condition; receiving over the network, from each client of each of the other users in the set, outside data representative of such other user's emotional condition; storing the first user data and the outside data; using the first user data and the outside data in an algorithm to generate a digital output that is representative of a composite emotional condition for the first user; and communicating the digital output to the first user's client over the network.

In an alternate embodiments, the computer processes further includes causing the digital output to be represented on the first user's client at least in part by a graphical image. In some embodiments, the computer processes further includes, with respect to each of the other users, generating a digital output that is representative of a composite emotional condition for such other user, such output reflecting in part emotional condition data for users other than such other user, and communicating the digital output to such other user's client over the network.

In some embodiments, the method further includes communicating the digital output that is representative of a composite emotional condition for the first user to a second set of users with whom the first user has agreed to share the digital output.

In some embodiments, the digital output that is representative of a composite emotional condition for the first user includes a numerical score therefor, and in some embodiments, the digital output includes data for a graphic representation of the composite emotional condition for the first user. In some embodiments, the graphic representation of the composite emotional condition for such other user includes a graphical representation of a weather state.

In another embodiment, the graphical image includes an anthropomorphic portion having characteristics that change dynamically in response to changes in digital output that is representative of a composite emotional condition for the first user, and in another embodiment, the graphical image includes an image of a person. In some embodiments, wherein the anthropomorphic characteristics include facial features, while in some embodiments the anthropomorphic characteristics include posture of a person.

In some embodiments, the first user data representative of the first user's emotional condition is numeric and is based at least in part on an input by the first user that is a self-assessment of the first user's emotional condition, while in some embodiments the outside data representative of each such other user's emotional condition is numeric and is based on an input by such other user that is a self-assessment of each such other user's emotional condition.

In some embodiments, the first user data representative of the first user's emotional condition also includes postings and responses by the first user, and in some embodiments the outside data representative of each of such other users' emotional condition also includes responses by each such other user to postings and responses by the first user.

In some embodiments, the operation of the algorithm is event-driven, by a new posting or response implicating the first user.

In some embodiments, the first user data provided to the algorithm includes frequency of changes by the first user of such user's self-assessment as an input, and in some embodiments, the frequency of the changes by the first user of such first user's self-assessment is an input to the algorithm to the exclusion of the first user's self-assessment itself.

### BRIEF DESCRIPTION OF THE DRAWINGS

The foregoing features of embodiments will be more readily understood by reference to the following detailed description, taken with reference to the accompanying drawings, in which:

FIG. 1 is a block diagram of architecture of a system in accordance with an embodiment of the present invention;

FIG. 2 is a block diagram of logical flow of the web server 11 of FIG. 1 in serving clients of users of the system of FIG. 1;

FIG. 3 is a block diagram of logical flow of processes carried out by the Chi algorithm engine of FIGS. 1 and 2;

FIGS. 4-41 are representations of computer displays constituting a user interface in accordance with an embodiment of the present invention;

FIG. 4 is a representation of the homepage experienced by a user;

FIG. 5 shows the modification of the homepage when the user invokes detail showing how others are affecting his Chi score;

FIG. 6 shows further detail obtainable from the screen of FIG. 5 when the user seeks detail from that screen of a butterfly effect therein shown;

FIG. 7 shows how a notification is displayed on the screen of FIG. 5;

FIG. 8 shows the interaction experienced by a user on the homepage of FIG. 4 who seeks to adjust the I'm Feeling graphic 413;

FIG. 9 shows the interaction experienced by user on the homepage of FIG. 4 who invokes the alert button 414;

FIG. 10 shows the interaction experienced by a user on the homepage of FIG. 4 who invokes the alert button 414 when an alert is already being displayed;

FIG. 11 shows the interaction experienced by user on the homepage of FIG. 4 who invokes the public message graphic 410 or alternatively the private message 411;

FIG. 12 shows the interaction experienced by user on the homepage of FIG. 4 who invokes the graphical representation of a gift 412;

FIG. 13 shows the interaction experienced by user on the homepage of FIG. 4 who invokes a thumbnail of an individual who is in My Chi-Munity;

FIG. 14 shows the interaction experienced by user on the homepage of FIG. 4 who seeks to reorganize, add or remove members from My Seven;

FIG. 15 shows the interaction experienced by user on the homepage of FIG. 4 who invokes a search;

FIG. 16 shows the interaction experienced by user on the homepage of FIG. 4 who invokes the My Activity tab;

FIG. 17 shows the interaction experienced by user on the screen of FIG. 16 who invokes an event that affects the user's My Chi;

FIG. 18 shows the interaction experienced by a user, having invoked an event that affects the user, for selecting a gift to give to another member;

FIG. 19 shows the interaction experienced by a user, having invoked the My Gifts tab of FIG. 4, and seeking display of gifts received by the user;

FIG. 20 shows the profile of an individual whom the user is not tapped into;

FIG. 21 shows the profile of an individual whom the user is tapped into but who is not tapped into the user;

FIG. 22 shows the profile of a an individual whom the user is tapped into and who is also tapped into the user;

FIG. 23 shows the profile of an individual and who is in the user's My Seven;

FIG. 24 shows the profile of an individual who has been invited to join the My Chi website but who has not yet joined;

FIG. 25 is a representation of a screen for displaying the top 10 events affecting the Chi of an individual whose profile is being viewed by the user;

FIG. 26 is a representation of a screen for displaying a post from an individual whose profile is being viewed by the user;

FIG. 27 is a representation of a screen for displaying each of the individuals that are connected to both the user and the individual whose profile is being viewed by the user;

FIG. 28 is a representation of a screen allowing a user to adjust and post how the user is feeling about a relationship;

FIG. 29 is a representation of a screen informing the user that a relationship sought to be invoked by the user is private;

FIG. 30 is a representation of a screen by which a user may create the user's My Chi-Munity;

FIG. 31 is a representation of a typical screen display for use on an iPad device;

FIGS. 32-41 are representations of typical screen displays for use on an iPhone;

FIG. 32 is a representation of the homepage display for use on an iPhone;

FIG. 33 is a representation of the homepage of FIG. 32 but with full-screen images invoked;

FIG. 34 is a representation of a screen for defining an alert;

FIG. 35 is a representation of a screen for providing a setting for I'm Feeling;

FIG. 36 is a representation of a display of My Seven;

FIG. 37 is a representation of a display of My Seven as in FIG. 36, wherein there has been a sort according to a specified criterion;

FIG. 38 is a representation of a display of My Activity;

FIG. 39 is a representation of a display providing a notification;

FIG. 40 is a representation of a display of connections that the user has in common with an individual whose Chi-Munity is being viewed by the user; and

FIG. 41 is a representation of a display of connections that the user has in common with individuals of the relationship being viewed by the user.

FIGS. 42A-42C are illustrations of avatars;

FIGS. 43A-43D are illustrations of a set of pages in one embodiment;

FIGS. 44-A-44C are illustrations of a set of pages in one embodiment;

FIGS. 45A-45F are illustrations of a set of pages in one embodiment;

FIGS. 46A-46AE are illustrations of a set of pages in another embodiment;

FIGS. 47A-47F are illustrations of a weather conditions.

### DETAILED DESCRIPTION OF SPECIFIC EMBODIMENTS

An embodiment of the present invention is implemented by a web server configured to provide a web site with the URL “WeChi.com”. However, this URL is merely exemplary, and any suitable URL may be employed. This embodiment is described in detail below. We have developed a set of terms applicable to this web site (sometimes referred to as “the site”), including terms actually used on the web site For convenience, we have identified five categories of such terms, as follows:

1. Universal

2. Navigation

3. Actions

4. Elements

5. Algorithm

Definitions for terms in each of these five categories are provided below, along with additional definitions that do not fall into these categories.

Definitions. As used in this description and the accompanying claims, the following terms shall have the meanings indicated, unless the context otherwise requires:

1. Universal

The term “WeChi.com” means the URL of the web site established by the web server in accordance with an embodiment of the present invention.

The term “The Mark” means the graphic symbol representing “Chi” in “WeChi.com”.

The term “Tap Into My-Chi” is the tagline for “WeChi.com”.

The term “Chi” means Energy of Life and is a common denominator of “WeChi.com”; it is represented by a number in accordance with an embodiment herein described.

The term “My-Chi” is a “member's” “score”. However it may sometimes refer to the “member's” “world” in “WeChi.com”.

The term “Score” means a number representing a “member's” “Chi”. Similar terms include “WeChi points” and “Chi-score.”

The term “World” means a graphical representation of a “member's” “Chi”.

The term “Tap” (or “Listen” or “Listen To”) refers to a method by which a given “member” can select another “member” to influence the “Chi” of the given member. For usages see below. A Tap need not be bi-directional, so that the fact that a given member has selected another member to influence the Chi of the given member does not mean that the selected member has tapped into the Chi of the given member.

The term “Taps” may refer to the relationships with other “Members” that a given “Member” has established.

The term “Chi-munity” refers to a constellation of “Taps” of a given “Member” (or, alternately, the constellation of other members to which a user Listens, or is Listing To), namely the constellation of relationships with other “Members” that a given “Member” has established. The other members of that constellation may be known as “Peeps.”

The term “Butterfly Effect” refers to the consequences of a “member's” “actions” on the “Chi” of other “members”, and in particular where there is a cascading effect through more than one layer of Taps.

The term “Good-Chi” means positive energy.

The term “Bad-Chi” means negative energy.

The term “Chi-On” signifies active membership in “WeChi.com”.

The term “Chi-Off” signifies deactivation of membership in “WeChi.com”.

The term “I'm Feeling” refers to the primary graphical navigation element that enables a “member” to easily “adjust” how such person is shown to be feeling through a graphical interface. As explained in further detail below in connection with operation of the Chi algorithm, the “I'm Feeling” element in various embodiments is distinct from a member's Chi.

The term “Sevens” refers to the primary navigation element where a given “member” can prioritize and monitor seven other “members” of such “member's” “Chi-munity”. (Although we have picked the number 7 to use here, many other numbers are equally possible, such as 9 or 5, for example, to identify the specific members whom the user wishes to have priority ranking)

The term “Alignment” refers to the graphical display of a “member's” alignment with another member.

2. Navigation

The term “Home” refers to the primary navigation element that features a “member's” “Chi-munity” and “activity”.

The term “I'm Feeling” refers to the primary graphical navigation element that enables a “member” to easily “adjust” how such person is shown to be feeling through a graphical interface.

The term “Sevens” refers to the primary navigation element where a given “member” can prioritize and monitor seven other “members” of such “member's” “Chi-munity”.

The term “Gifts” storage refers to a primary navigation element by means of which a “member” can cause storage of items that may be given away.

The term “Status” refers to a view of another “member's” “I'm Feeling” page.

The term “Search” refers to the primary navigation element by which a “member” can find something of interest.

The term “Account” refers to the primary navigation element that a “member” selects to make adjustments to “settings” and “privacy”.

The term “Log-out” refers to the primary navigation element that ends a “member's” “active session”.

The term “Relationships” refers to the secondary navigation element that allows a “member” to “create” and access “relationships”.

The term “Notification” refers to a representation of a new “activity” that appears on a screen available to a “member”.

The term “History” refers to a “member's” archive of “activity”.

The term “Help” refers to a “member”-accessible web page on the site providing answers to FAQs.

The term “About” refers to a “member”-accessible web page on the site providing information about the site.

3. Actions

The term “Invite(s)” means the act of inviting a third party to join “WeChi.com”.

The term “Accept” means an affirmative “action”.

The term “Decline” means a negative “action”.

The term “Register” means a method by which a new “member” “registers”.

The term “Turn it on” refers to a method of finalizing “registration”.

The term (Chi) “On” refers to the result of successful “registration”.

The term “Tap” refers to a method by which a given “member” can select another “member” to influence the “Chi” of the given member. Uses include:

“To Tap” I want to “tap” your “Chi”.

“Tapped” I have “tapped” your “Chi”.

“Tap into” “Tap into” her Chi.

“Tapped into” I “tapped into” her “Chi”.

“Tapping” I plan on “tapping” your “Chi”.

“Tapping into” I plan on “tapping into” your Chi.

“You've been Tapped” “You've been Tapped”.

Similarly, the term “Listen” refers to a method by which a given “member” can select another “member” to influence the “Chi” of the given member. Uses include:

“To Listen” I want to Listen to you

“Listening” I am Listening to your Chi

The term “Share” refers to a method by which a “member” can save, finalize and provide to others in the social network access selected information pertinent to the member.

The term “Gifting” refers to the transfer to another “Member” by a given “Member” of something without the expectation of receiving anything in return.

The term “Re-Gifting” refers to the sharing of a gift received from another “member”.

The term “Edit” refers to a method by which a “member” can alter certain classes of data on the site.

The term “Bumping” is the process of re-assigning a seven to a specific “rank” that is less than the 7th “seven”.

The term to “Text” refers to a method by which a “text” message is entered by a “member” via the site.

The term “Adjust” refers to a method by which a “member” makes an iterative change in a parameter, such as “I'm Feeling”, pertinent to the “member”.

The term “Create” refers to a method by which a “member” defines a “Relationship”.

The term “Request(s)” refers to a “member's” act of requesting, or being requested.

The term “Select” refers to an act of choosing by a “member”.

The term “Upload” refers to an act of uploading a file from a member's client to the site.

The term “Engage” means to interact with a “member”.

The term “Rank” means to order one or more “members” in the “sevens”.

The term “Leveling Up” means for a “member” to advance from one level of game-play to the next by accomplishing specific “quests” established on the site.

The term “Blocking” means restricting account access by a specified “member”.

4. Elements

The term “Member” refers to anyone or anything who has “registered” and chosen a “member name”.

The term “Member Name” refers to a unique name assigned to a given “Member” based on a determination thereof by the given “member”.

The term “First Name” refers to the first name provided by a given “member” at “registration” by the given “member”.

The term “Last Name” refers to the family name provided by a given “member” at “registration” by the given “member”.

The term “Location” refers to the location provided by a given “member” at “registration” by the given member.

The term “Email” refers to the email address provided by a given “member” at “registration” by the given member.

The term “Confirmation Email” refers to an email, sent to a new “member”, after “registration” and account activation; the email includes a unique link that verifies the action.

The term “Password” refers to the password provided by given user at “registration” by the given user.

The term “Weak Password” refers to a “password” having 4-8 alphanumeric characters.

The term “Strong Password” refers to a “password” having more than 8 characters that includes both letters and numbers.

The term “Chi-munity” refers to a constellation of “Taps” of a given “Member”, namely the constellation of relationships with other “Members” that a given “Member” has established.

The term “Avatar” refers to a graphical object used to represent an emotional state of a “member”.

The term “Weather” refers to a graphical representation of a “member's” “Trends”.

The term “Dendroid” refers to a specific Level 1 “avatar”: a tree-like form (fantasy).

The term “Bark” refers to another specific Level 1 “avatar”: an oak-like tree.

The term “Blossom” refers to yet another specific Level 1 “avatar”: a blossoming tree.

The term “Fireworks” refers to a Level 1 “alert”, and signifies a positive event.

The term Flare” refers to a Level 1 “alert”, and signifies a negative event.

The term “Thumbnail” refers to the image representing another “member” with whom a given member has a “relationship” on a web page from the site accessed by the given “member”.

The term “Activity” refers to a record of all actions within a “member's” “Chi-munity”.

The term “Sort” refers to a functionality that allows a “member” to filter the “Chi-munity” and “search” results.

The term “Creator” refers to a “member” who “creates”, names, and administers a “relationship”.

The term “Relationship(s)” refers to a “member's” personal connection(s) to a named “avatar”.

The term “My-World” refers to the graphical representation of a “member's” “Chi”.

The term “Settings” refers to a set of parameters, relating to content of, use of, and access to a given “member's” personal information, controlled by the given “member”.

The term “Privacy” refers to the ability of a “member” to control visibility and accessibility of such member's personal information.

The term “Gift” refers to an object of value.

The term “Alert” refers to a positive or negative graphical communication posted by a “member”.

The term “Currency” refers to a medium of exchange within “WeChi.com”.

The term “Quest” refers to a mission-like objective capable of being undertaken by a “member” on the site.

The term “Badge” refers to a social proof of achievement displayable by a “member” on the site.

The term “Level” refers to a milestone achieved by a “member”.

The term “Verified Account” refers to a “member” who has been verified by “WeChi.com”.

The term “Engagement” refers to “Activity” within a “member's” “Chi-munity”.

The term “Active Session” of a given “member” refers to a condition wherein the given “member” is logged into “WeChi.com”.

The term “Tips” refers to Helpful hints.

The term “Seven” refers to “Members” or “relationships” included in “My-S even”.

The term “Trending Arrows” refers to Directional arrows that indicate the direction of a “member's” “trends”.

The term “ I'm Feeling” refers to a graphical interface whereby a given “member” can “adjust” a representation of such “member's” emotional state.

The term “Effect” refers to the consequence of an “action”.

The term “Significant Effect” in relation to a given “member” refers to an “effect” that results in an algorithmically determined change in “Chi” of the given “member”.

The term “Authenticated” refers to systems verification that an “email” address is real.

The term “Verification” refers to the method by which an “email” address is authenticated.

The term “Public View” refers to any view by a given “member” of another “member's” data

The term “Header” refers to a navigation masthead at the top of each view.

The term “Drawer” refers to an interaction field that opens after the selection of a button or navigation link.

The term “Posts” refers to all saved “shares” by a “member” on an “I am feeling” “avatar” and on a “relationship” “avatar”.

The term “Thread” refers to all “engagement” taken on a “post” and viewed in a “member's” “history”.

The term “Time Stamp” refers to the time recorded on each “shared” “engagement”.

The term “Active Session” of a given “member” refers to a condition wherein the given “member” is logged into “WeChi.com”.

5. Algorithm

The term “Algorithm” refers to the adaptive logical processing performed in computer processes to determine a “member's” “Chi”.

The term “Scarcity” refers to algorithmically determined limits on “gifts” and their accessibility.

The term “Trends” refers to a quantified run of positive or negative change of a given “member's” Chi over a specified interval of time within “WeChi.com”.

The term “Trending Arrow” refers to a directional arrow that indicates the direction of a “member's” “trend”.

The term “Positive Trend” refers to a sustained positive “trend” as determined by the “WeChi.com” “Algorithm”.

The term “Negative Trend” refers to a sustained negative “trend” as determined by the “WeChi.com” “Algorithm”.

The term “Decay” with respect to a given “member's” “Chi” refers to a deterioration of specific state variables used within the “Algorithm” to determine the given “member's” “Chi”.

The term “Significantly Affected” refers to an Algorithmically determined changes in “Chi” of a given “member” caused by an “action”.

The term “Factors” refers to Elements and “actions” that contribute to calculating “Chi” of a given “member”.

6. Additional Definitions.

A “user's client” is process running on a computing device of the user permitting communication of the device over a network with a server associated with the web site for implementation of an embodiment of the present invention. The network may include the internet, but embodiments of the present invention may, for example, be implemented over other suitable networks, such as, for example, the network of a wireless mobile carrier, or a combination of the internet with other networks.

A “computing device” may be any of a variety of devices for digital communication over a network, including a desktop computer, a smartphone, a laptop computer, a tablet computer, etc., which may access the network through a wire connection or any of a variety of wireless connections, including under standards of the IEEE, such as 802.11x.

Rules. Operation of the site can be understood in terms of rules that are programmed into the server. Herewith we provide rules in the following categories:

1. Registration

2. I'm Feeling

3. Relationships

4. Sevens

5. Butterfly Effect

6. Home

7. History

8. Profile

9. Status

10. Gifts

11. Search

12. Levels and Badges

13. Account

14. General

Registration Rules

All “Members” must have a “registered” “account”. In some embodiments, registrations occur via accounts on other social networking platforms, such as Facebook. For example, a member's account information can be drawn from that member's Facebook account (e.g., name, birthday, photograph, etc.)

After “launch”, new “members” can register through “WeChi.com” and/or “invitations”. Minors who “register” are processed similarly to how Facebook processes minors.

To “register”, new “members” must provide: first and last names, a valid “email” address, and a “password”.

New “members” have the option to “invite” their friends by entering “email” addresses and/or syncing social network and “email” accounts.

“Registration” is complete when new “member” selects “turn it on”.

A “confirmation email” is sent to all new “members” when “registration” is complete. All new “members” must respond to the unique URL within each “confirmation email”.

New “members” who do not respond to “confirmation email” will be required to at any subsequent “log-in”.

“Members” have the option to “post” a “thumbnail” (default image provided). A “member's” “Chi” is turned “On” at the conclusion of “registration”.

I'm Feeling Rules

Landing page after completion of “registration”.

Controlled by the “member” who owns the view.

New “members” will be prompted to select an “avatar.

If a new “member” does not select an “avatar”, a default will be provided.

Upon “selection” of an “avatar” the page populates, “Chi” is displayed, and the “member” is prompted to engage.

A new “member's” starting “Chi” will be determined by a variety of “factors”.

There are three independent forms of “engagement”: “I'm Feeling”, selection of an “alert”, and the “text” box.

Any “engagement”, or combination of “engagements”, can be “shared”. A “share” button appears upon the initiation of any “engagement”. “Engagement” is saved only after a “member” clicks the “share” button. “Alerts” remain until removed by the “member”.

“Avatar” adjustments remain until they are changed.

“Avatar” can be switched at any time without losing the “adjustment”. “Members” can access historical postings and engagement on their “avatar”

Relationships Rules

All “members” have the option to “create” a “relationship” In some embodiments, a relationship may be known as a “Loop.”

“Relationships” must involve at least a “creator”.

“Relationships” can involve an unlimited number of “members”.

“Members” can “create” and/or belong to an unlimited number of “relationships”. “Members” “create” “relationships” via the “create” “relationship” button.

The “creator” has administrative rights over “relationships”.

The “creator” must select an “avatar” for each “relationship”.

The “creator” has the option to “upload” a “thumbnail” to represent the “relationship”. The “creator” must name the “relationship”.

The “creator” can only include other members from their “Chi-munity” in any relationship.

“Members” have the option to “request” other “member's” inclusion to the “relationship”. To join a “relationship”˜“requested” “members” must “accept” the “request”. “Requested” “members” have the option to “decline” “requests”.

“Relationship” “requests” appear in a “members” “activity”.

“Relationships” are displayed in a “member's” “Chi-munity”.

“Engagement” on each “relationship” is limited to “members” whom are included.

“Engagement” includes any combination of “avatar” “adjustments”, “sharing” “gifts”, and “text”.

The “Creator” of a “relationship” has the option to change the “avatar” for the “relationship”

All “relationship” “engagement” is displayed in the “history” of the “relationship”.

Members” navigate between “I m feeling” and their “relationships” via a navigation “drawer”.

“Relationships” are displayed in “search” results.

Any “member” can “request” inclusion to “relationships.”

The “creator” must “accept” or “decline” “requests” to join a “relationship”.

“Relationship” “members” have the option to leave the “relationship” at any time.

Sevens Rules

The “member” who owns the view can “edit” the “Sevens”.

The “Sevens” are “ranked” sequentially 1-7 from left to right, top to bottom.

Members invited during “registration” populate a “members” “sevens” as they complete “registration”.

“Edit” allows a “member” to change the composition of their “sevens”.

A “member's” “Chi-munity” will be made available when “editing”.

A “member's” “Sevens” can only include “members/relationships” in their “Chi-munity”.

“Members” who add “relationships” to their “sevens” can view the “alignment” of that “relationship” in their “sevens” with the “alignment” of that “relationship” in the “sevens” of each “member” of the “relationship”.

A “member” has the option to “re-order”, “insert”, “remove”; and “add” a “seven”. A “member” initiates change by selecting the “edit” button.

“Re-order” allows the “member” to change the “rank” of the “sevens”. “Insert” allows the “member” to “add” a new “seven” at a specific “rank”.

Inserting a “seven” “re-orders” the “sevens” sequentially, “bumping” the 7th “seven”.

“Remove” and “add” will enable the “member” to replace a “seven” and retain the order of all others.

Changes to the “sevens” are saved only upon the selection of the “share” button.

Upon clicking “share”, the changes are saved and the “Butterfly Effect” button replaces “edit”.

“Member/relationship names”; “avatars”; and “alerts” will be displayed in each “seven” A default “avatar” will be used if a “member” has not selected one.

All “sevens” link to the appropriate “members” “I m feeling” page.

Changes are reflected in a “members” “activity”.

Butterfly Effect Rules

An optional query specifically connected to a change in the “sevens'.

Activated by clicking the “Butterfly' button immediately after an “edit’ is “shared’ (saved).

Demonstrates the effect of an “edit” on the “Chi” of other “members”. Provides the number of “members” “affected” and “significantly affected”.

The “significantly affected” are displayed along with their corresponding “Chi” and “trending arrow”.

If the “significantly affected” are not in the “members” “chi-munity”, the option to “tap into” that “member” is provided.

Selecting a “significantly affected” “member” links to that “members” “profile” page. The “member” must manually close the “Butterfly Effect” interaction.

Home Rules

Provides detail of a “members” “ Chi-munity” and “activity”.

Page populates as “invitees” complete “registration”.

All “member's” “tapped into” are displayed in a “members” “Chi-munity”.

“Chi-munity” is ordered algorithmically (by default), and “sorted” by influence on a “members” “Chi”.

A “member” can “sort” their “Chi-munity” alphabetically. “Members”! “relationships” in the “sevens” are designated by color.

Details of each “member”/“relationship” in “Chi-munity” include: a “thumbnail”, “member name”/“relationship name”, “Chi”, “trending arrow”, and any “alerts” posted by a “member”.

In some embodiments, directional “trending arrow” indicates old-to-new “rank”.

Selecting the “member” “thumbnail” links to that “member's” “profile” page. Selecting an “alert” links to that “members” “status” page.

Selecting a general field (“member” or “relationship” will dynamically sort the “activity” field according to that “member”/“relationship”.

“Activity” details all “engagement” “history” in chronological order in real-time, between the “member” and their “Chi-munity”.

“Engagement” “history” includes all “posts” “shared” by the “member”, all “Status” updates of the “Chi-munity” “members”/“relationships”, and “engagement” with the “Chi-munity”.

“Activity” populates as a “member” “registers” and as their “Chi-munity” populates.

Each “activity” item includes a “to/from”, a “member name”, a “time stamp”, and any combination of “text”, “avatar”, “alert”, or “gift”.

“Relationship” “activity” includes the “relationship name”. “Relationship” “requests” are displayed in a “members” “activity”.

Clicking specific “activity” “posts” link the “member” to the “I'm Feeling”, “relationship” page of that “member”, or the “status” page corresponding to a “member” in their “Chi-munity”.

History Rules

A “member's” “engagement” “history” is always accessible via “activity” and “history”.

“History” is the specific “activity” “shared” on the “I'm Feeling” and “relationship” “avatars”.

Selection of the “history” button will initiate the “history” field (“drawer”).

“History” button is located on each “members” “I m feeling”, “relationship” and “status” page.

“History” details a “member's” “posts” in chronological order; the most recent “post” “shared” appears first.

Each “post” may include any combination of “adjusted” “avatar, “alerts”, “text”, “gifts” and a “time stamp”.

“Engagement” on each post is displayed as a “thread”.

“Threads” are displayed, in some embodiments, in reverse chronological order; the oldest “engagement” is displayed first, while in some embodiments the most recent threads are displayed, e.g., under a “What's Up” tab, for example.

Each “thread” includes any combination of “text” and “gifts”, the “member name” who “shared”, and a “time stamp”.

“Members” can select and “engage” with any historical “post” in real-time. A “member” can “engage” with their “I'm Feeling” “history” with “text” only. “Share” button appears as the “member” “engages”.

A “member” can “engage” with “relationship” and “status” page “history” with both “gifts” and “text”.

Profile Rules

A “profile” provides an overview of another “member's” “Chi” and their public “My-Chi” account details.

All “members” must have a “profile”.

By default, a “member” “shares” their “status”, “sevens”, “gifts”, “Chi-munity”, “history”, and “Chi”.

By default, “members” also “share” various data points related to their “Chi-munity”.

By default, a “member” can also see how “aligned” they are with the “member” of the “profile” being viewed.

“Members” have the option to manage what is displayed on their “profile” through “privacy” preferences.

To access and “engage” with “shared” details, a “member” must be “tapped into” the “member” who owns the “profile” page.

A “member” can “tap into” other “members” via their “profile”.

“Tapped” into “members” can access and “engage” by clicking on the “shared” details. “Members” have the option to “sort” a “member's” “Chi-munity” alphabetically.

Status Rules

“Status” is the public view of another “members” “I m Feeling” page. View will display “avatar” and “alerts” as set by the “member”.

Access is restricted to those who have “tapped into” the “member” who owns the “status” page.

There are two independent forms of “engagement” on the “status” page: “sharing” “gifts” and “text”.

Any “member” can “share” “text” and “gifts” with any other “member” within their “Chi-munity”.

“Gifts” are appropriate to the “avatar” and have a “scarcity” value (see “gifts”. Any “engagement” or combination of “engagements” can be “shared”.

A “share” button appears upon the initiation of any “engagement”.

“Engagement” is saved and “shared” only after a “member” clicks the “share” button. All “engagement” on a “status” page is displayed in the “history”.

“Status” page “history” can be accessed through the “history” button.

“Members” can “engage” with the historical “postings” on each “status” page (see “history”).

Gifts Rules

“Gifts” are specific to the “avatar” on each “I'm Feeling”, “relationship”, and “status” page. “Gifts” are “scarce”; “sharing” “gifts” is limited to what exists in a “members” “Gifts” storage. “Members” start with a default number of “gifts” in their “Gifts” storage.

“Members” can increase their inventory of “gifts” by receiving, earning, or purchasing new “gifts”.

“Gifts” received can be “re-gifted”.

Specific “gifts” are free.

“Gifts” sent are attributed with “bad-chi” or “good-chi”.

“Gifts” appear in the “activity” and “history” of each “I'm Feeling”, “relationship”, and “status” “avatar” they are “shared” with.

“Gifts” are saved in the “Gifts” storage of the recipient and/or “gift” holder.

Search Rules

All “members” can “search” for any “member”/“relationship”.

“Members” in the “search” results are displayed in descending order according to “Chi”. “Relationships” in the “search” results are displayed in alphabetical order.

“Members” can “search” for other “members”/“relationships” via “first name”, “last name”, “member name”, and “relationship” name.

“Verified Accounts” are denoted graphically within the “search” results.

Clicking on a “member” links the “member” to the “profile” of the “member” selected. Clicking on a “relationship' allows “members” to “request' inclusion in a “relationship”. “Search” results can be “sorted” alphabetically.

Levels and Badges Rules

As a “member” achieves specific milestones, they reach new “levels” of game play. New features become available to the “member” after reaching specific “levels”. “Leveling up” is tied to the completion of “quests”.

Completion of “quests” also rewards the “member” with “badges”.

“Quests” are designed for the “member” to maximize “Chi”.

Earned “Badges” are good for a “members” “Chi”.

A “member's” “badges” are displayed in the “Gifts” storage and on the “profile”.

The more “badges” a “member” acquires, the more advanced that “member” is.

Account Rules

All personal information is documented on the “account” page.

“Member” can “edit” and “adjust' personal information, “account” “settings” and “privacy”.

“Members” can “edit” first and last name, “email” “address”, “password”, “social network” “syncing”, “birthday”, and “thumbnail”.

Any “member” can “block” and or remove any other “member” from “tapping into” their “Chi”.

“Members” can deactivate their “account” (“Chi-Off”).

A “member's” “Chi” is only “Off” if they deactivate their “account”. Account deactivation must be confirmed via “email” response. Default “privacy” is to “share” all.

“Members” can “adjust” the “privacy” of “I'm Feeling”; “Sevens”; “Gifts”; “Chi-munity”; “activity”; and “tapping”.

All “members” must “share” “Chi” at all times.

General Rules

Any person with a valid “email” address can join. Appropriate navigation button is highlighted at all times. Historical “activity” is always available.

Any “member” can tap into any other “member”. Header never changes.

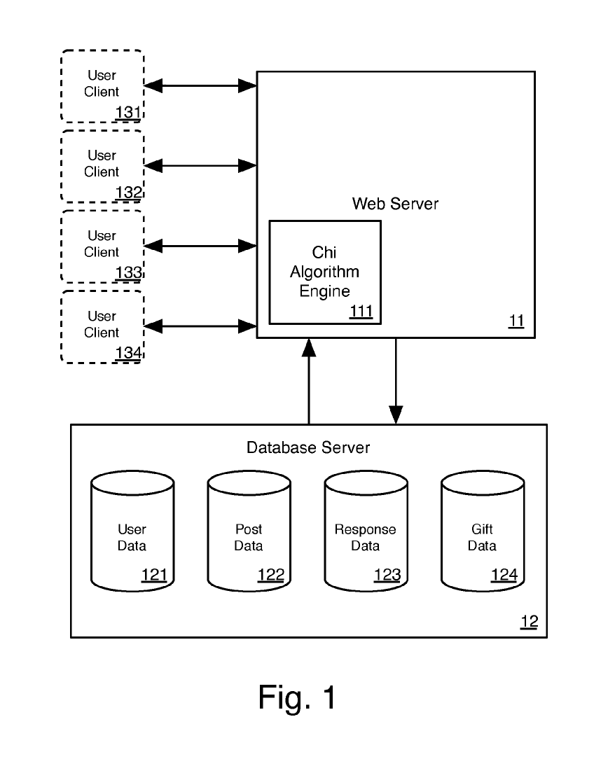

FIG. 1 is a block diagram of architecture of a system in accordance with an embodiment of the present invention. In this embodiment, a web server 11 is in communication over at least one network, such as the internet, with diverse client computing devices of users. The computing devices may include desktop computers, smartphones (such as the iPhone, available from Apple Inc., Cupertino, Calif.), other portable computing devices such as laptop computers, tablet devices (such as the iPad, also available from Apple Inc.), entertainment-based computing devices (such as the iPod, available from Apple Inc., and the PlayStation, available from Sony Corporation of America, New York, N.Y.), etc. These devices are identified as clients 131, 132, 133, and 134. Typically, the clients 131, 132, 133, and 134 may be running web browsers for communication with the web server 11. Alternatively, one or more of the clients may be running a dedicated application that communicates with the web server 11. (In other words, the web server 11 may also be running processes for communicating with a dedicated application running on the client.) The web server 11 includes the Chi algorithm engine 111, which is described in further detail below.

The Web server 11 is in communication with a database server 12, which provides data used by the Web server 11 in communicating with the clients. The database server 12 accesses a variety of databases, including user data 121, post data 122, response data 123, and gift data 124. The database for user data 121 stores contact and billing information for the user, including the user's name and e-mail address, but also the identification of other members in the user's social network, that is, in the user's Chi-munity. The user data database 121 also stores other information that is particular to the user's participation as a member, including the user's current Chi score. The database for post data 122 stores posts that have been made by members on the site. The database for response data 123 stores responses made by members to posts. Finally, the database for gift data 124 stores gifts that have been allocated to members.

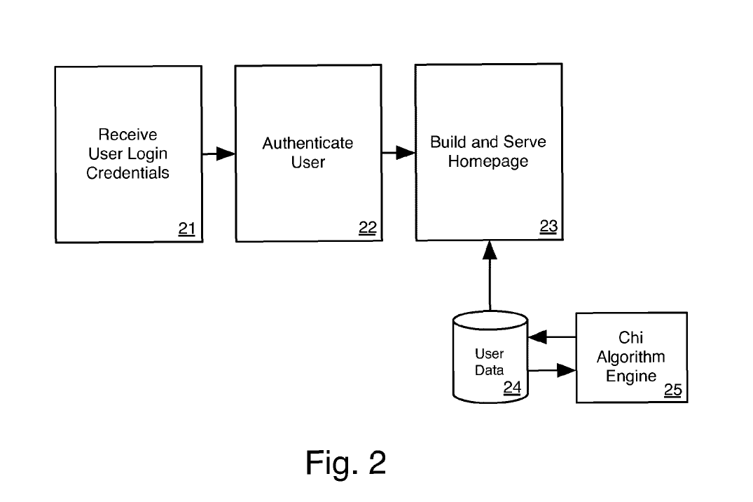

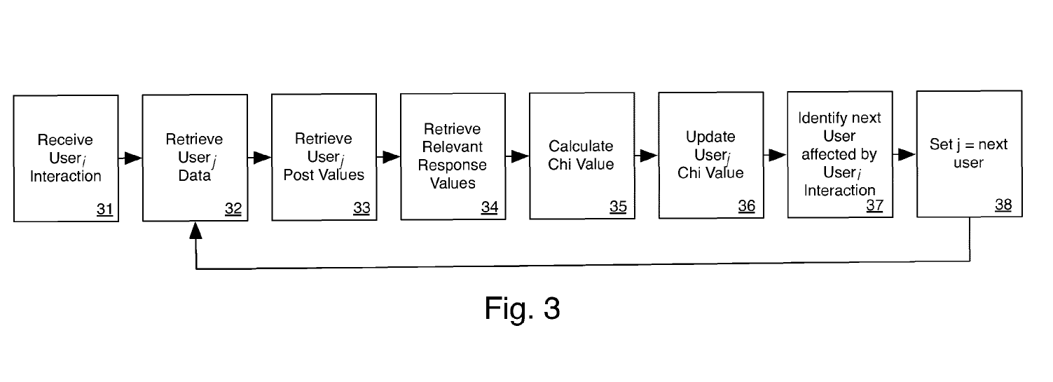

FIG. 2 is a block diagram of logical flow of the web 11 of FIG. 1 in serving clients of users of the system of FIG. 1. In process 21, the server receives login credentials of the user. In process 22, the server authenticates the user. In process 23, the server accesses user data 24, via the database server 12 of FIG. 1, and uses the user data to build a home page pertinent to the user. The user data 24, accessed by the server, in the meantime is updated by the Chi algorithm engine 25 in the manner that will be described below in connection with FIG. 3. After the homepage pertinent to the user has been built by the server, it is then served to the user.

FIG. 3 is a block diagram of logical flow of processes carried out by the Chi algorithm engine of FIGS. 1 and 2. A feature of embodiments of the present invention is that the Chi value of a member is determined, not only by actions, circumstances, and events of a member, but also by actions, circumstances, and events of other members who have been tapped by the given member. Thus, a member's Chi value is a more complex construct than the “I'm feeling” element in various embodiments herein. Specifically, a user's Chi value reflects, in various embodiments, the frequency of adjustments by the user in providng a self-assessment of the user's emotional condition, as well as postings and responses by which the user is implicated. Such postings and responses include postings and responses by the user as well as responses by others to a postings or responses by the user. The general approach is shown in the embodiments of the Chi algorithm in Exhibit A attached hereto. Sf is a quantity configured generally to address the frequency of changes in the “I'm feeling” setting by the user. Similarly, Sp and Sr are quantities developed from posting and responses, respectively, by which the user is implicated. Consequently, a user's Chi value depends on more than posts and responses by the user alone. Typical factors influencing the determination of a Chi value are as follows:

Influence on a user's Chi by a POST
What Type? (Individual, Relationship, Phantom)
Poster's Posting Frequency
Poster's Alert Frequency
Added Weight if Alert assigned, modified by Alert Frequency
Summation of Response Values
Also possible: add weight if it's a Relationship, and the Relationship is in Poster's Sevens

Influence on a user's Chi by a RESPONSE
What Type? (Individual, Relationship, Phantom)
Added weight if Poster is in Responder's Seven
Responder's Response Frequency to the Poster
Added weight if Response is a Gift
Quickness in Response

Influence on a user's Chi by a PAGE VISIT (Relationship/Phantom)
Raises Chi trend
Inactivity lowers Chi trend

Influence by CHI OF SOMEONE AFFECTING YOU: (Relationship/Individual/Phantom)
Time in which Influenced was tapped into Influencer
Rank of Influencer (in sevens or influence in chimunity)
Strength of Influencer's Chi Trend (how dramatic the trend is)

Influence by COMPOSITION OF SEVENS
The act of ranking an individual or Relationship affects your Chi

A illustrative algorithmic approach for the Chi value calculation is itself specified in the document attached hereto and incorporated herein by reference as Exhibit A. In various embodiments, the operation of the algorithm is event-driven. For example, in some embodiments, the operation of the algorithm may be initiated by a posting or response by a user, or by the adjustment of an “I'm feeling” control (e.g., slider) by a user.

A variety of variations are possible. For example, some embodiments may omit some of the calculations, while some embodiments may use different or variable weighting factors. Some embodiments may employ a subset of the User State Variables. As just one example, some embodiments may omit the inclusion of gifts in the algorithm, while others may assign a weight to gifts that is different than that shown in Exhibit A. In addition, some embodiments determine a user “My 7” without user input. For example, a user's “My 7” may be determined by assessing the other users that most actively engage with a user, and the data about those users may be used in the algorithms just as if the user had selected the “My 7.”

Turning now to FIG. 3, operation of the Chi algorithm engine 111 of FIG. 1 (which corresponds to item 25 in FIG. 2) is triggered in process 31 by receipt of in interaction by a user, here identified as user,. The interaction may be a post by the user or it may be a response by the user. The algorithm engine operates initially to determine a new Chi value for userᵢ. However, user, can be affecting the Chi value of other users as well. Accordingly, in process 32, the Chi algorithm engine begins processing Chi values for an arbitrary user identified as userⱼ (using here the index j instead of the index i). Initially, however, the engine sets j=i so that initial processing is for userᵢ. Once the Chi algorithm engine has been triggered, in process 32 it retrieves data pertinent to userⱼ, including the current Chi score of the userⱼ. In process 33, it retrieves post values of userⱼ, and also in process 34 retrieves response values that are pertinent to userⱼ. The response values may well include responses of other users who have been tapped by userⱼ. In process 35, the engine uses the retrieved values to calculate a new Chi value for userⱼ. After calculation of the new Chi value, in process 36 the engine updates the Chi value for userⱼ. Because the interaction received in process 31 can affect the Chi of users beyond that of userᵢ, in process 37 the engine identifies the next user who has been affected by userᵢ's interaction, and in process 38 the index j is set to specify the next user and the engine thereafter begins processing anew for the next user starting with process 32. This processing continues for each user whose Chi has been affected by userᵢ.

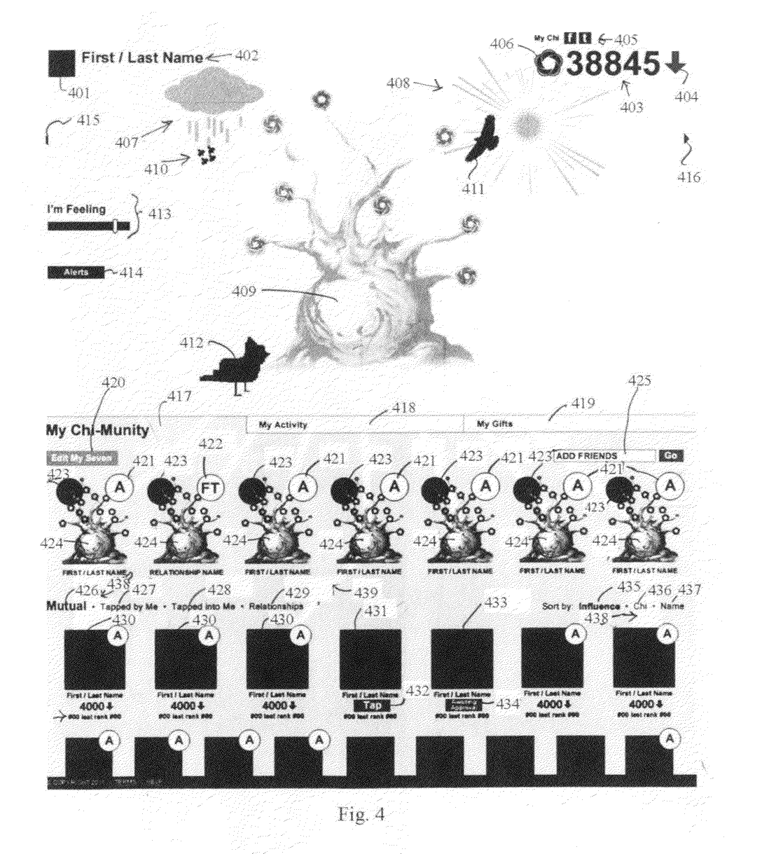

FIGS. 4-41 are representations of computer displays constituting a user interface in accordance with an embodiment of the present invention.

FIG. 4 is a representation of the homepage experienced by a user. In this figure item 401 is a thumbnail image of the particular user for whom the homepage has been customized. Item 402 is the user's first and last name. Item 403 is a numerical representation of the user's Chi, and item 406 is a My Chi logo identifying the website as a source. Item 404 is a graphical representation of trend in the user's Chi as either increasing or decreasing, and in this case the down arrow is indicative of a decreasing Chi since its last determination. Item 405 identifies links for sharing the user's Chi on social media websites such as Facebook and Twitter. Item 407 is a graphical representation of the trend in the user's Chi, using whether as a metaphor, in this case a graphic identifying rain. Item 408 is a graphical representation of the presence of an alert, namely fireworks or a flare. The tree 409 is populated with items that indicate graphically the I'm Feeling emotional state of the user. In this case the trio seemed to be populated with flowers. The bees 410 indicate a public message, whereas the flying bird 411 indicates a private message. The standing bird 412 is an indicator of a Gift. The I'm Feeling graphic 413 provides a mechanism for an I'm Feeling input. Item 414 is a button by which a user may provide an alert input. Item 415 is a navigational arrow allowing the user to move the screen laterally to the left to access graphics that do not fit on the screen, and similarly arrow 416 is a navigational arrow allowing the user to move the screen laterally to the right to access graphics that do not fit on the screen.

Continuing discussion of FIG. 4, tab 417 is a tab by which the user may access information about the user's My Chi-Munity. Tab 418 enables the user to access the user's My Activity, and tab 419 enables the user to access the user's My Gifts. The graphic item 420 enables the user to edit the user's selection of individuals to constitute the user's My Seven. Item 421 is an icon indicating that the individual represented in the thumbnail in which the icon is present has posted an alert. This individual, and each of the other individuals in the user's My Seven, has a tree 424 that is populated with items that indicate graphically the I'm Feeling emotional state of the individual. Similarly, the weather icon 423 associated with each of the individuals in the user's My Seven indicates for each individual the corresponding Chi trend. Item 422 is a Feeling Trend icon associated with a relationship indicating that the corresponding relationship has experienced a dramatic shift in the way its members are feeling. Search bar 425 provides a mechanism by which the user may find people to add to the user's Chi-Munity. It can be seen that the first row in the my Chi-Munity tab are provided thumbprints corresponding to the content of the user's My Seven. In subsequent rows are contained thumbprints of other individuals or relationships. Individuals are identified as Mutual (accessed by item 426, and into whom the user has tapped and who have tapped into the user), Tapped by Me (accessed by item 427), and Tapped into Me (accessed by item 428). Relationships may also be accessed (via item 429). Depending on which of these vehicles has been invoked, one may see thumbprints of individuals such as indicated by 430 where the relationship is mutual, individuals represented by 431 who have tapped into the user (and whom the user may seek to tap by graphic 432), as well as individuals whom the user has tapped (in this case represented by item 433, wherein graphic 434 indicates the particular individual is awaiting approval as a person into whom the user may). In this figure we are taking liberties for simplicity in illustration, because invoking the Mutual designator 426, one would not see individuals who have only tapped into me or who have only been tapped by me. It can be seen that appropriately clicking on items 435, 436 and 437 allows sorting of the thumbprints by influence, Chi, or name, respectively.

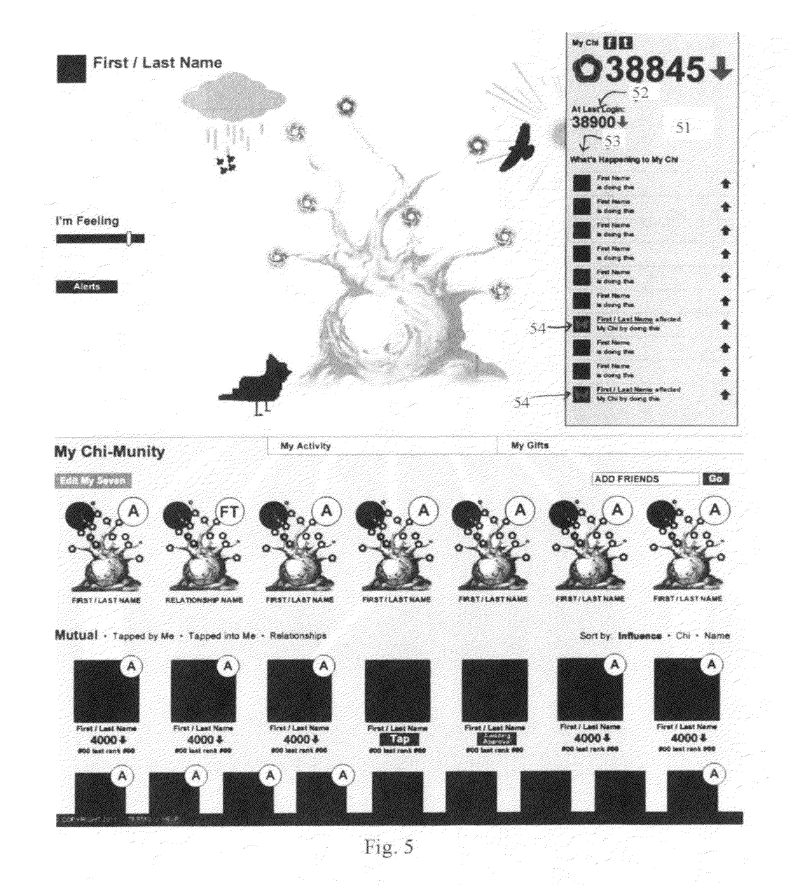

FIG. 5 shows the modification of the homepage when the user invokes detail showing how others are affecting his Chi score. In this figure item 51 is the Area describing how others are affecting the user's Chi. Item 52 is the numerical value of the user's Chi at last login. Item 53 is a list of the top 10 events affecting the user's Chi by showing, for each event, the person associated with the event and what affect the event had on the user's Chi. Each of items 54 indicates to the user that a Butterfly Effect has occurred as a result of the associated event.

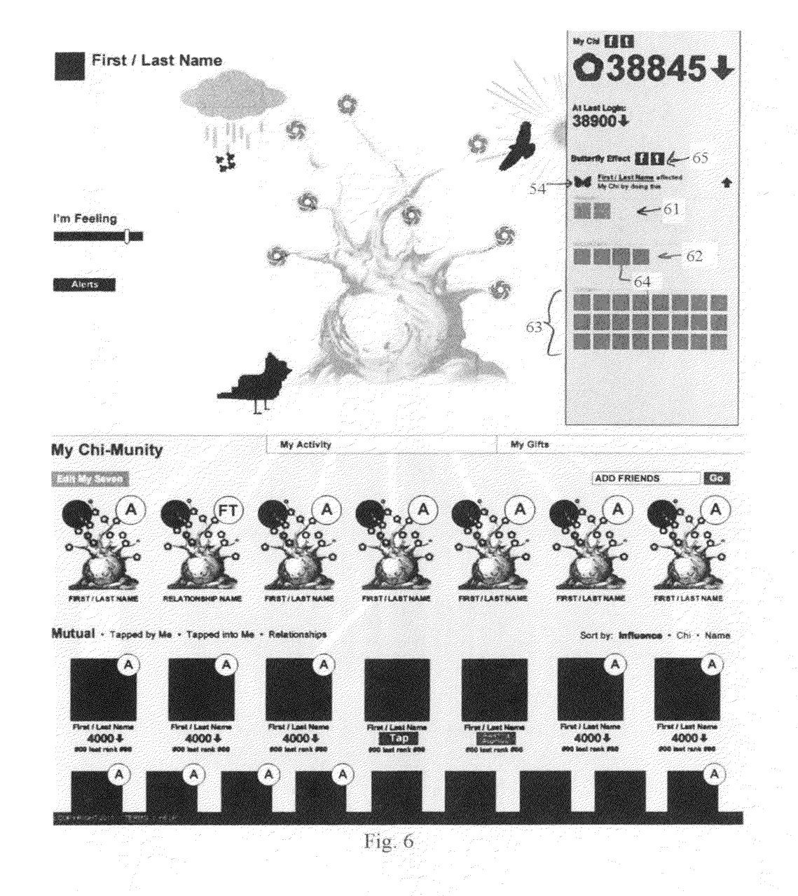

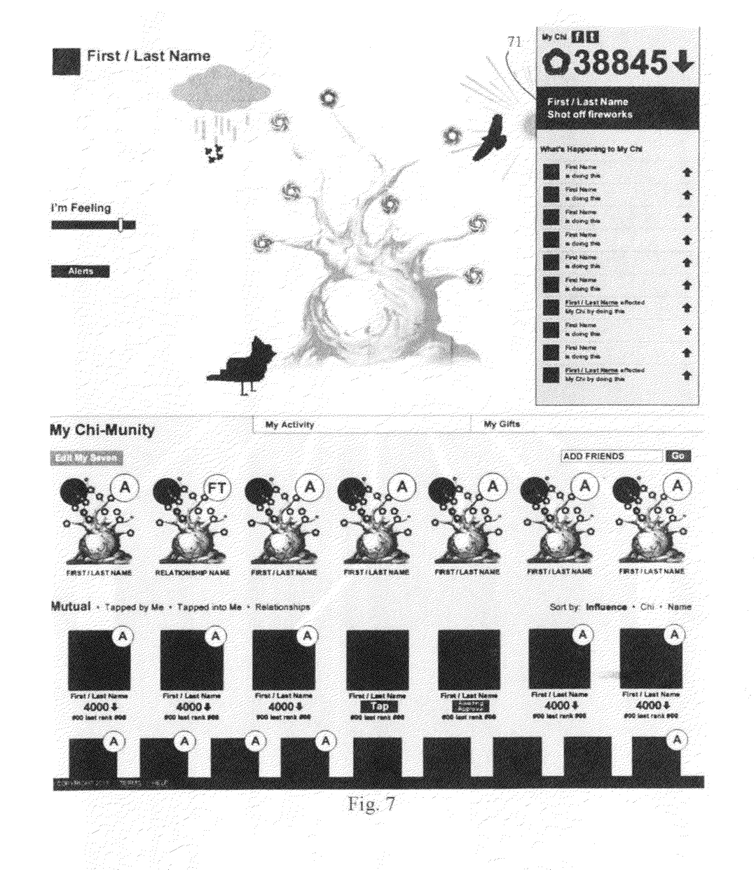

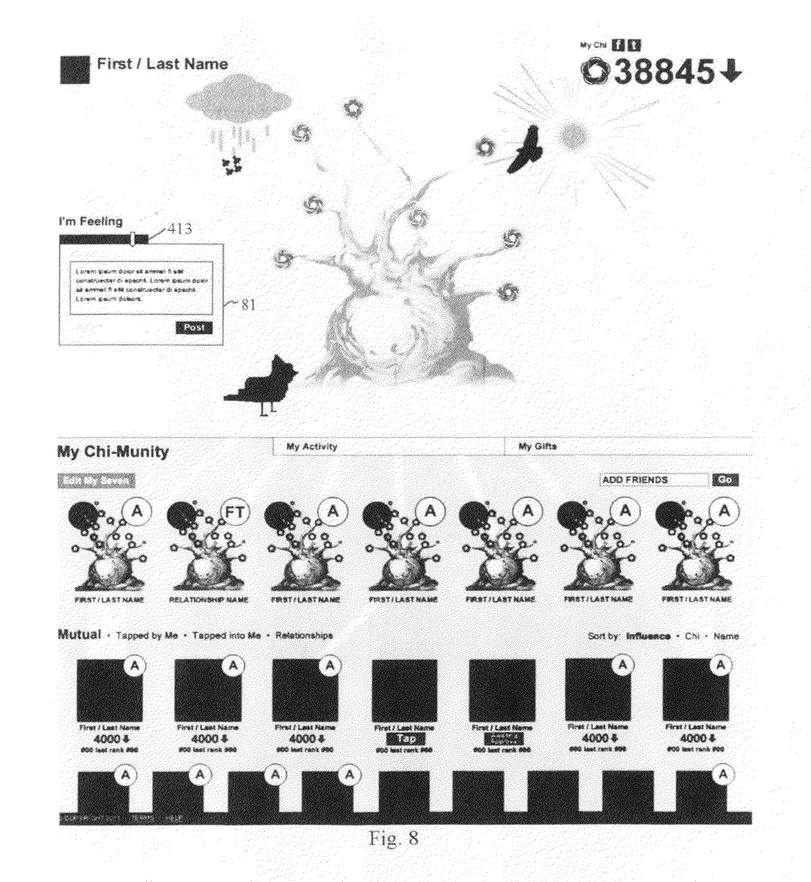

FIG. 6 shows further detail obtainable from the screen of FIG. 5 when the user seeks detail from that screen of a butterfly effect therein shown. In this figure, item 61 identifies Thumbnails of the members involved in the Butterfly Effect directly in contact with the source. Item 62 identifies Thumbnails of the members involved in the Butterfly Effect one step removed from the source. Item 63 shows Thumbnails of the members involved in the Butterfly Effect two steps removed from the source. Item 64 indicates a thumbnail of the user where placement shows the user's proximity to the source of the Butterfly Effect. Item 65 identifies links for sharing a Butterfley Effect on social media websites such as Facebook and Twitter.

FIG. 7 shows how a notification is displayed on the screen of FIG. 5. In this figure, item 71 is the area in which notifications about any event that affects the user's Chi will appear.

FIG. 8 shows the interaction experienced by a user on the homepage of FIG. 4 who seeks to adjust the I'm Feeling graphic 413. In this figure item 81 shows the window initiated by interacting with the “I'm Feeling” bar that allows a member to append text to the feeling.

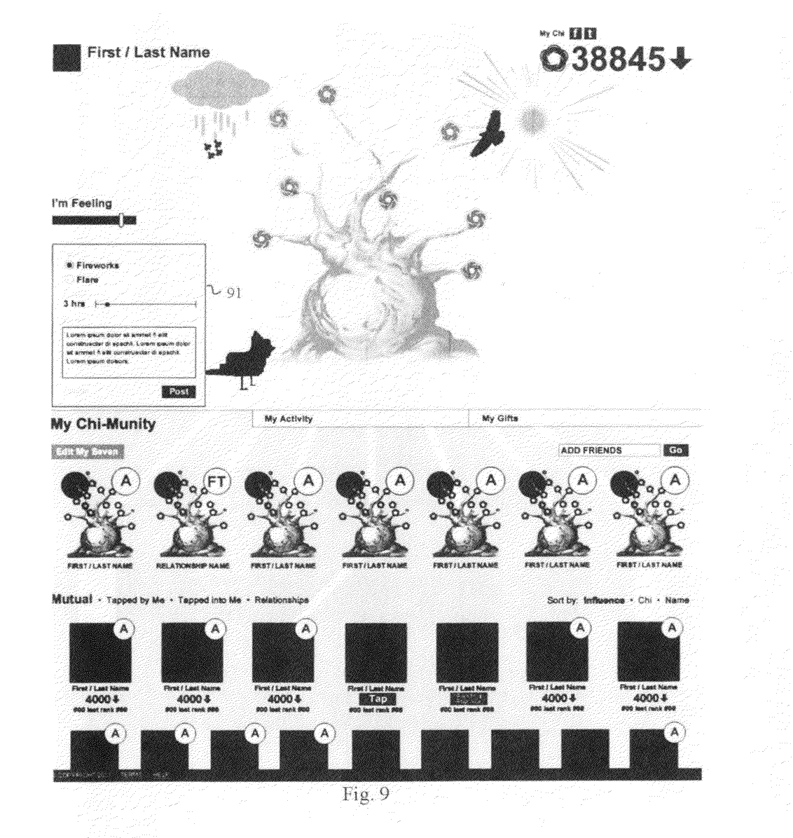

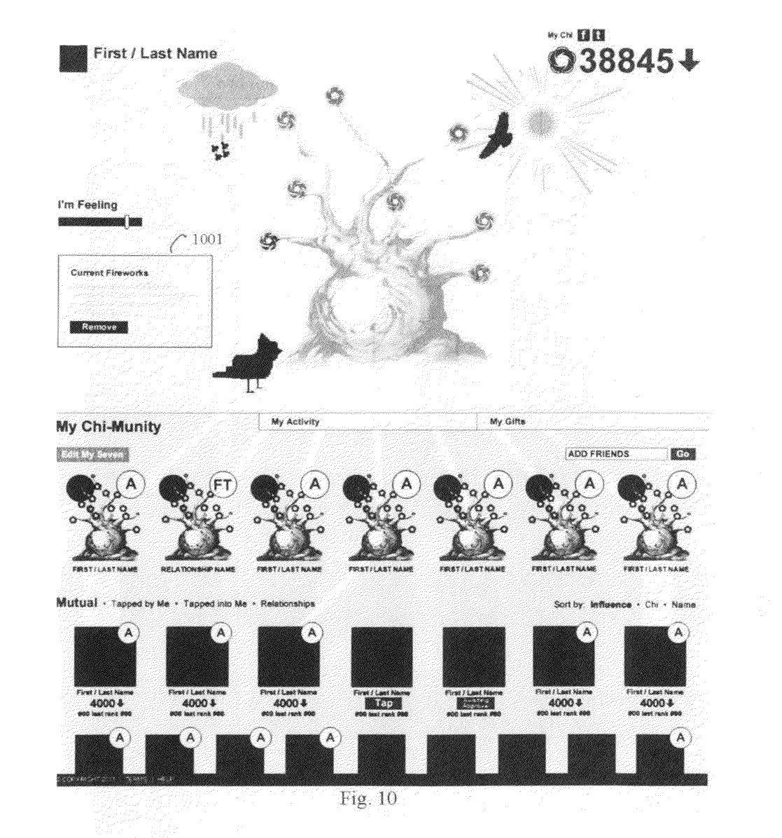

FIG. 9 shows the interaction experienced by user on the homepage of FIG. 4 who invokes the alert button 414. In this figure item 91 shows a window initiated by clicking the Alert button when no alert is being displayed. This window allows a user to set the type of alert he is posting, set the duration the alert will be displayed for and append text to the alert.

FIG. 10 shows the interaction experienced by a user on the homepage of FIG. 4 who invokes the alert button 414 when an alert is already being displayed. In this figure item 1001 is a window initiated by clicking the alert button when an alert is already being displayed.

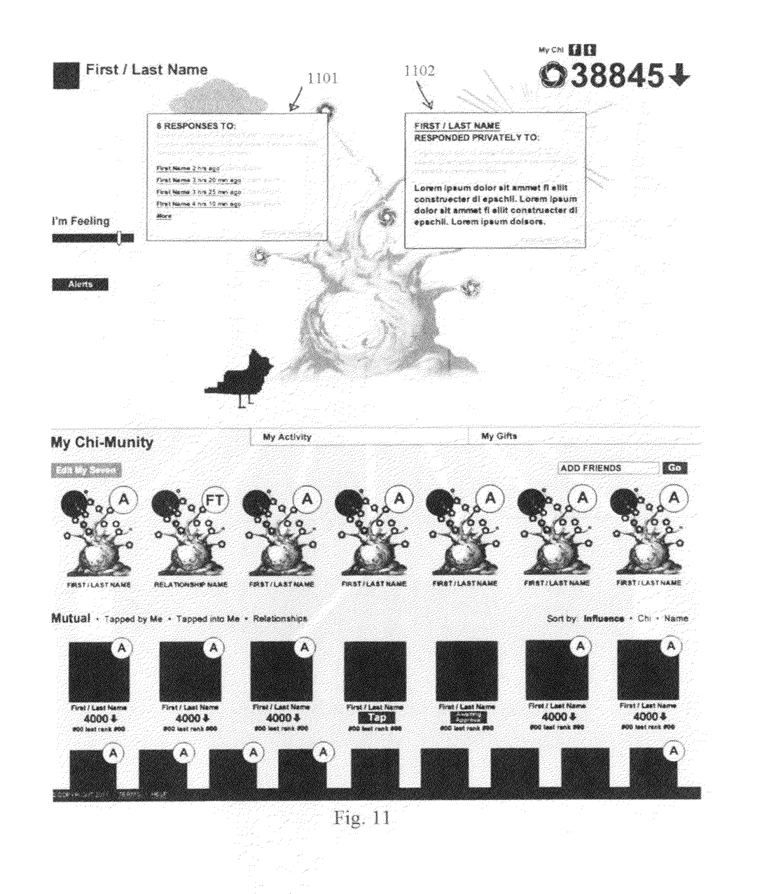

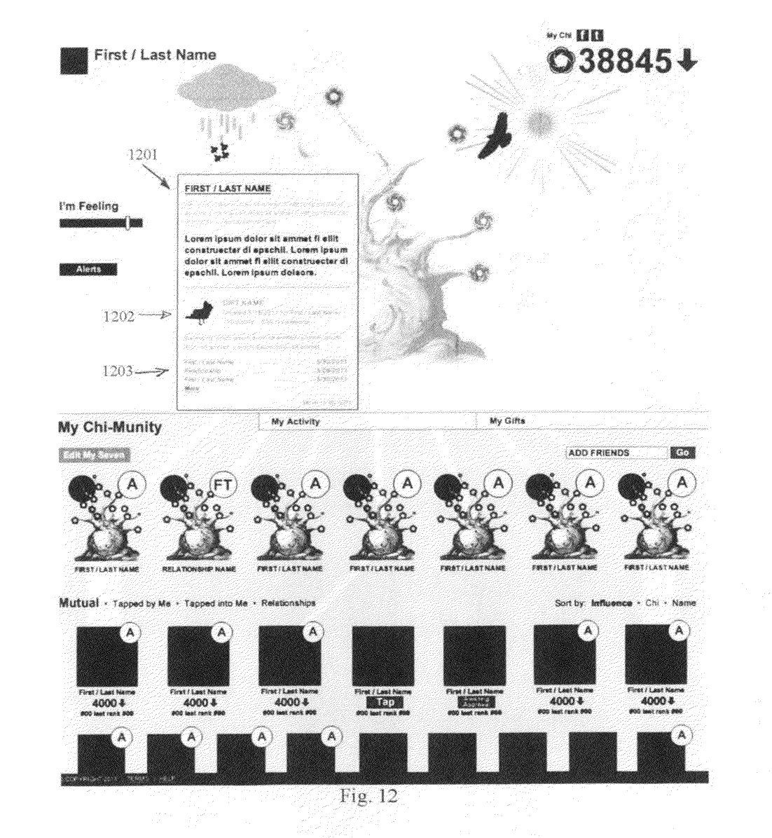

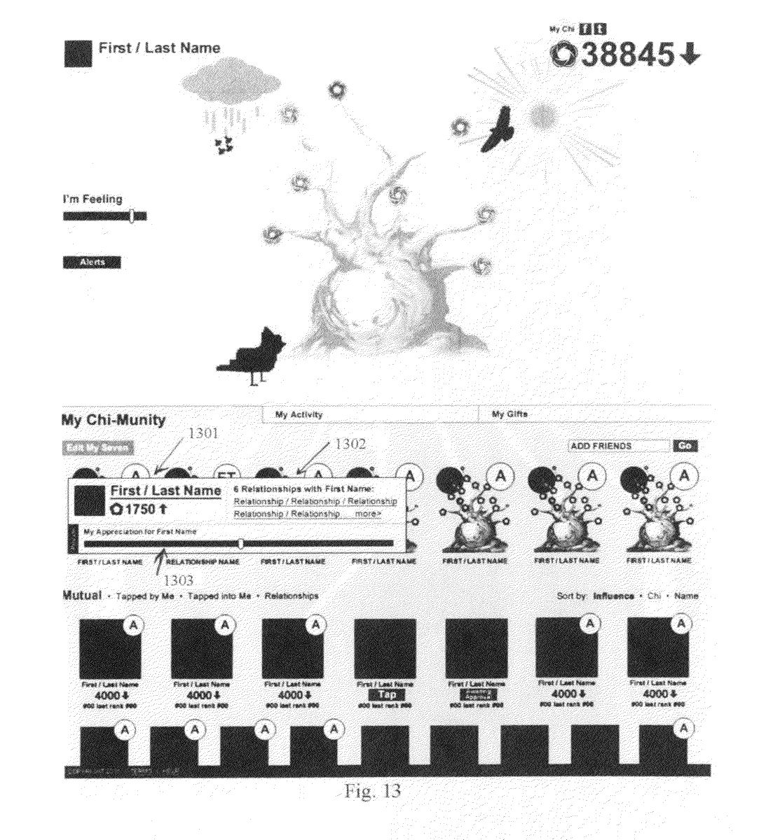

FIG. 11 shows the interaction experienced by user on the homepage of FIG. 4 who invokes the public message graphic 410 or alternatively the private message graphic 411. In this figure item 1101 shows a window initiated by interacting with the graphical representation of a public message (410). This window displays the responses to the user's post and links through to the user's activity this message in the context of the thread. Item 1102 shows a window initiated by interacting with the graphical representation of private messages (411). This window displays the response to the user's post and links through to the user's activity highlighting these messages in the context of the thread.

FIG. 12 shows the interaction experienced by user on the homepage of FIG. 4 who invokes the graphical representation of a gift 412. In this figure item 1201 is a window initiated by interacting with the graphical representation of a gift (412). This window displays the response to the user's post and information on the attached gift. Item 1202 is an image of the attached gift and information about it. This information includes the name of the person giving the gift, when and by whom the gift was created its value in points, how many such gifts are in existence, and a narrative story about the gift. Item 1203 shows the history of everyone who has owned the gift and links to the user's My Gifts section.

FIG. 13 shows the interaction experienced by user on the homepage of FIG. 4 who invokes a thumbnail of an individual who is in My Chi-Munity. In this FIG. item 1301 identifies a thumbnail, name, and Chi of a member or relationship. Item 1302 shows the connections the user has in common with the member or relationship displayed in this window. Item 1303 shows a private input where the user can set his appreciation for this member or relationship.

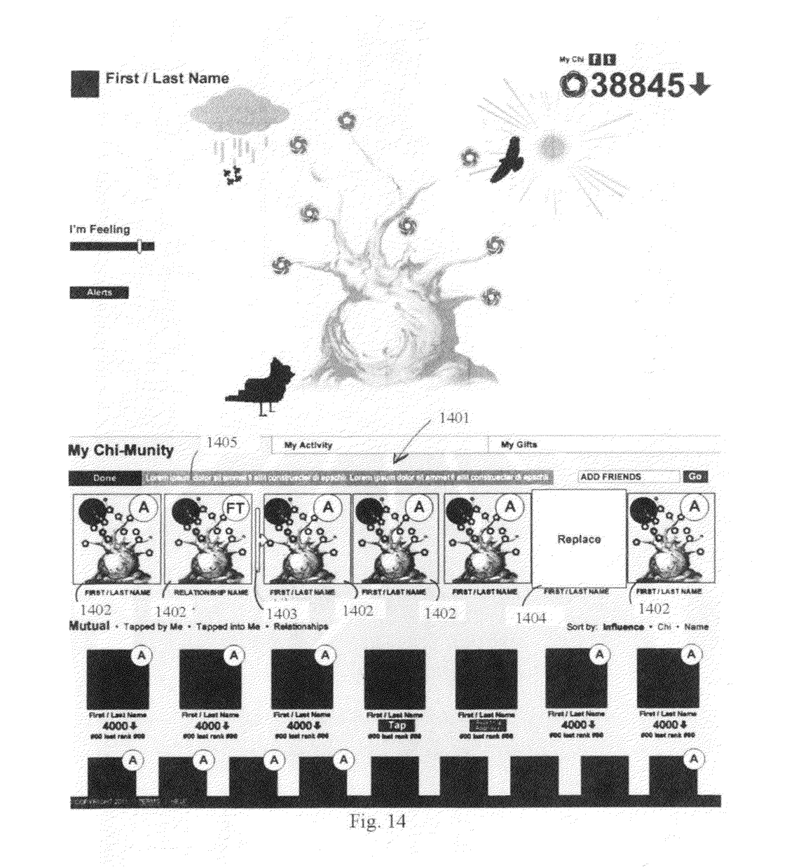

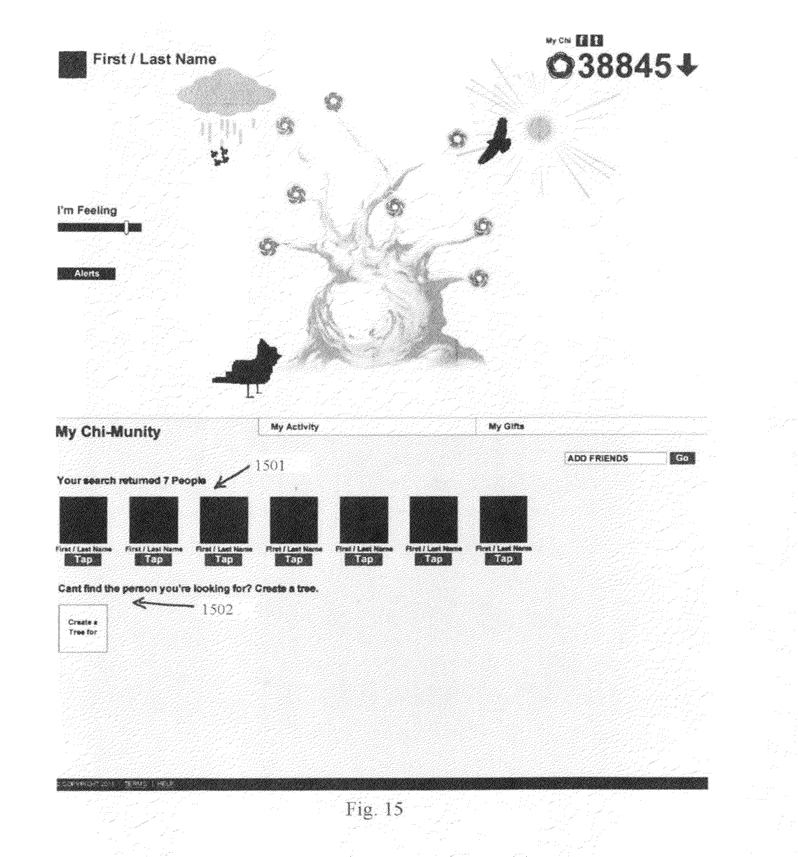

FIG. 14 shows the interaction experienced by user on the homepage of FIG. 4 who seeks to reorganize, add or remove members from My Seven. In this figure item 1401 is the input area for reorganizing, adding or removing members from My Seven. Item 1402 is a slot in My Seven that can be filled with a member. Item 1403 is an icon indicating that moving a member here will place them between two existing members, moving the following members down in rank and dropping the last member out of My Seven. Item 1404 is an icon indicating that moving a member here will replace the member who is currently ranked in this slot. Item 1405 is instructional copy about editing My Seven.

FIG. 15 shows the interaction experienced by a user on the homepage of FIG. 4 who invokes a search. In this figure item 1501 shows results from a search that includes members of My Chi, Facebook friends (if Synced) and Gmail Contacts (if Synced). Item 1502 is a button that creates a profile for someone who was not found in the user's search results.

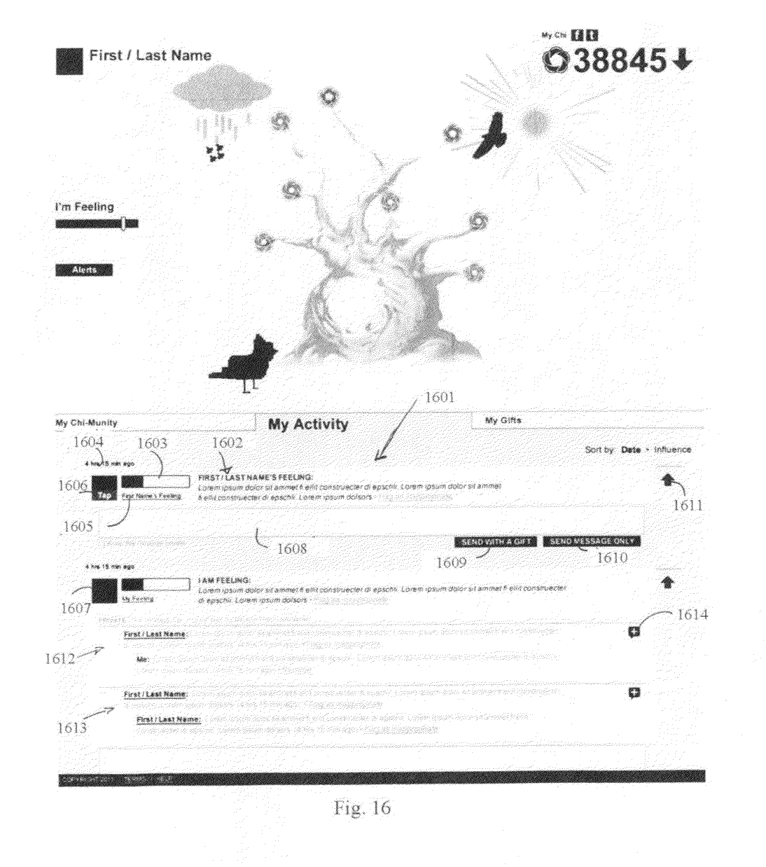

FIG. 16 shows the interaction experienced by user on the homepage of FIG. 4 who invokes the My Activity tab. In this figure, item 1601 is a module showing an event that has affected the user's Chi. Item 1602 shows a description of the action and the name of the member who initiated it. Item 1603 is a graphical representation of the “I'm Feeling” state of the member who initiated the action at the time it was initiated. Item 1604 is a timestamp of when the action was initiated. Item 1605 is a link that sorts My Activity to show only “I'm Feeling” posts generated by the corresponding member. Item 1606 is a Tap icon allowing the user the opportunity to add this member to My Chi-Munity. Item 1607 shows the thumbnail of the member who initiated this action. Item 1608 is a field for entering a text response to this event. Item 1609 is a button that sends the text response and attaches a gift. Item 1610 is a button that sends the text response without attaching a gift. Item 1611 shows a graphical representation of the affect this event is having on the user's Chi. Item 1612 shows a private thread in response to an event. Item 1613 shows a public thread in response to an event. Item 1614 is a button allowing the user to comment specifically to this response.

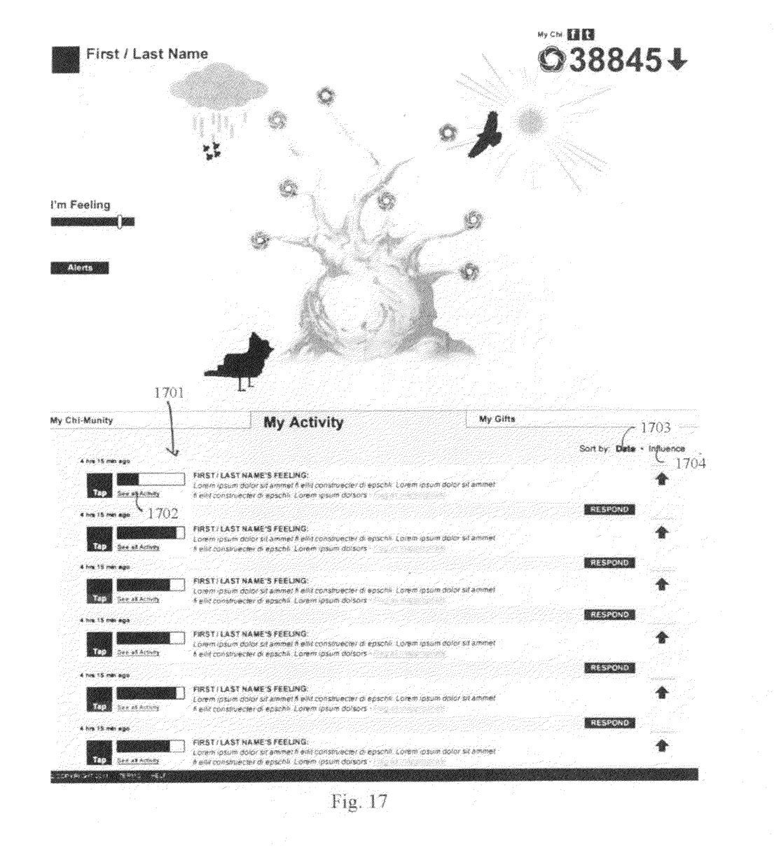

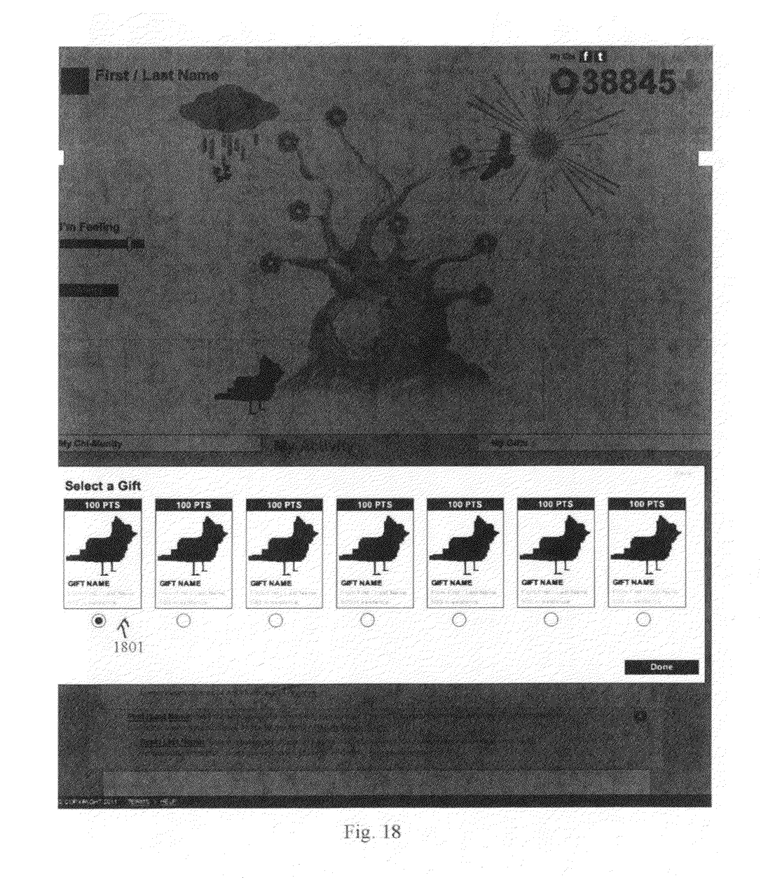

FIG. 17 shows the interaction experienced by user on the screen of FIG. 16 who invokes an event that affects the user's My Chi. In this figure item 1701 is a module showing an “I'm Feeling” post. Item 1702 is a link that sorts My Activity to show all events that have affected the user's Chi. Item 1703 is a link that sorts all modules in My Activity by the date each was initiated. Item 1704 is a link that sorts all modules in My Activity by the amount of influence each has had on the user's Chi.

FIG. 18 shows the interaction experienced by a user, having invoked an event that affects the user, for selecting a gift to give to another member. In this figure item 1801 shows a graphical representation of a gift in the user's possession that may be selected and given to another member.

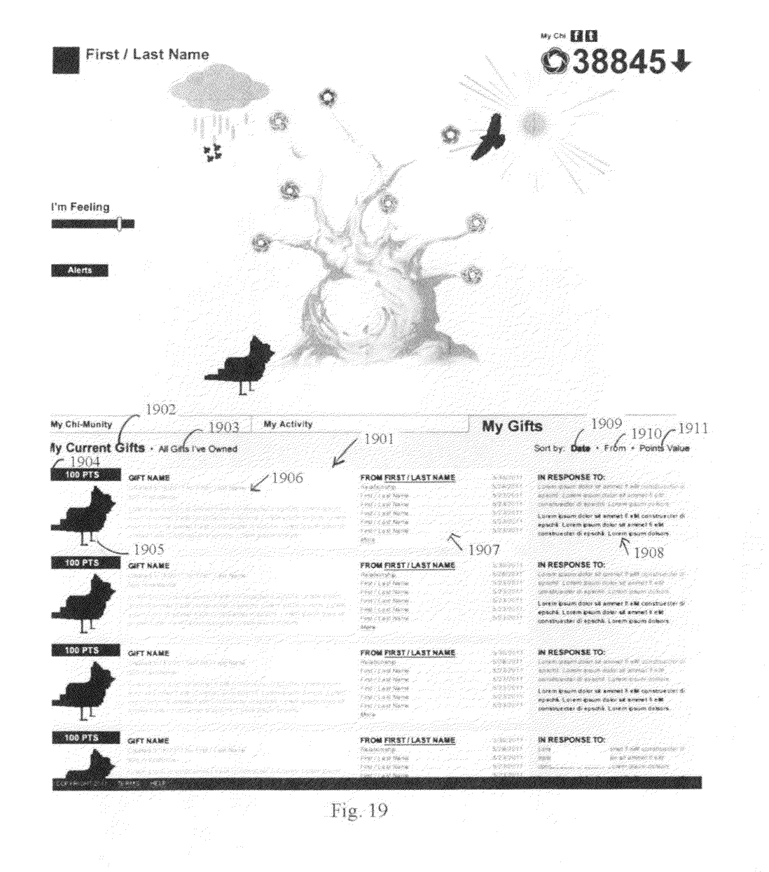

FIG. 19 shows the interaction experienced by a user, having invoked the My Gifts tab of FIG. 4, and seeking display of gifts received by the user. In this figure item 1901 is a module showing a gift. Item 1902 is a link that sorts My Gifts to display only gifts currently held by the user. Item 1903 is a link that sorts My Gifts to display all gifts that have ever been held by the user. Item 1904 shows the value of the gift in points. Item 1905 is a graphical representation of the gift. Item 1906 is a description of the gift. This description includes the gift name, when it was created, who it was created for, how many are in existence and a narrative story about the gift. Item 1907 shows the history of everyone who has ever held the gift and the date they received it. Each name in the history links to the corresponding relationship or member profile. Item 1908 shows where a message included with the gift is displayed. Item 1909 is a link that sorts My Gifts by the date each gift was received. Item 1910 is a link that sorts My Gifts alphabetically by the name of each gift's sender. Item 1911 is a link that sorts My Gifts by the point value of each gift.

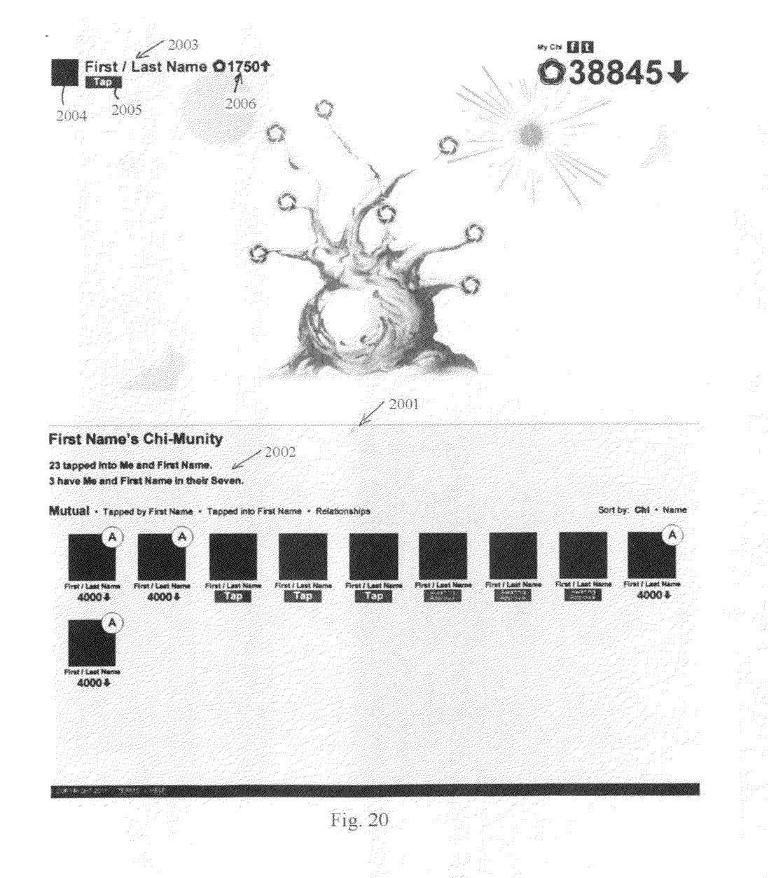

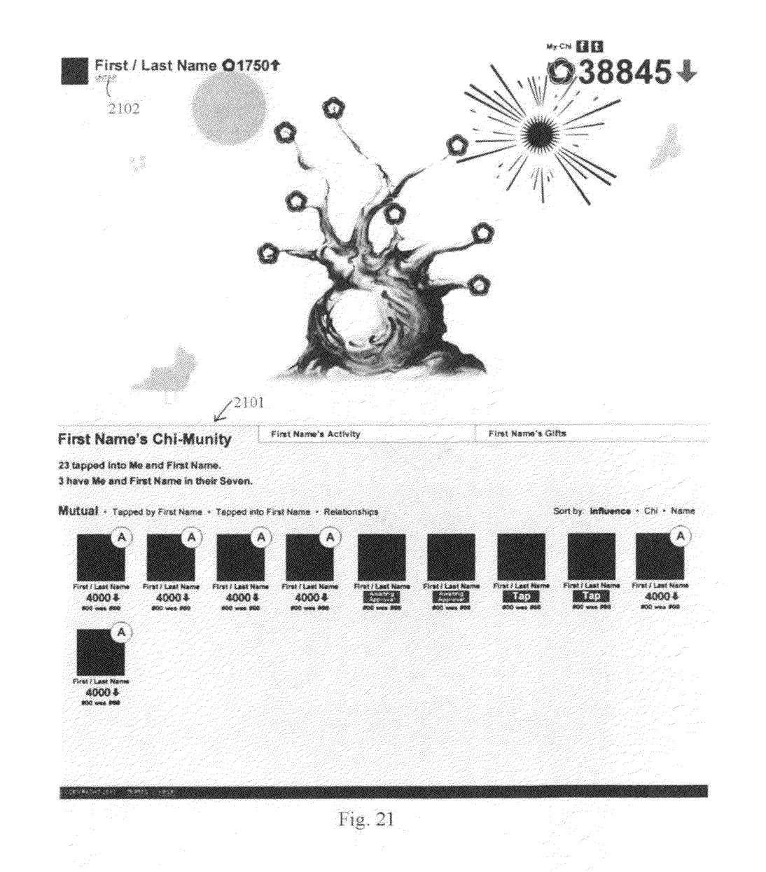

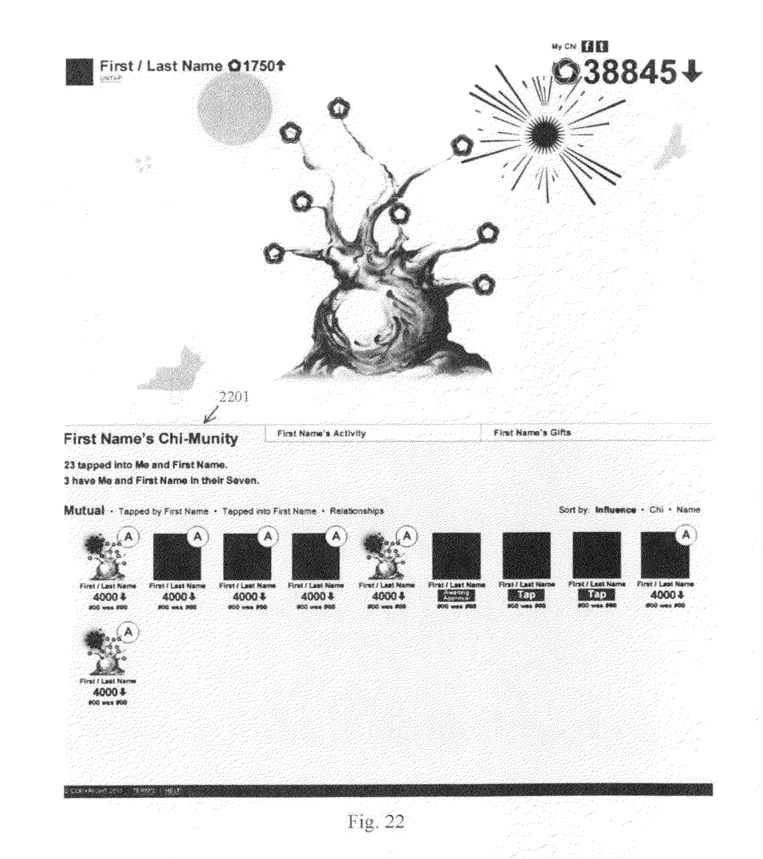

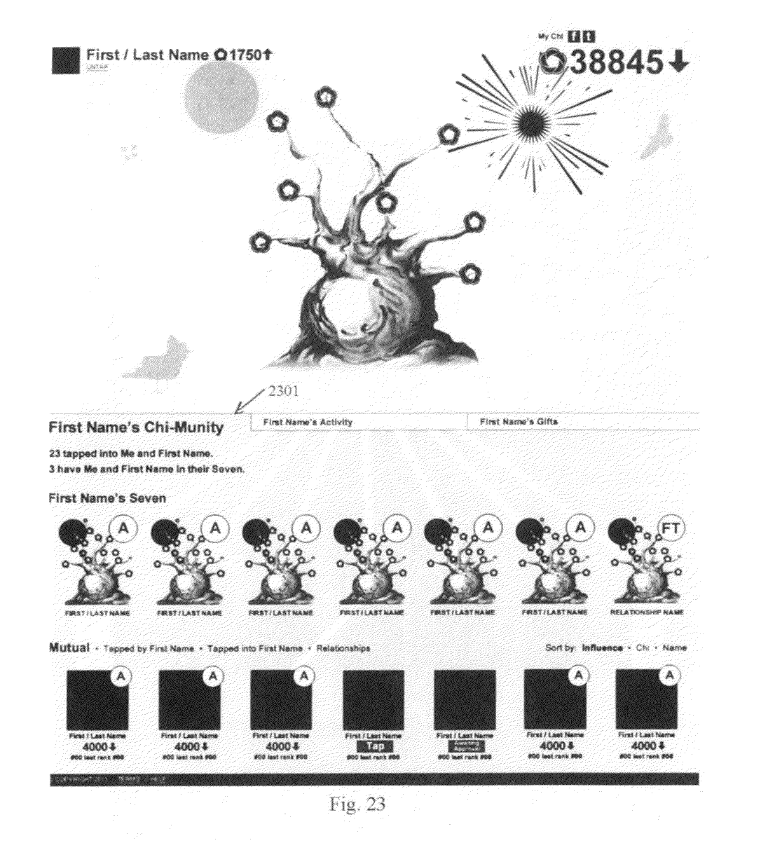

FIG. 20 shows the profile of an individual whom the user is not tapped into. In this figure item 2001 displays the Chi-Munity of a member the user is not tapped into. At this level of connection the member's Activity and Gifts tabs are not available to the user, nor is the ability to sort by influence or see who is in the member's Seven. Item 2002 shows connections the user has in common with the member whose page he is viewing. Item 2003 is the name of the member whose profile the user is viewing. Item 2004 is a thumbnail of the member whose profile the user is viewing. Item 2005 is an indicator of whether or not the user is tapped into the member whose profile he is viewing. Here the user will also have the ability to either tap or untap them the member whose profile he is viewing. Item 2006 is a numerical representation of the Chi of the member whose profile the user is viewing.

FIG. 21 shows the profile of an individual whom the user is tapped into but who is not tapped into the user. In this figure item 2101 displays the Chi-Munity of a member whom the user is tapped into, but who is not tapped into the user. At this level of connection the member's Activity and Gifts are available to the user as is the ability to sort the Chi-Munity by Influence. However the user can not see who is in the member's Seven. Item 2102 indicates whether or not the user is tapped into the member whose profile he is viewing. Here the user also has the ability to either tap or untap the member whose profile he is viewing.

FIG. 22 shows the profile of an individual whom the user is tapped into and who is also tapped into the user. In this figure item 2201 Displays the Chi-Munity of a member whom the user is tapped into and who is also tapped into the user. At this level of connection the member's Activity and Gifts are available to the user as is the ability to sort by Influence. The user can see who is in the member's Seven but cannot see the order in which the member has ranked them.

FIG. 23 shows the profile of an individual and who is in the user's My Seven. In this figure item 2301 Displays the Chi-Munity of a member the user is tapped into and placed in My Seven, who is also tapped into the user and placed him in their Seven. At this level of the member's Activity and Gifts are available to the user as is the ability to sort by Influence. The user can see who is in the member's Seven and the order in which the member has ranked them.

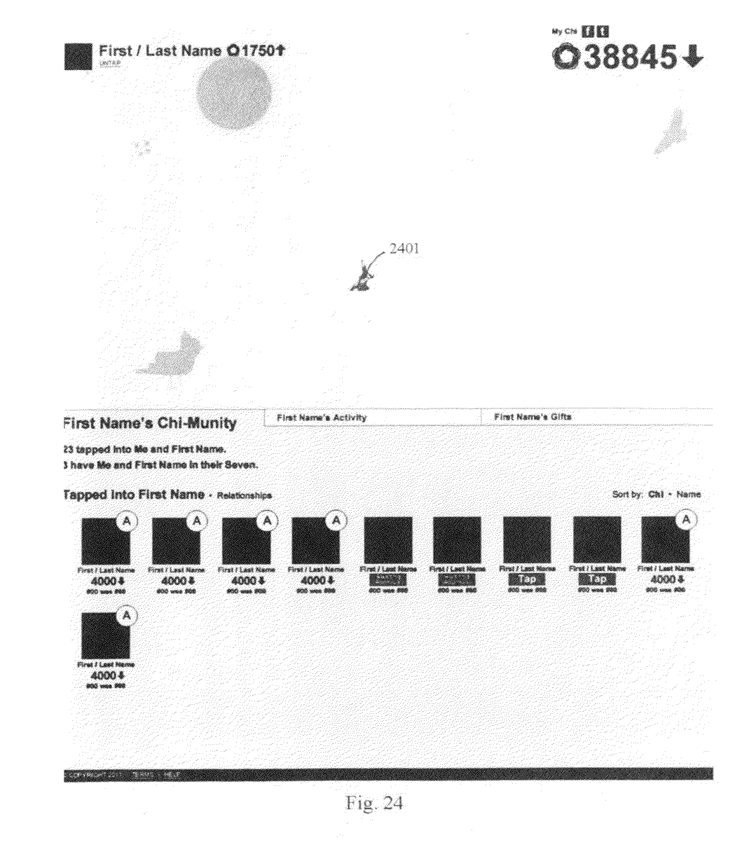

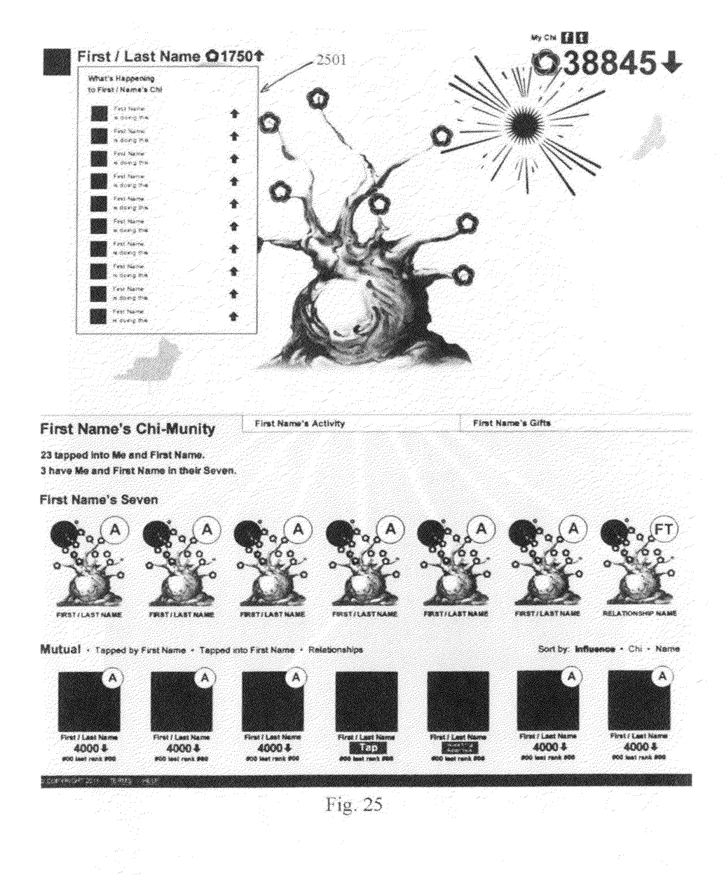

FIG. 24 shows the profile of an individual who has been invited to join the My Chi website but who has not yet joined. In this figure item 2401 is a graphical representation of a person who has been invited to join My Chi website but has not yet done joined.

FIG. 25 is a representation of a screen for displaying the top 10 events affecting the Chi of an individual whose profile is being viewed by the user. In this figure item 2501 is a list of the top 10 events affecting the Chi of the member whose profile the user is viewing. This list shows the effect these events are having on the member's Chi.

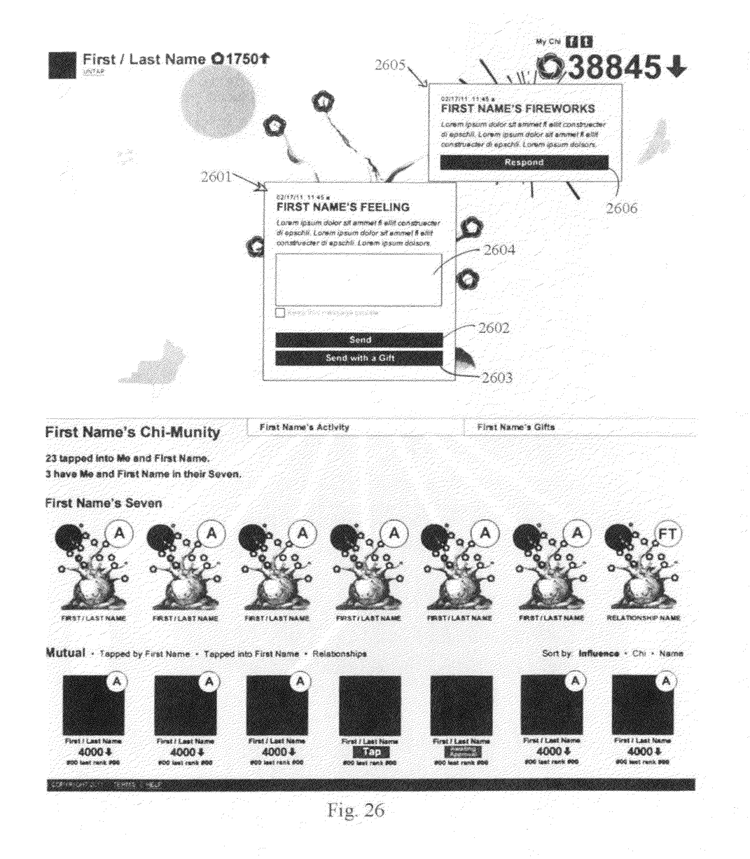

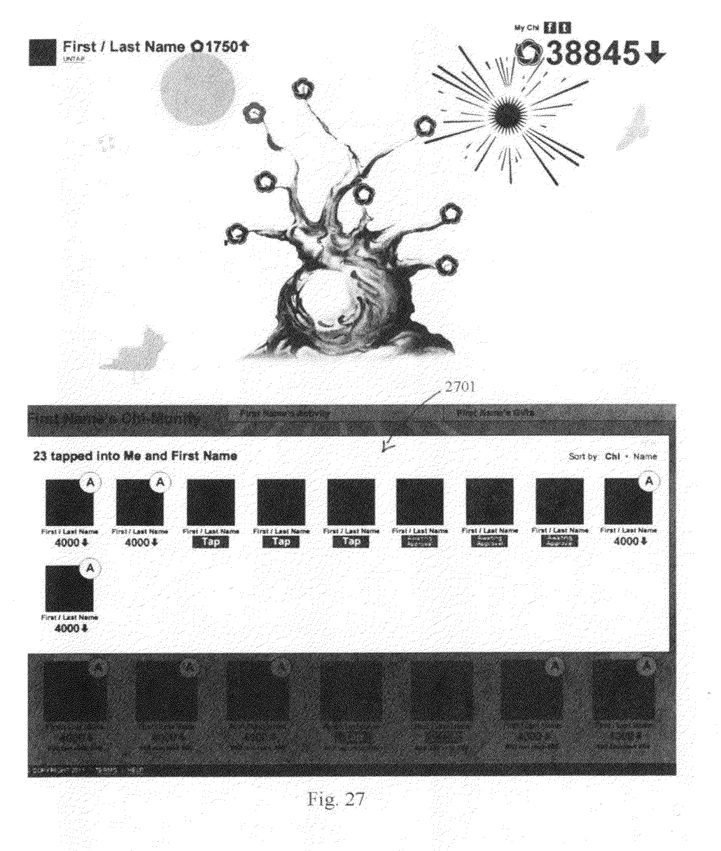

FIG. 26 is a representation of a screen for displaying a post from an individual whose profile is being viewed by the user. In this figure item 2601 is a window containing a post from the member whose profile the user is viewing. Item 2602 is a button allowing the user to send a text response to the member whose profile he is viewing. Item 2603 is a button allowing the user to send a text response to the member whose profile he is viewing with an attached gift. Item 2604 shows an input for entering a text response to the member's post. Item 2605 is a window containing a post from the member whose profile the user is viewing. Item 2606 is a button allowing the user to activate inputs in the window so he can respond to the member's post.

FIG. 27 is a representation of a screen for displaying each of the individuals that are connected to both the user and the individual whose profile is being viewed by the user. In this figure item 2701 shows a graphical representation of each of the members that are connected to both the user and the member whose profile he is viewing.

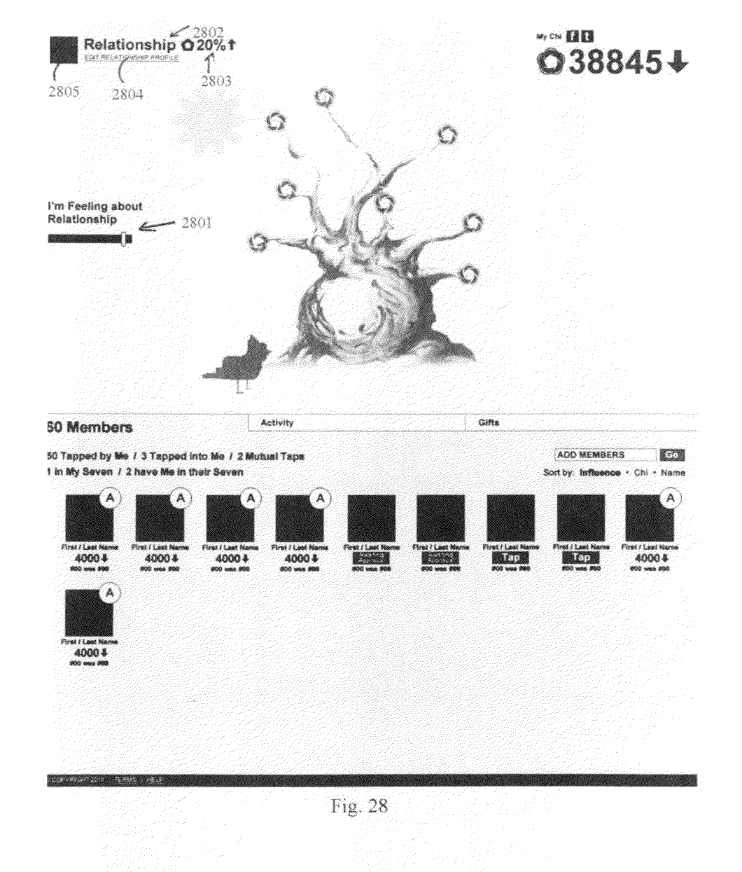

FIG. 28 is a representation of a screen allowing a user to adjust and post how the user is feeling about a relationship. In this figure item 2801 show an input allowing the user to adjust and post how they are feeling about a relationship. Item 2802 is the name of the Relationship the user is viewing. Item 2803 shows the percentage of change in the underlying value of the Chi of the relationship the user is viewing. Item 2804 indicates whether or not the user is a part of this relationship. This indicator also offers him the ability to join, edit or leave the relationship depending on his level of connection. Item 2805 shows the thumbnail of the relationship who's profile the user is viewing.

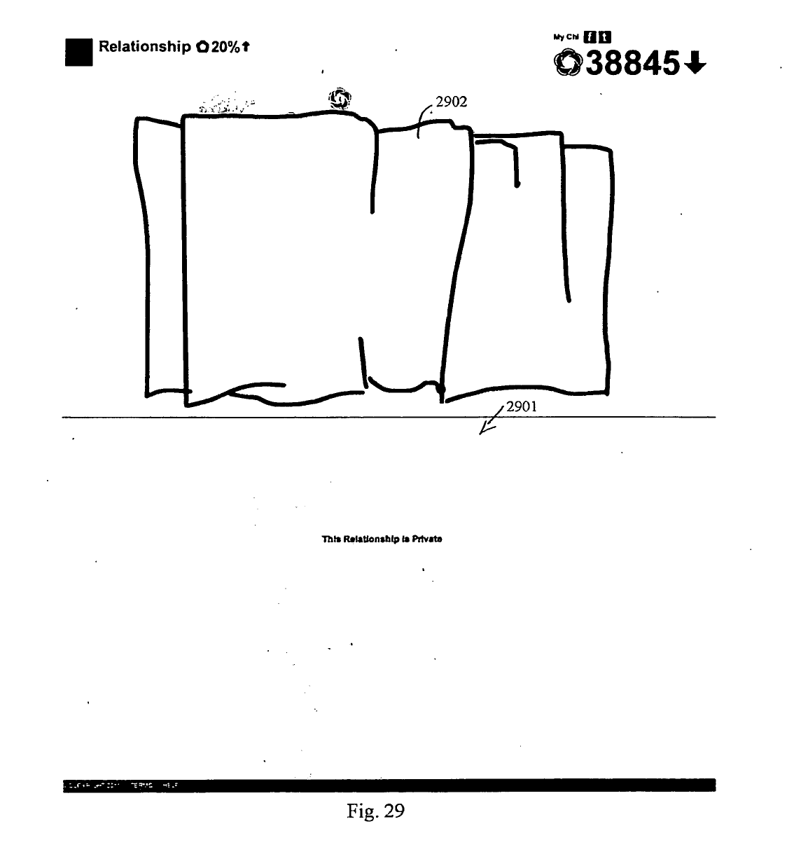

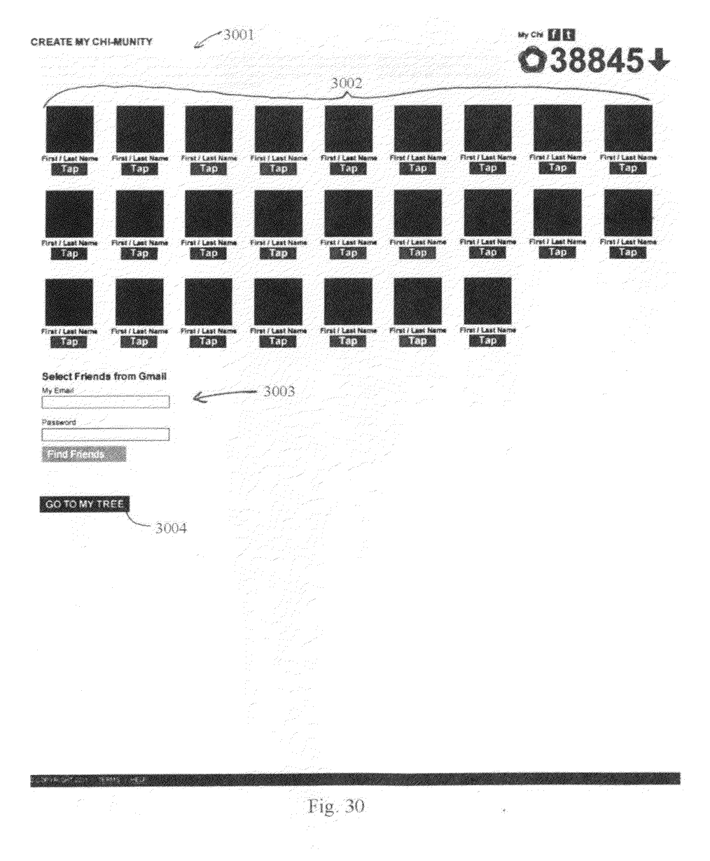

FIG. 29 is a representation of a screen informing the user that a relationship sought to be invoked by the user is private. In this figure item 2901 shows a message informing the user that this relationship is private. Item 2902 is a graphical representation of a curtain hiding the Relationship's tree from the user.

FIG. 30 is a representation of a screen by which a user may create the user's My Chi-Munity. In this figure item 3001 is instructions on what a Chi-Munity is and how to create one. Item 3002 is a set of thumbnails of people the algorithm suggests the user begin his Chi-Munity with. These suggestions are based on the user's Facebook interactions. Item 3003 shows an area for importing contacts from gmail. Item 3004 shows a button that completes the signup process and takes the user to his profile.

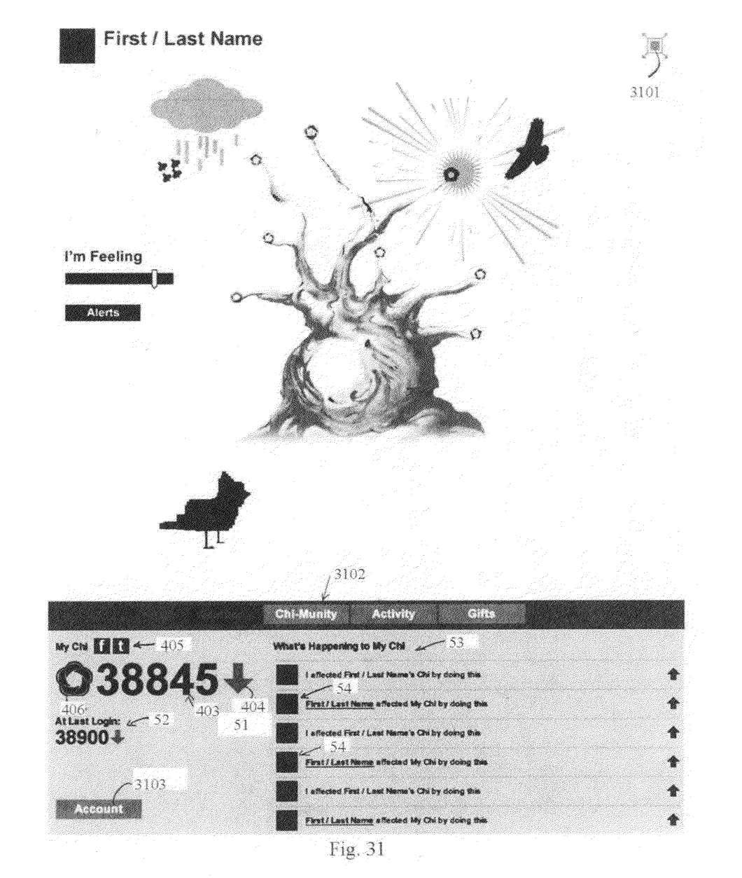

FIG. 31 is a representation of a typical screen display for use on an iPad device in accordance with an embodiment of the present invention. In this figure item 3101 is a button that enlarges the graphical representation of the user's weather, tree, messages and gifts to full screen. Item 3102 shows a tab system for navigating to Weather, Chi-Munity, Activity and Gifts. Item 3103 is a button that links to the user's account and profile information.

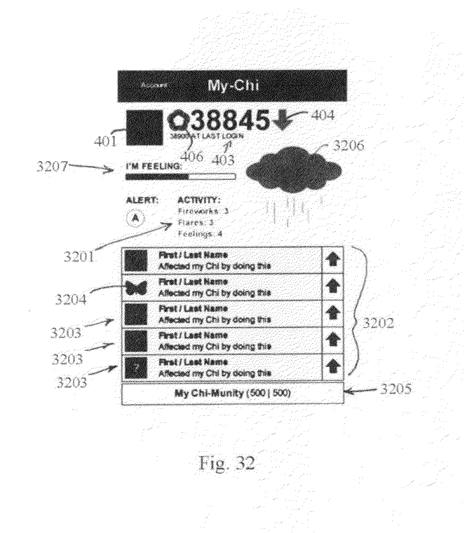

FIGS. 32-41 are representations of typical screen displays for use on an iPhone in accordance with an embodiment of the present invention.

FIG. 32 is a representation of the homepage display for use on an iPhone. In this figure item 3201 is a display of important recent events happening in my Activity. This display links to My Activity. Item 3202 lists the top 5 events affecting the user's Chi. Item 3203 is a thumbnail of the member who caused the corresponding event and what affect that event had on the user's Chi. Item 3204 indicates to the user that a Butterfly Effect has occurred as a result of the associated event. Item 3205 is a button that links to My Chi-Munity. Item 3206 shows a graphical representation of an up or down trend in the user's Chi using weather as a metaphor. Item 3207 shows a graphical representation of “I'm Feeling”. This icon links to a screen where the user can adjust his “I'm Feeling” bar.

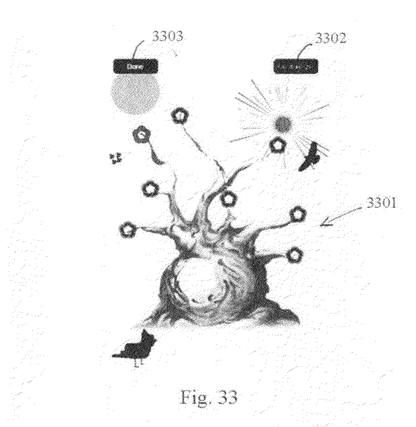

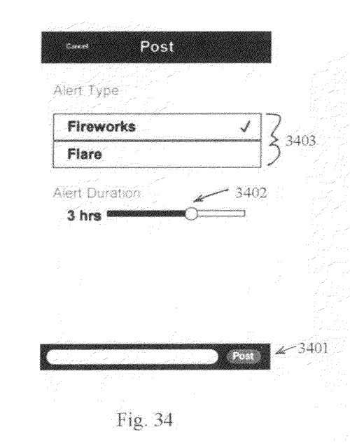

FIG. 33 is a representation of the homepage of FIG. 32 but with full-screen images invoked. In this figure item 3301 shows a full screen graphical representation of the user's weather, tree, messages and gifts. Item 3302 is a button allowing the user to customize the look of his tree. Item 3303 is a button that exits from the full screen view returning the user to the previous page.

FIG. 34 is a representation of a screen for defining an alert. In this figure item 3401 is an input for adding text to an alert. Item 3402 is an input for setting the duration of time the alert is displayed. Item 3403 shows an input for setting the type of alert that is displayed.

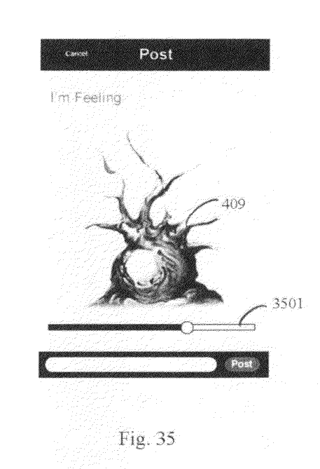

FIG. 35 is a representation of a screen for providing a setting for I'm Feeling. In this figure item 3501 shows an input for setting “I'm Feeling”.

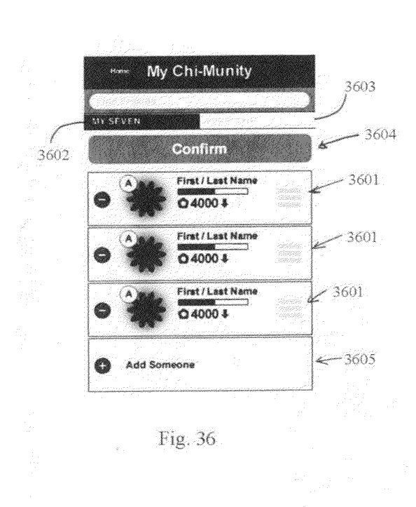

FIG. 36 is a representation of a display of My Seven. In this figure item 3601 displays the profile of a member who has been placed in the user's My Seven. This display shows a graphical representations of the member's Chi trend using weather as a metaphor, “I'm Feeling” and alerts. It also shows the member's name and a numerical representation of his Chi. Item 3602 is a link that sorts My Chi-Munity to display only members in My Seven. Item 3603 is a link that sorts My Chi-Munity to display everyone in My Chi-Munity. Item 3604 is a button to initiate or confirm reorganizing, adding or removing members from My Seven.

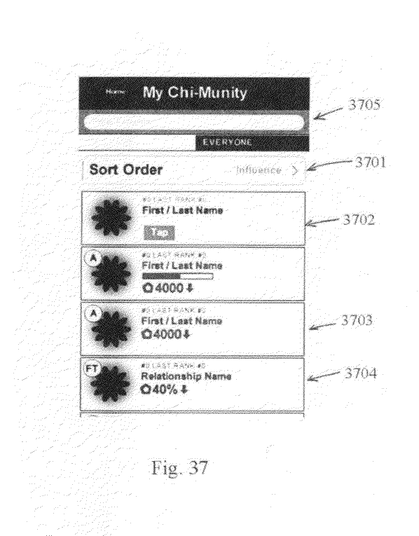

FIG. 37 is a representation of a display of My Seven as in FIG. 36, wherein there has been a sort according to a specified criterion. In this figure item 3701 is a link that sorts My Chi-Munity. The influence each member is having on the user's Chi, the value of each member's Chi, or the name of each member alphabetically may be chosen as a method of sort. Item 3702 is a link to the profile of a member the user is not tapped into. This link shows a graphical representations of the member's Chi trend using weather as a metaphor as well as his name. Item 3703 is a link to the profile of a member the user is tapped into. This link shows graphical representations of the member's Chi trend and alerts as well as his name and a numerical representation of his Chi. Item 3704 is a link to the profile of a Relationship the user is a part of. This link shows a graphical representation of the relationship's Chi trend and Feeling trend as well as the Relationship name and the percentage of change in the underlying value of the Chi of the Relationship. Item 3705 is a search bar for finding people to add to My Chi-Munity.

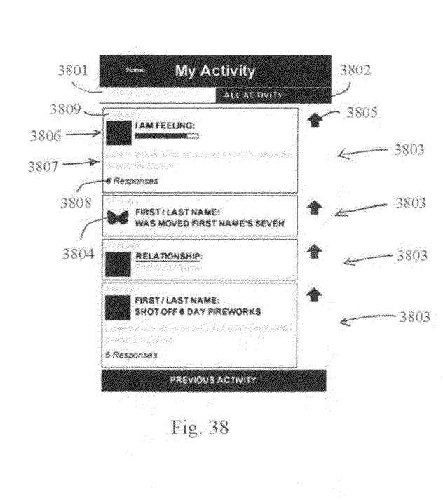

FIG. 38 is a representation of a display of My Activity. In this figure item 3801 is a link that sorts My Activity to display only the events that are awaiting a response from the user. Item 3802 is a link that sorts My Activity to display all the events that are affecting the user's Chi. Item 3803 is a module showing an event that has affected the user's Chi. Item 3804 indicates to the user that a Butterfly Effect has occurred as a result of the associated event. Item 3805 is a graphical representation of the effect this event is having on the user's Chi. Item 3806 is a thumbnail of the member whose profile the user is viewing. Item 3807 is a description of the event and the name of the member who initiated it. Item 3808 is the number of responses this event has received. Item 3809 is a timestamp on the event when it was initiated.

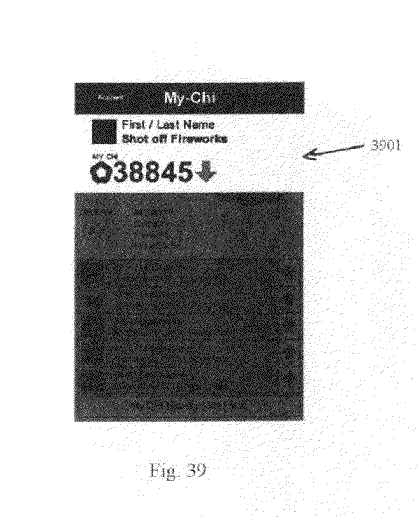

FIG. 39 is a representation of a display providing a notification. In this figure item 3901 shows the area where notifications are displayed to the user about anything event that affects his Chi.

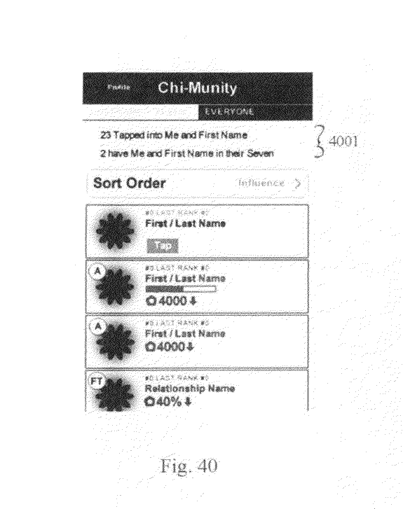

FIG. 40 is a representation of a display of connections that the user has in common with an individual whose Chi-Munity is being viewed by the user. In this figure item 4001 shows the connections that the user has in common with the member whose Chi-Munity he is viewing.

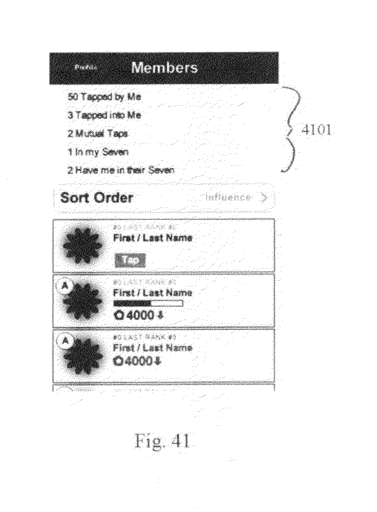

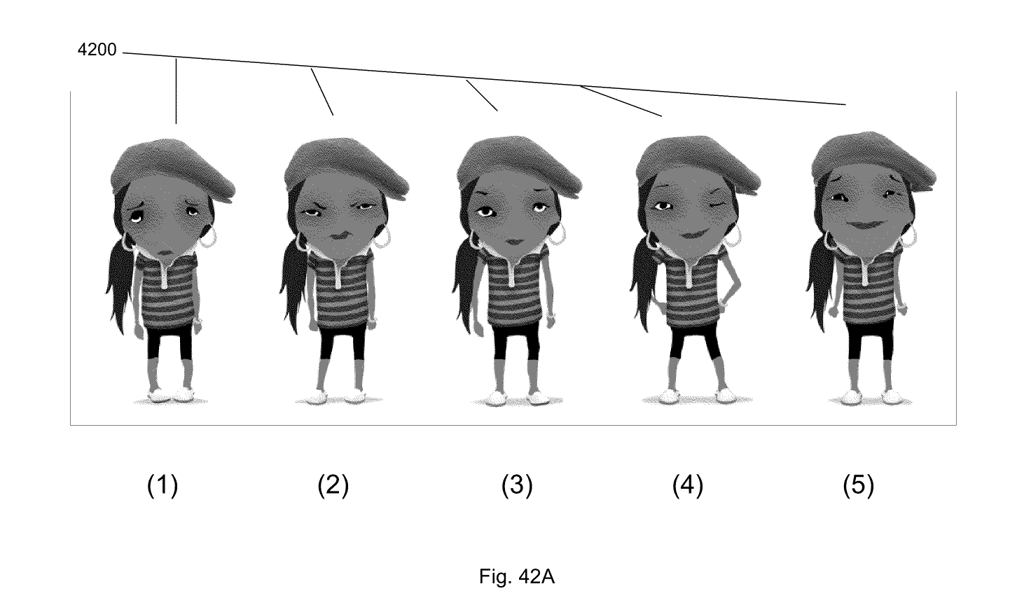

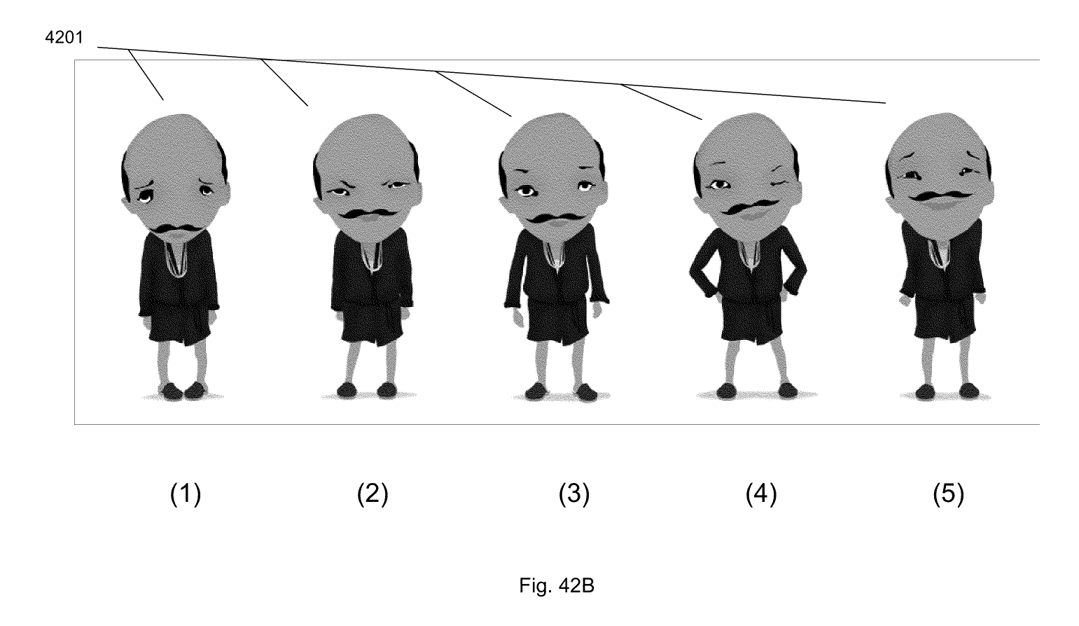

FIG. 41 is a representation of a display of connections that the user has in common with individuals of the relationship being viewed by the user. In this figure item 4101 shows the connections the user has in common with the members of the relationship he is viewing.

It will be appreciated that user data 121 of FIG. 1 can be utilized in a variety of ways. For example, one might access the Chi score of all users having an address in user data 121 that lies within a given geographic area, such as a city or a zip code, and then compute an average Chi score within the given geographic area. This data can be accessed by a query to the database storing user data 121. After the data is accessed an average can be computed.

In an embodiment of the present invention a user can designate a geographic area of interest and trigger such a query for the designated geographic area to arrive at an average Chi for the designated geographic area.

In a further related embodiment, once the average Chi for a given geographic area has been determined, it becomes possible to determine the average Chi on two successive occasions, such as on successive days, and thereafter to determine a trend for the average for the designated geographic region. Just as a trend in a member's Chi can be shown by the arrow 404 of FIG. 4, so can a trend for the average be indicated by an arrow. However, the trend for a geographic region might also be displayed in another manner. For example, if the designated geographic area is New York City, one might employ the Empire State Building as a symbol for New York City, and illustrate a Chi trend by a blinking light on top of the building: a blinking red light on the building might thus indicate a downward trend for the average Chi in New York City whereas a blinking blue light on the building might indicate an upward trend for the average Chi in New York City.

Although we have discussed the use of averages obtained for designated geographic region, other criteria, such as averages of Chi for users in a given school or for users participating as spectators in an event such as the Super Bowl, can similarly be obtained.

In yet another further embodiment, there may be employed as a “Relationship” some societal event or phenomenon, such as the Egyptian revolution or Major League Baseball. This kind of Relationship may be handled in precisely the same manner as other forms of Relationship as described above. In that way, a Relationship can contribute to a user's Chi, and a user can indicate also how the user feels about the Relationship, as described above in connection with FIG. 28. One can then also determine dynamically, an average of how users feel about the Relationship. Optionally, a user may be enabled to obtain this average and to obtain also trend information.

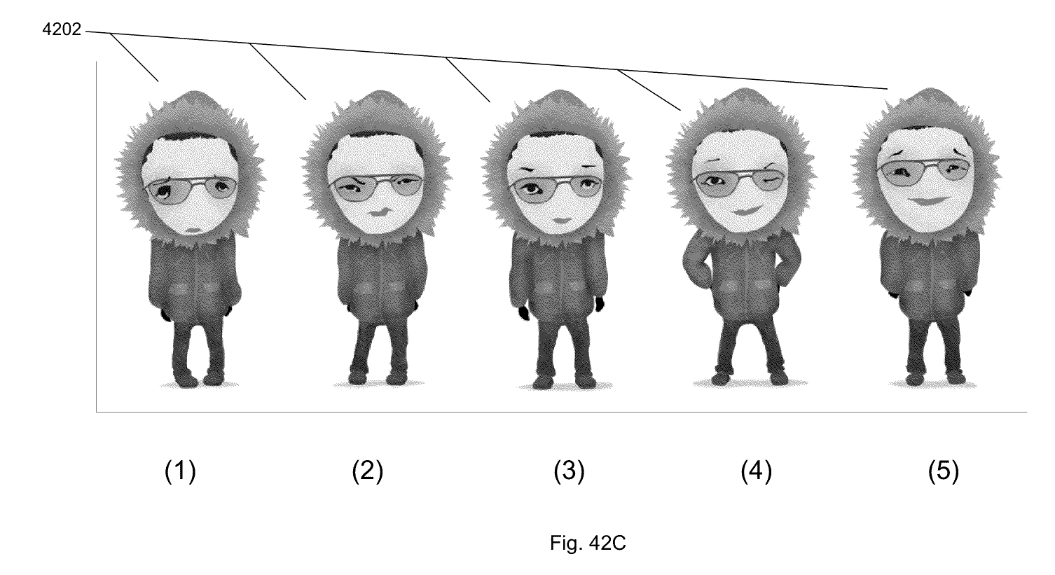

Although the embodiments described above illustrate a user's Chi with a tree, other embodiments represent a user with an anthropomorphic avatar, such as those illustrated in FIGS. 42A-42C. An anthropomorphic avatar has one or more anthropomorphic features that are intuitive to people, and thereby facilitate communication of the user's Chi. For example, an avatar in the image of a human may have facial features and/or a posture that change dynamically as a function of the user's Chi.

An exemplary anthropomorphic avatar 4200 is illustrated in several states in FIG. 42A. A low Chi may be represented by the avatar 4200 in FIG. 42A(1)—for example a Chi of 20 points or lower for an allowed Chi range of 100 points. In contrast, the avatar in FIG. 42A(5), which represents the same user but with a high Chi (for example, a Chi of 80 points or higher). As compared to the avatar 4200 in FIG. 42A(5), the low-Chi avatar of FIG. 42A(1) has a slouching posture, and facial features indicative of a sad or depressed mood. Other avatars, such as those in FIGS. 42A(2)-(4) have postures and facial features that indicate the user's Chi at various points in-between the low Chi of FIG. 42A(1) and the high Chi of FIG. 42A(5). FIGS. 42B(1)-(5) and FIGS. 42C(1)-(5) illustrate alternate avatars with facial features and postures that vary dynamically with the user's Chi. A user may therefore select from any number of avatars at any given time, and may even change avatars at will or according to the user's momentary whim.

Although FIGS. 42A(1)-(5) show five avatars to express a range of Chi, any number of avatars could be used, either more or less than five, to express a range of Chi points. Further, the range of Chi represented by a particular incarnation of an avatar need not be the same as the range of any other avatar. For example, if five avatars represent a Chi-range of 100 points, each incarnation of an avatar my cover 20 Chi points. Alternately, the lowest avatar (e.g., FIG. 42A(1)) may represent a Chi of 0-10 points, while the highest avatar (e.g., FIG. 42A(5)) may represent a Chi of 91-100 points, while the remaining 80 Chi points (11-90) may be distributed over the remaining three avatars (FIGS. 42A(2)-(4)).

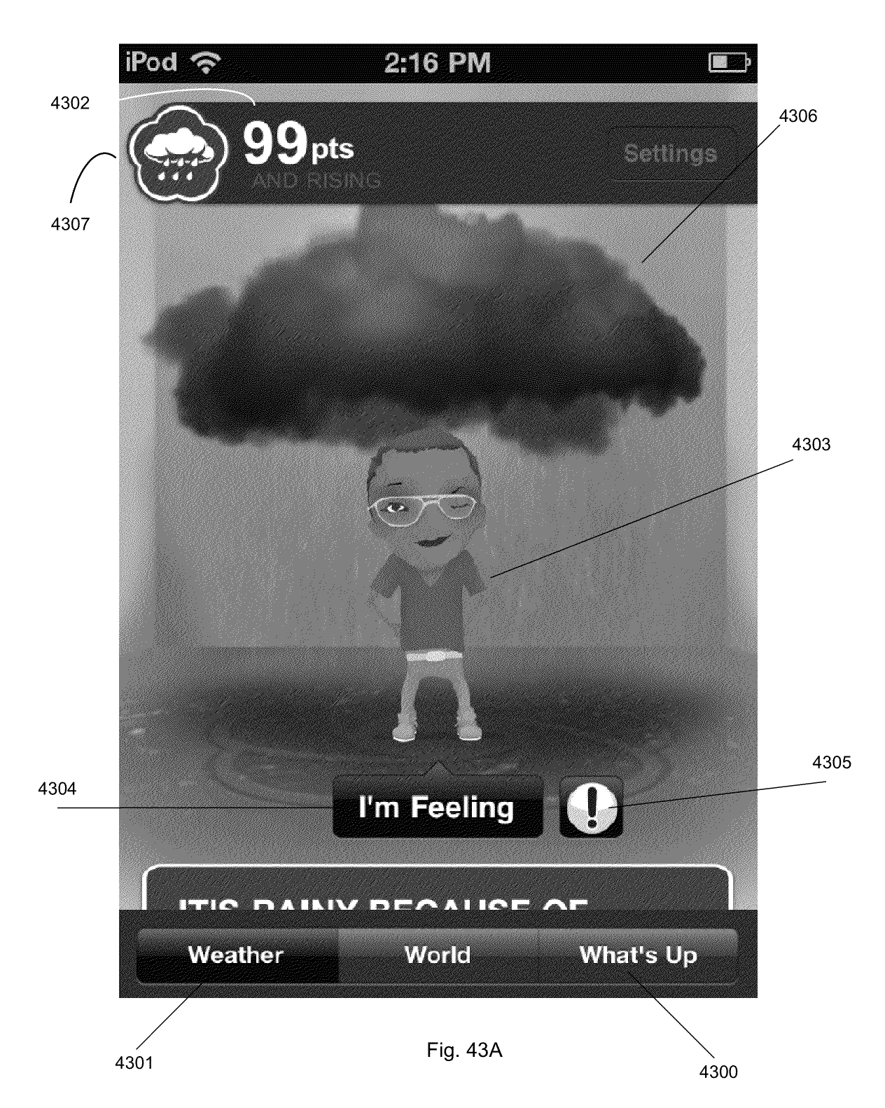

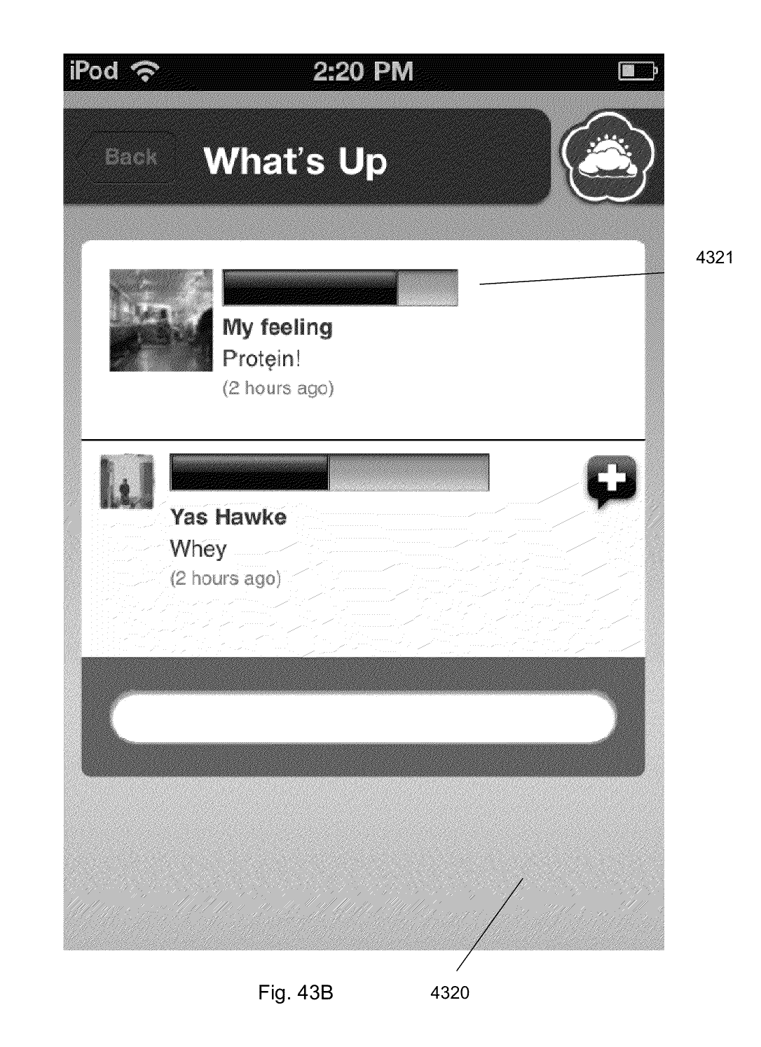

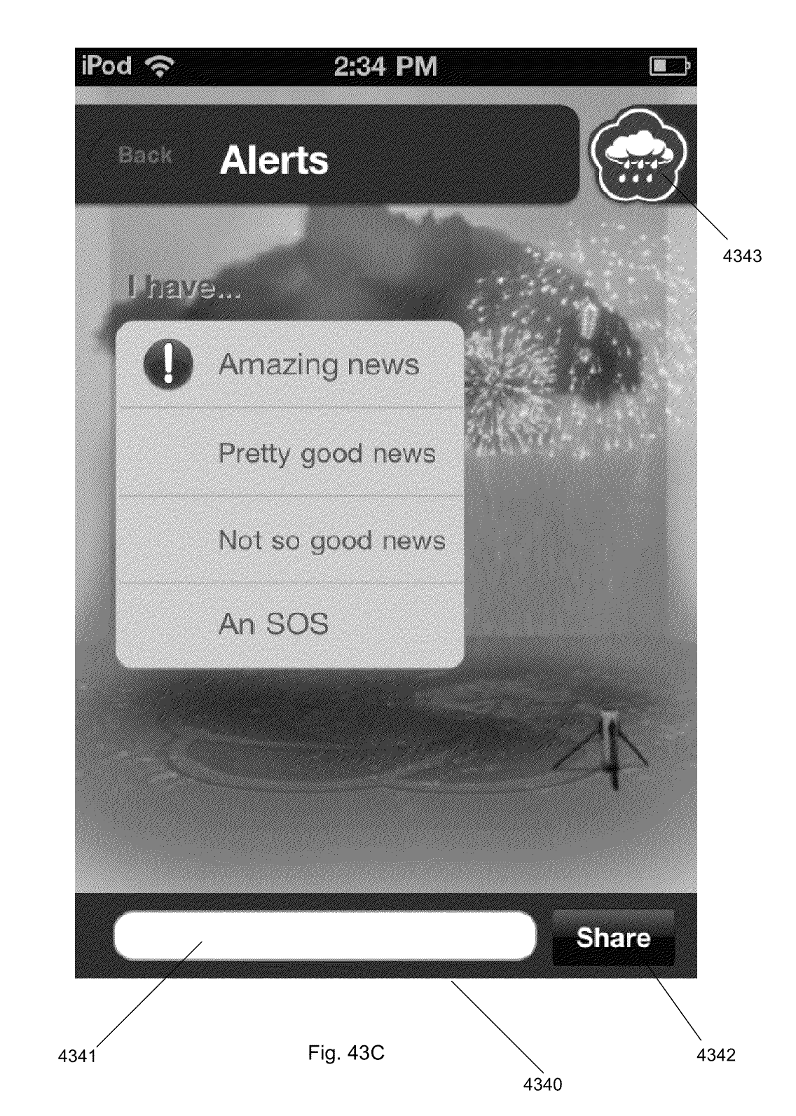

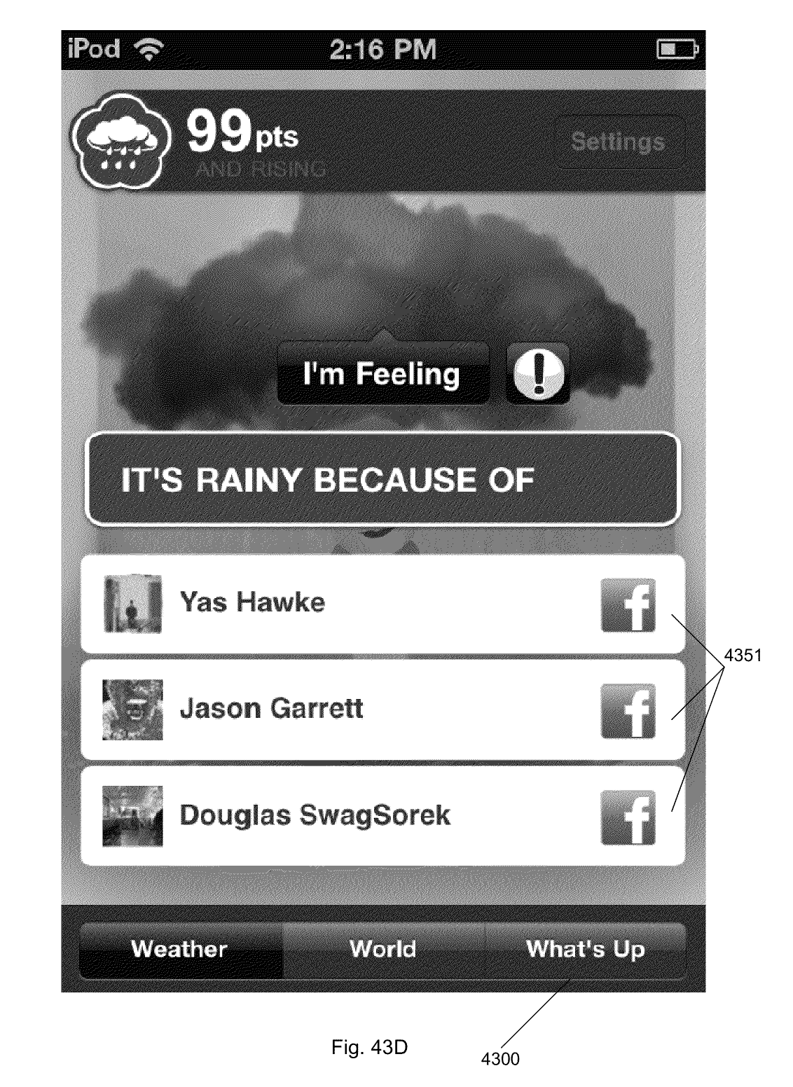

An embodiment employing anthropomorphic avatars is illustrated by FIGS. 43(A)-45(F). The screen images of this embodiment may represent images the screen of a mobile device, such as an iPhone for example. The description below assumes that the images are presented on an iPhone with a touch-screen interface, although the embodiment is not limited to any particular device or platform.

This embodiment presents three tabs (“Weather,” “World,” and “What's Up”). Each tab represents a distinct user-interface screen, and activating a tab (e.g., touching the tab on a touch-screen device) navigates the user to the associated user-interface screen.

The “Weather” tab 4301 navigates the user to the Weather screen 4300, which may be considered to be like a “home page.” In this embodiment, the three user-interface screens are rectangular. In the case of the Weather screen 4300, the top portion of the rectangular screen is illustrated in FIG. 43A, and the bottom of the screen is illustrated in FIG. 43D.

The Weather screen 4300 presents an overview of the user's Chi and the Chi of the user's Chi-munity. In FIG. 43A, the user has a Chi of 99 (and it is rising) as reported by icon 4302 and Chi score. The appearance (e.g., facial expression and body posture) user's anthropomorphic avatar 4303 reflects that the user's self-assessment of his Chi, and is not a function of a calculated Chi score. The user may adjust his Chi by touching the “I'm Feeling” icon 4304, which will navigate the user to another screen 4320, as shown in FIG. 43B, at which the user represented by the avatar 4303 can modify his or her own Chi using the “I'm Feeling” graphic 4321 (see also the “I'm Feeling” graphic 413 in FIG. 8). Changing the “I'm Feeling” score (e.g., moving the slider) alters the avatar's facial expression and posture. In some embodiments, text can optionally be appended to a particular post.

Although the “I'm Feeling” graphic 4321 is illustrated as a slider bar in FIG. 43B, any variety of user interfaces could be used, including for example a graphical dial or knob, or even a numerical-input box.

Adjacent to the Chi score is a small icon 4307, in the case of FIG. 43A, it is a rain cloud. This small icon dynamically changes to match the weather, as shown by the rain cloud 4306 above the head of avatar 4303.

Adjacent to the “I'm Feeling” icon 4304 in FIG. 43A is an “Alert” icon 4305, which in this embodiment takes the form of an encircled exclamation point (!) within a square. Activating (e.g., touching or clicking-on) the Alert icon 4305 navigates the user to the page 4340 illustrated in FIG. 43C. From this screen, the user who is represented by the avatar 4304 can post an “alert” to the user's Chi-munity. The alert can have one of several levels of quality, in this embodiment ranging from “Amazing news” (for example, if the user has won the lottery), to “An SOS” (for example, a cry for help). At the bottom of the screen is a text box 4341 in which the user can enter text to accompany the alert (e.g., “I just won the lottery!!!”). Then, activating the “Share” icon 4342 broadcasts the alert to the user's Chi-munity. Sending an alert with a quality of “Amazing News” or “Pretty Good” will cause a fireworks to display on the Weather screen, while sending an alert with a quality of “Not so good” or “SOS” causes flares to display on the Weather screen.

At the upper-right of the screen in FIG. 43C is a raincloud icon 4343. Activating this icon 4343 will return the user to his or her home page (e.g., the Weather page 4300), and so the icon 4343 may be known as the “home” icon. The appearance of the icon 4343 may be fixed, or may dynamically change appearance to match the weather shown on the Weather page 4300. In the example of FIG. 43C, the home icon 4343 is a raincloud to match the weather on the home page 4300, as described more fully below.

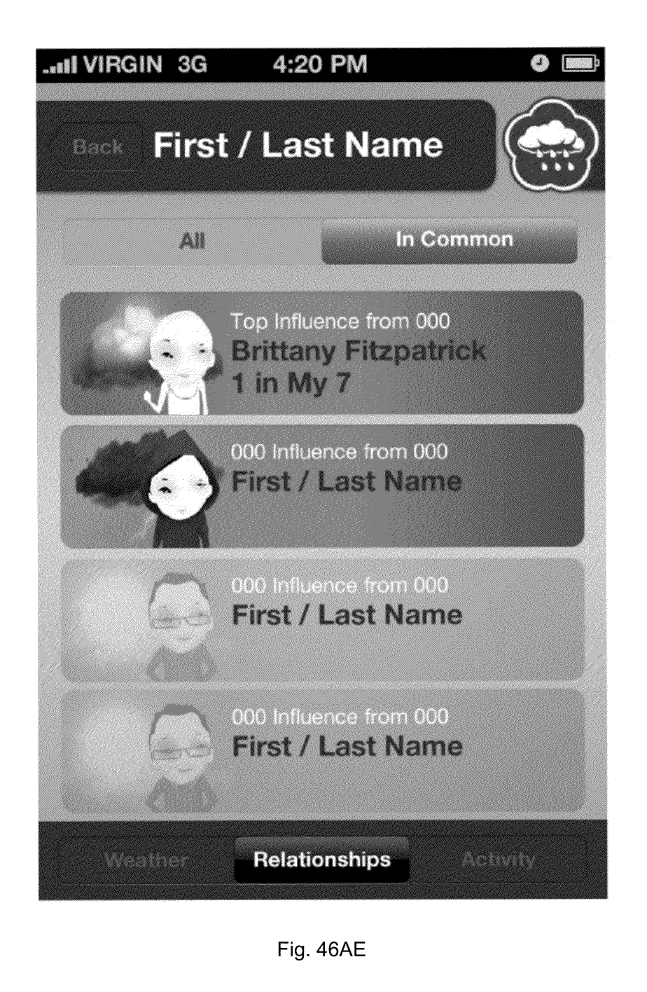

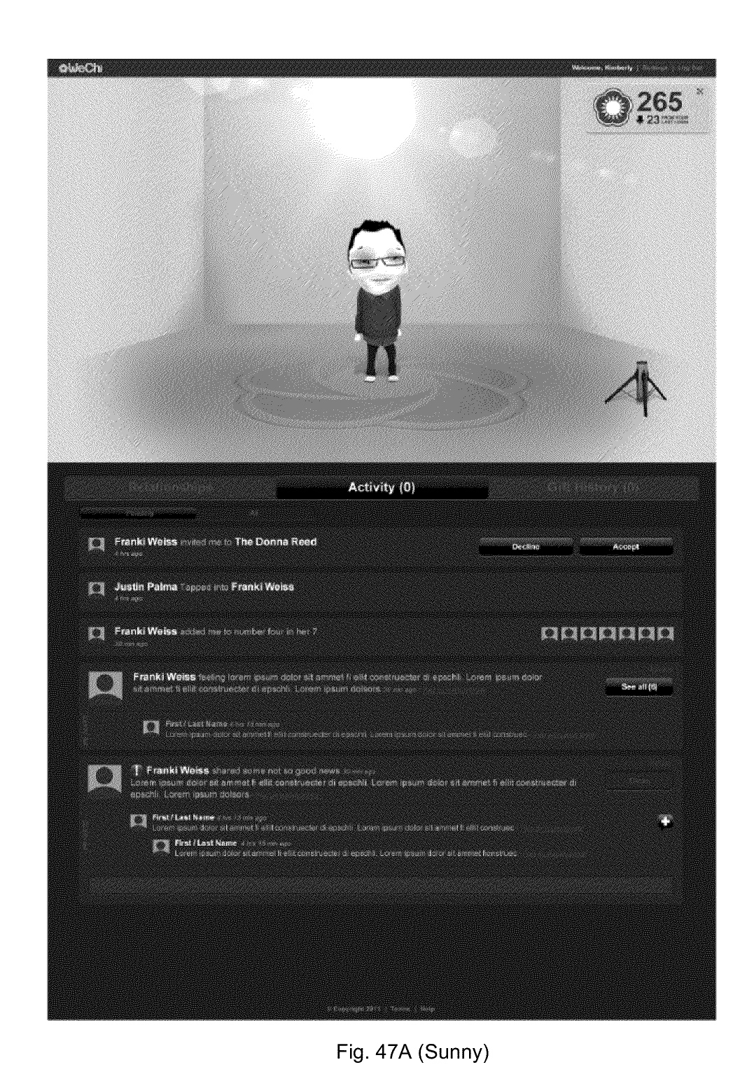

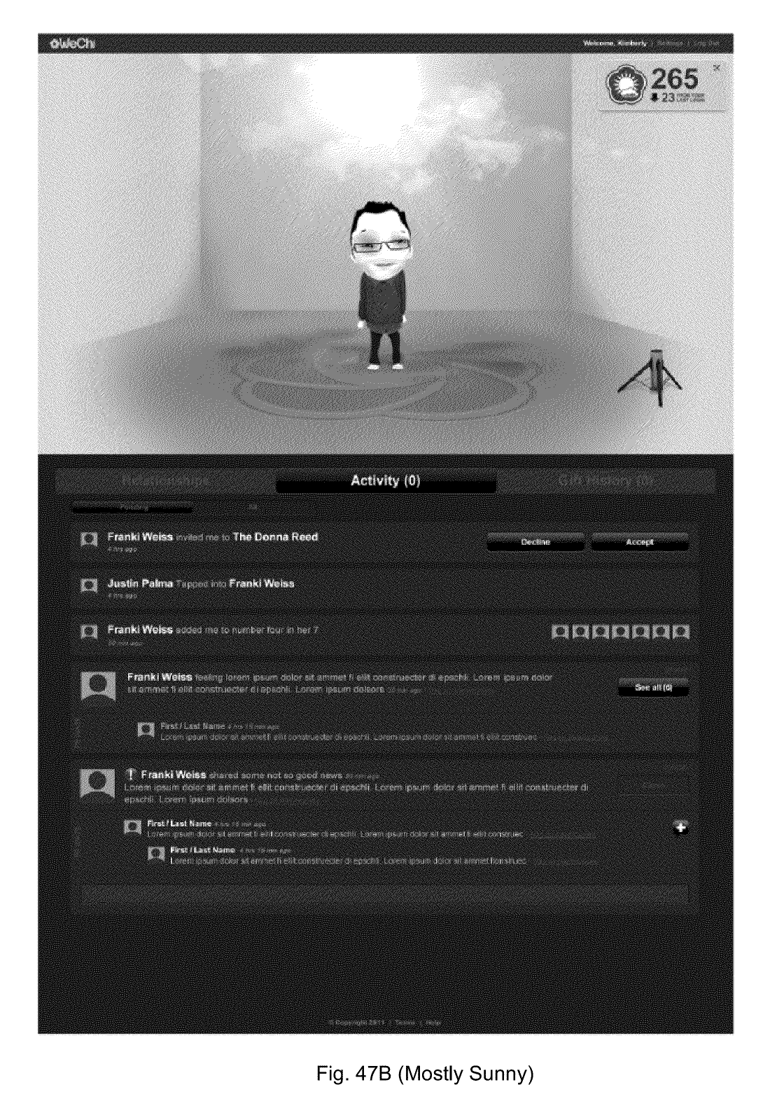

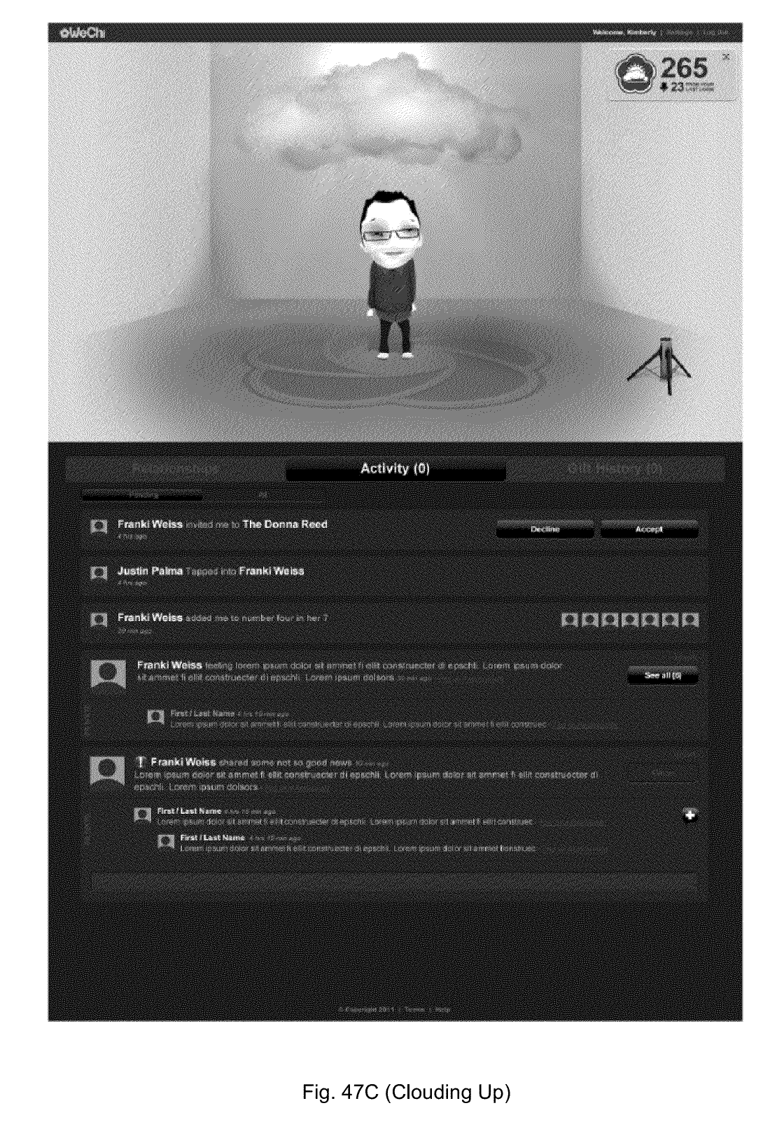

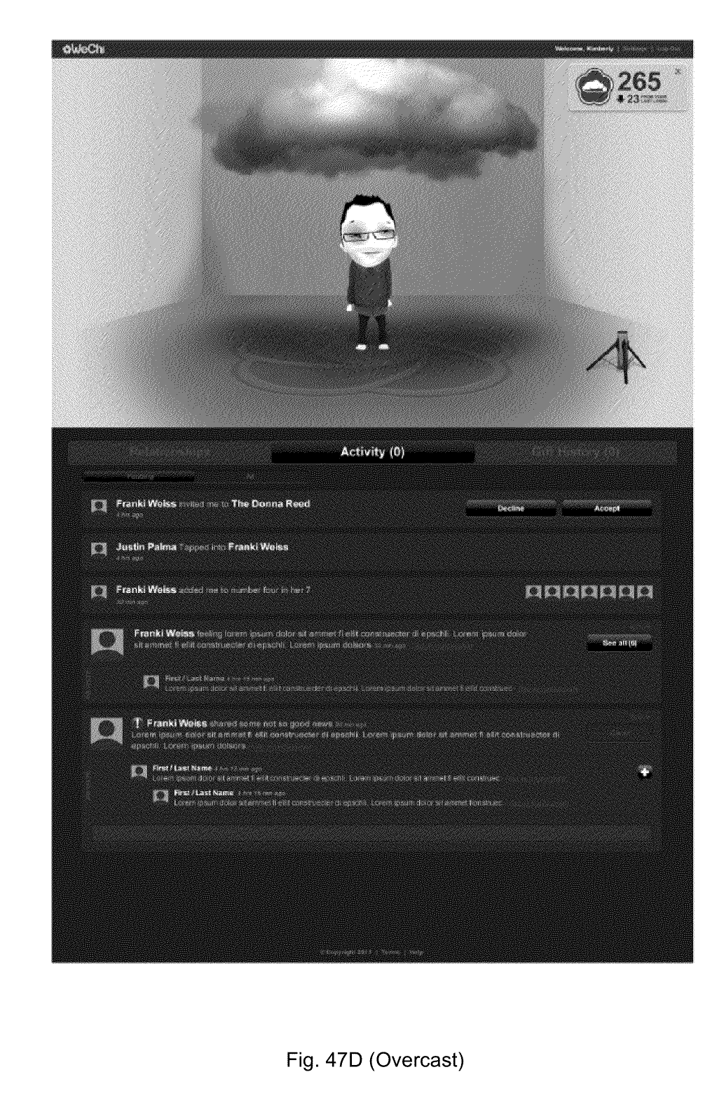

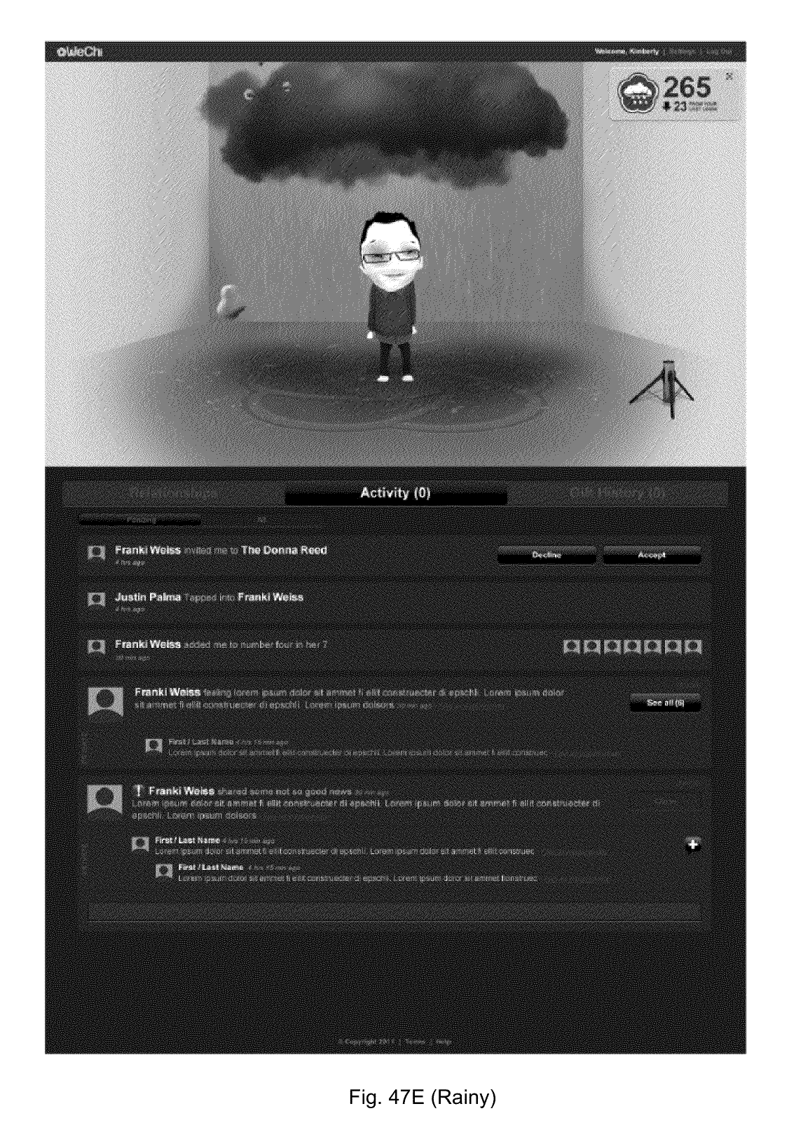

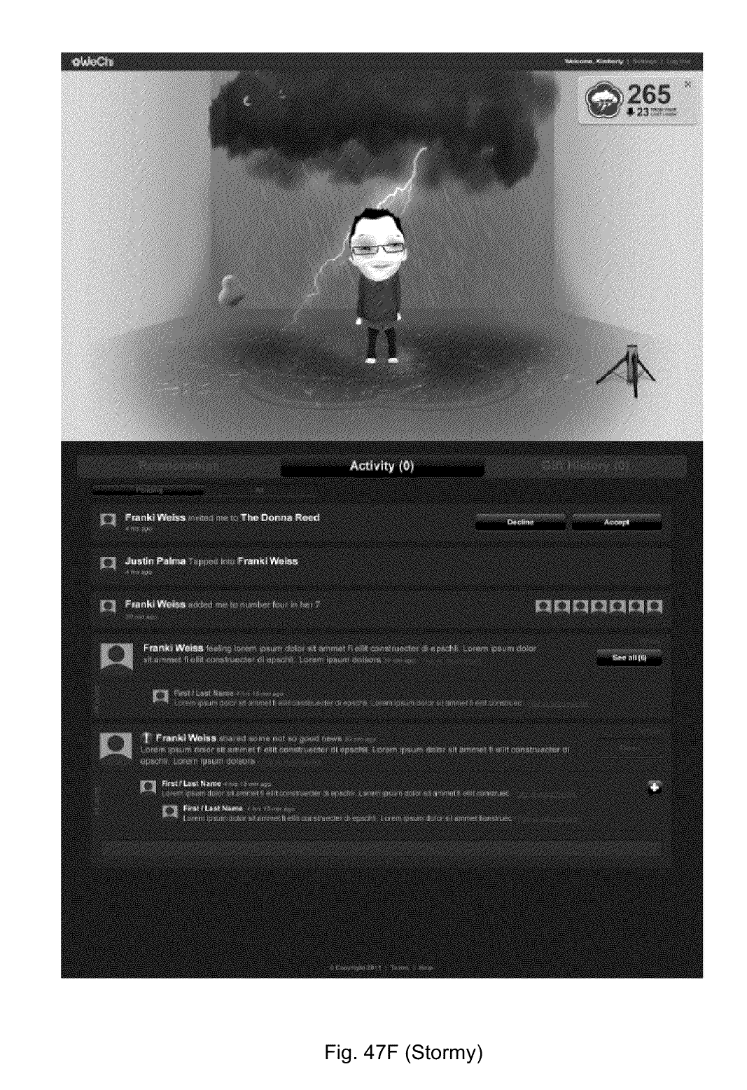

Returning to the Weather screen 4300 in FIG. 43A, we see that (in contrast to the high-Chi represented by avatar 4303) the rain cloud 4306 over the avatar 4303 indicates that the user's Chi-munity has a low score. This weather state might be described as “rainy” (see, e.g., FIGS. 47A-47F). In addition, the Weather screen—provides to the viewer information about the basis for the Weather—in this case, as to why the weather is rainy (“It's Rainy Because Of”).

In FIG. 43D, the weather is determined as a function of activity of three members of the user's Chi-munity (specifically, Yas Hawke, Jason Garrett, and Douglas SwagSorek). Note that the members of a user's Chi-munity are other members to whom the user “listens to.” That act of (or status of) “listening to” another member is equivalent to “tapping into” another member, as described in connection with an earlier embodiment, and those terms can be used interchangeably. From the page 4300 illustrated in FIG. 43D, the user can investigate the activities (e.g., postings and responses) of those members of the user's Chi-unity. Further, activating the “f′ icon 4351 allows the user (or anyone else viewing this page) to post a comment or response to Facebook. In some embodiments, activating the “f′ icon posts an entry on the user's Facebook wall citing the user's weather and the person affecting the user's weather.

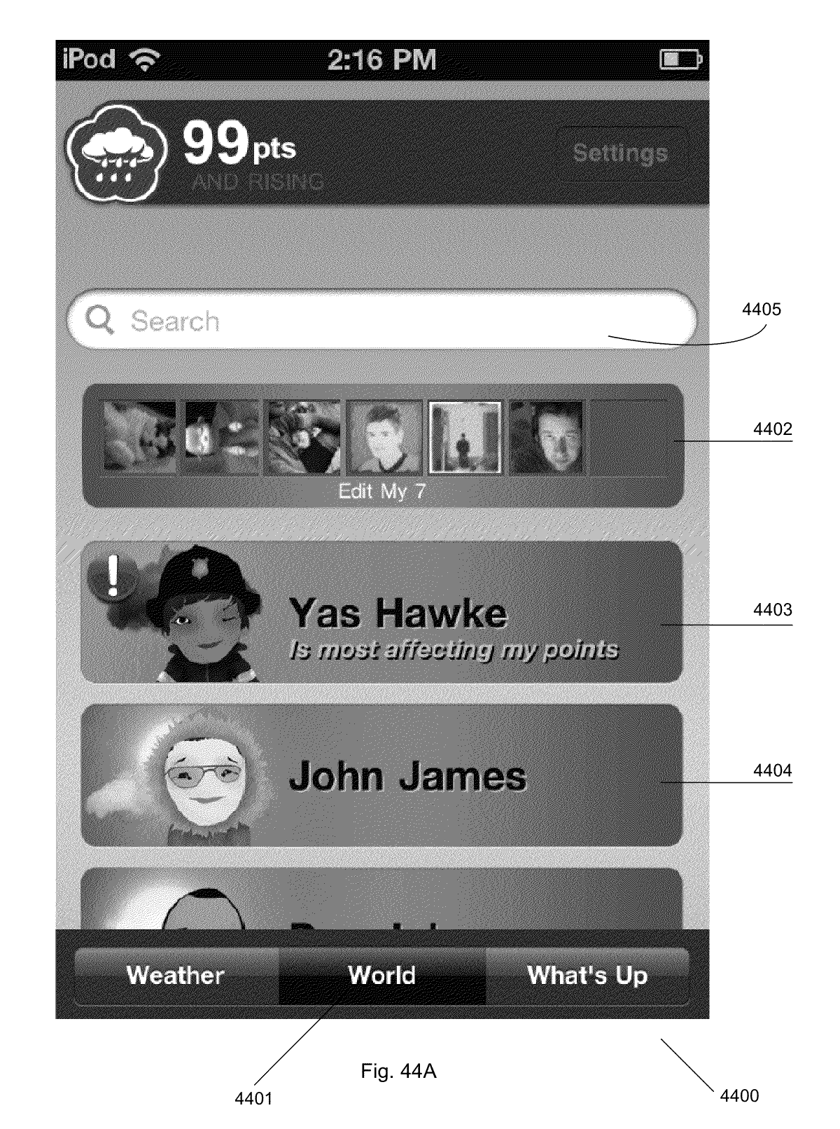

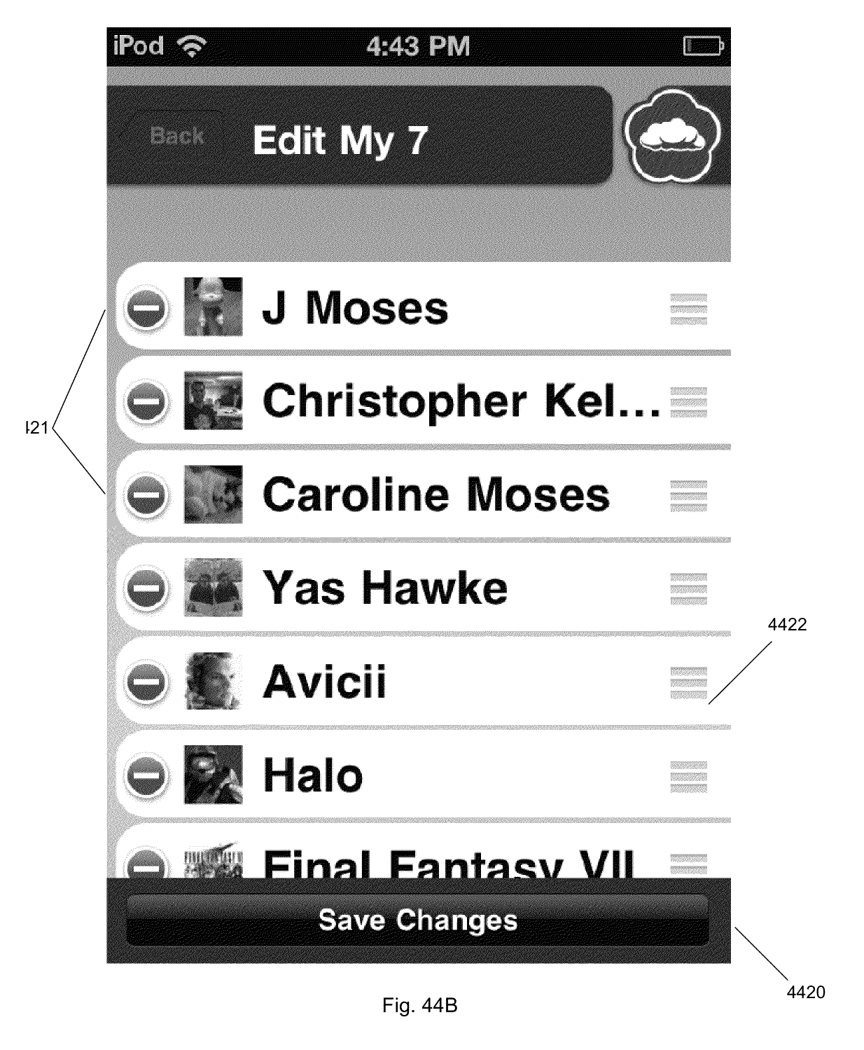

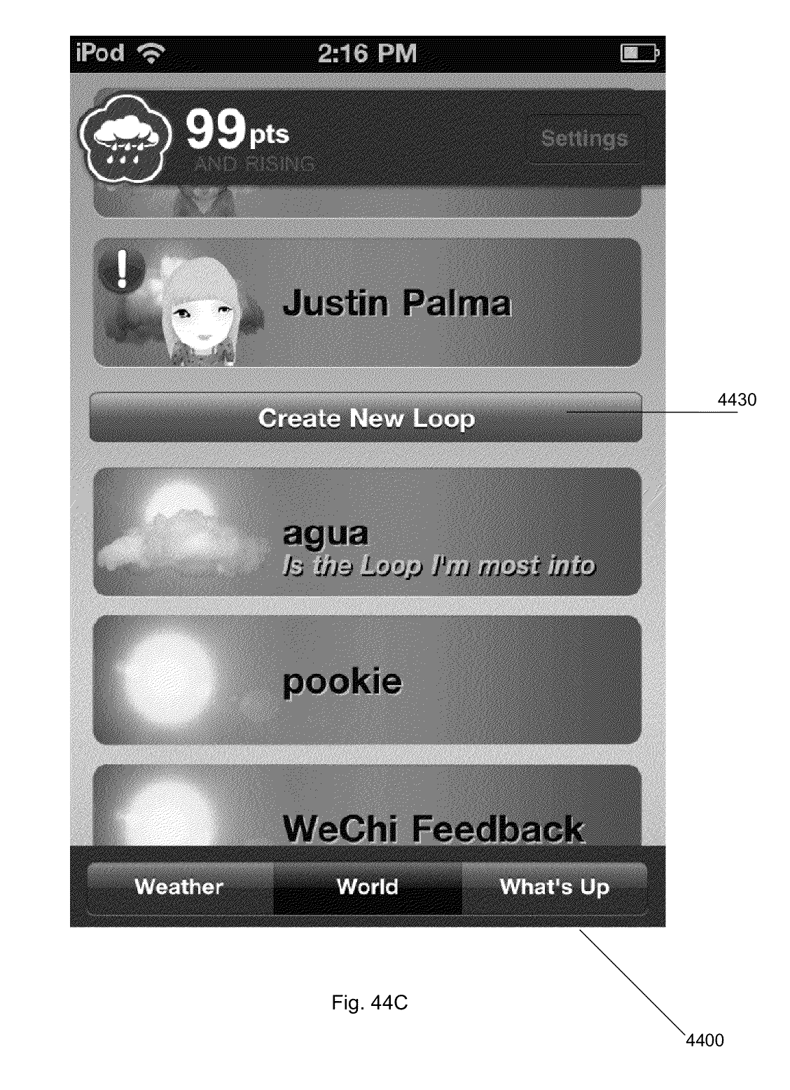

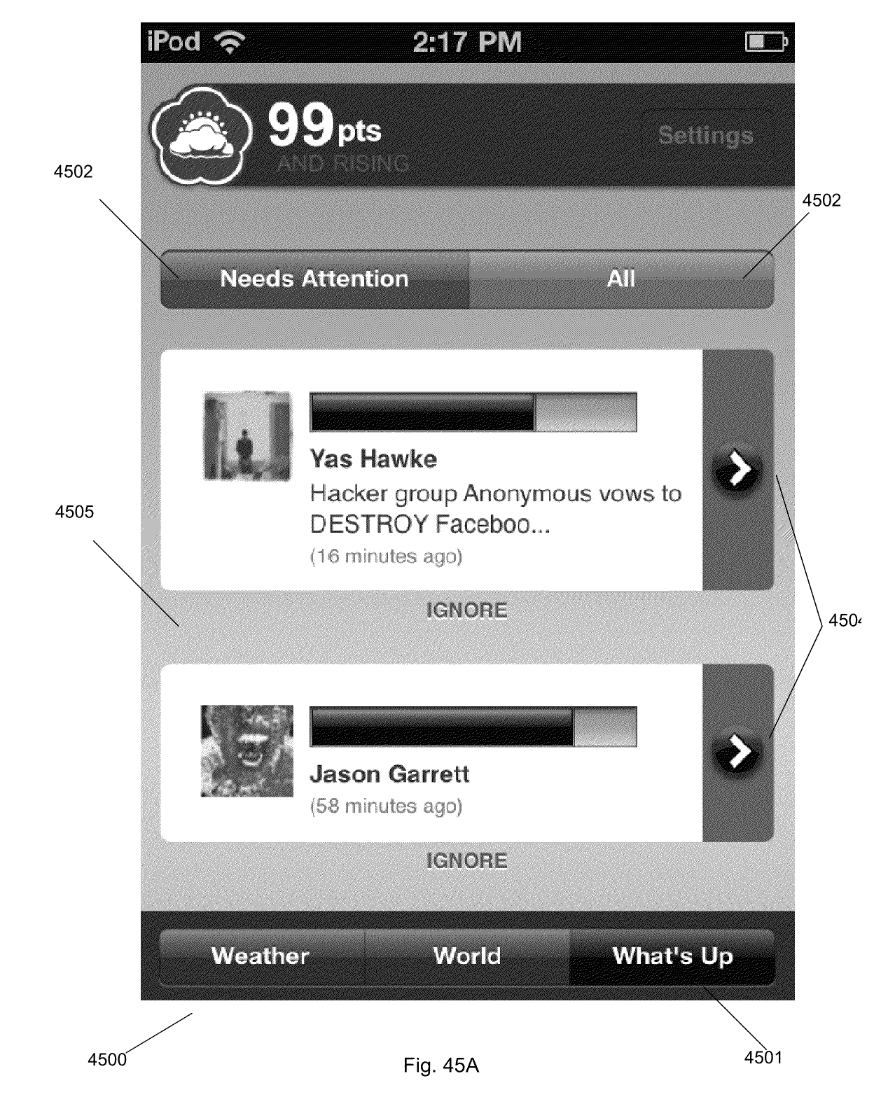

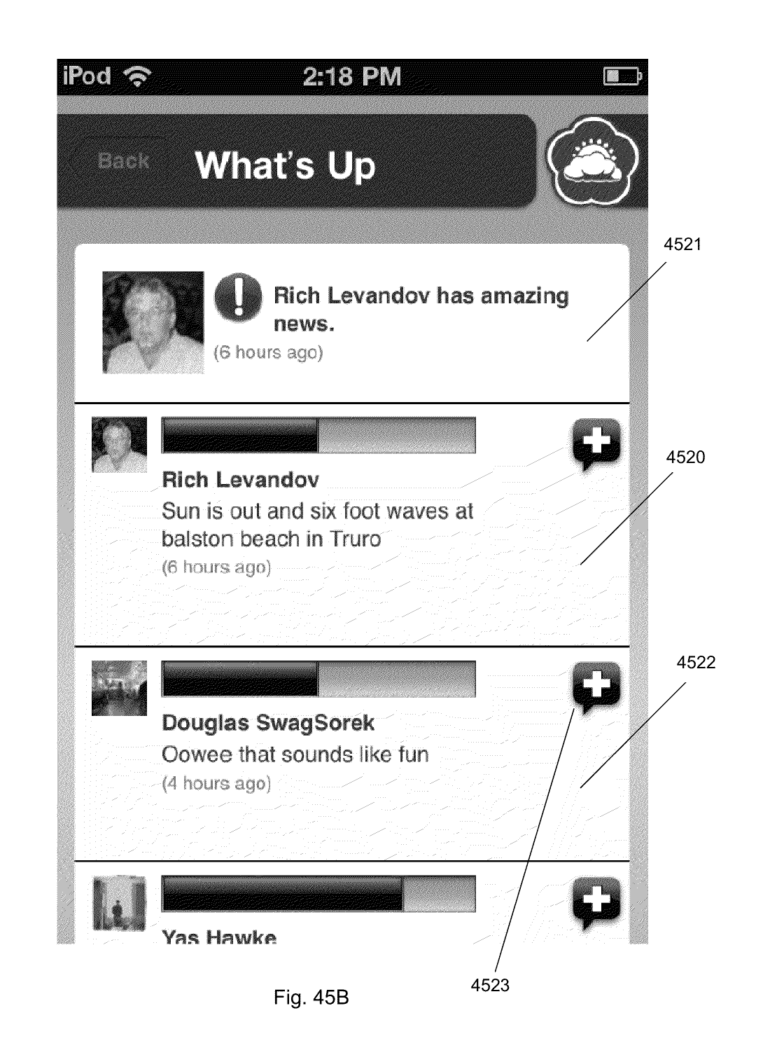

Activating the “World” tab 4401 navigates the user to the page 4400 illustrated in FIG. 44A. From this page 4400, the user can learn more about his or her Chi-munity (for example, what member of the Chi-munity is having the most affect on the user's Chi), and edit the user's My 7 using the “Edit My 7” field 4402. The user may also navigate to the pages of the members of the user's Chi-munity by activating (e.g., touching or clicking-on) a graphic representing that member, such as graphic 4403 (for Yas Hawke) or graphic 4404 (for John James) for example. In addition, a “Search” box 4405 that allows the user to search among the user's members (peeps) and Loops.

To edit the user's “My 7,” entering the “Edit My 7” field 4402 navigates the user to a screen 4420 as illustrated by FIG. 44B. On that screen 4420, the user can delete a member from the user's “My 7” (e.g., by activating the minus (“−”) sign 4421), or re-arrange (e.g., re-prioritize) the members of the user's “My 7” (for example, by dragging and dropping the graphic for a member (e.g., graphic 4422 representing “Avicii”) to another position within the “My 7”). Alternately, the user could also add a new member of to the user's “My 7.”

FIG. 4C illustrates the bottom portion of the World screen 4400 in FIG. 44A, and includes information about, and graphical fields to represent, the user's “peeps” and “Loops.” A “Loop” is a group of members to which a user “listens” (or is tapped into), and a Loop may also contain other Loops. The user may create a new Loop by activating the icon “Create New Loop” 4450, and then (when prompted or presented with a menu) identifying which other members or other Loops are in the new Loop.

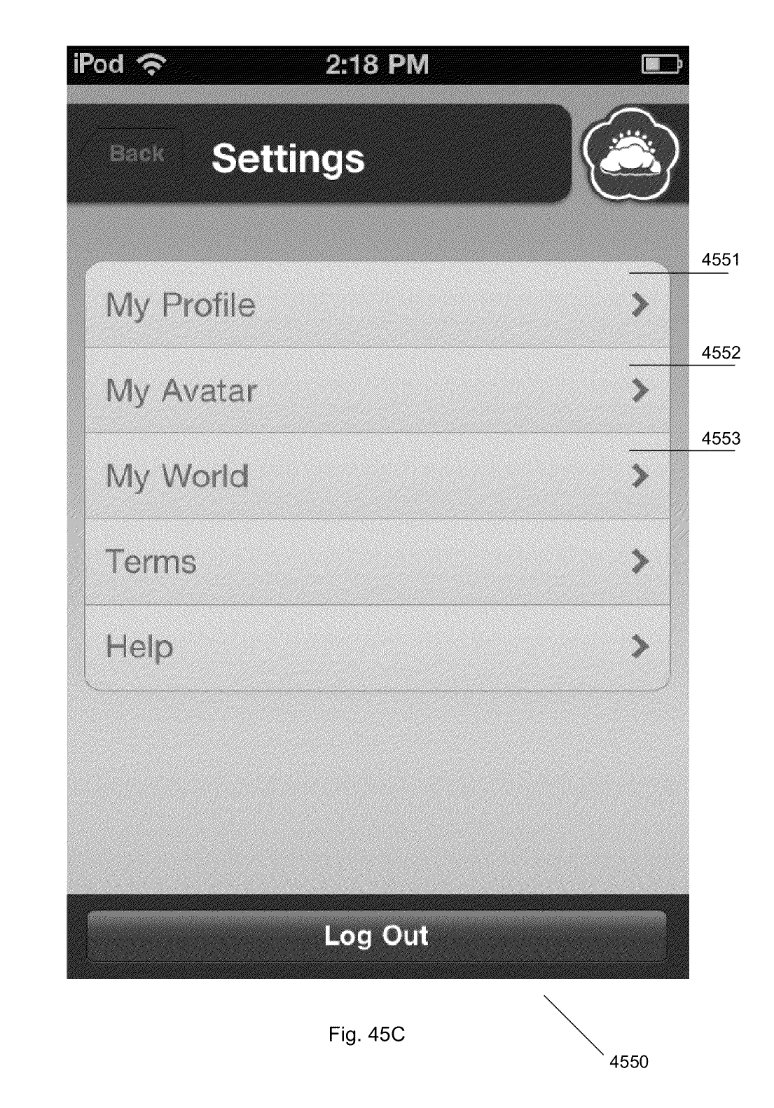

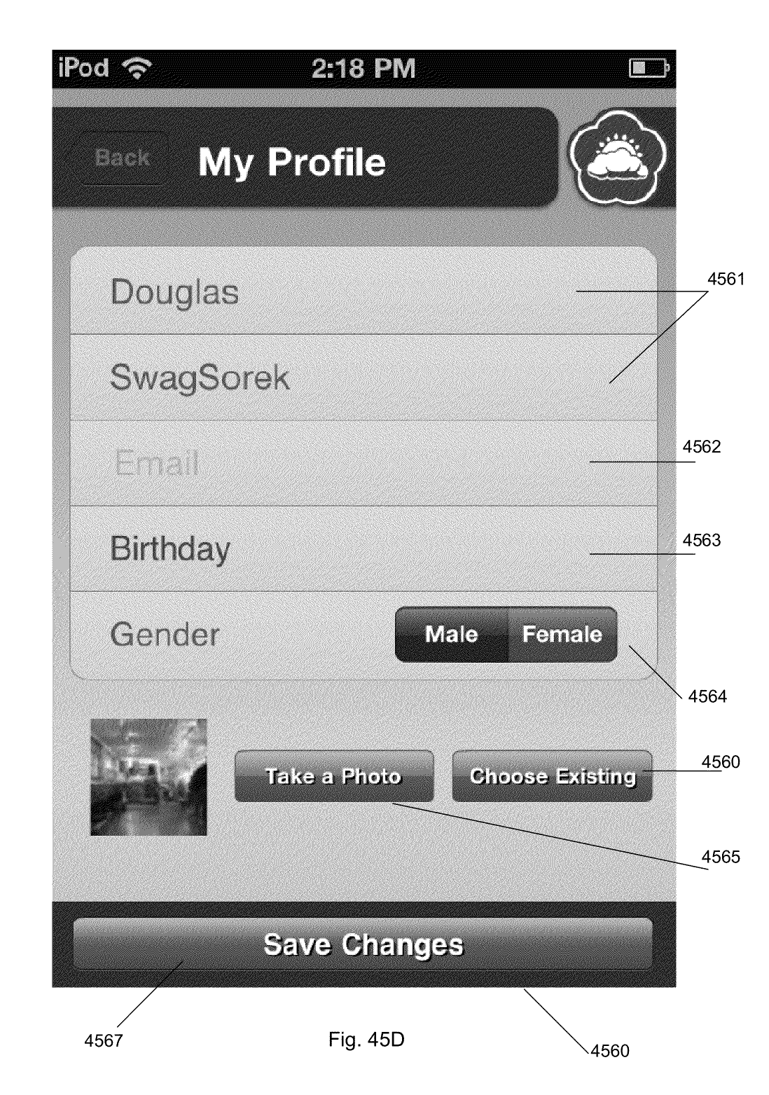

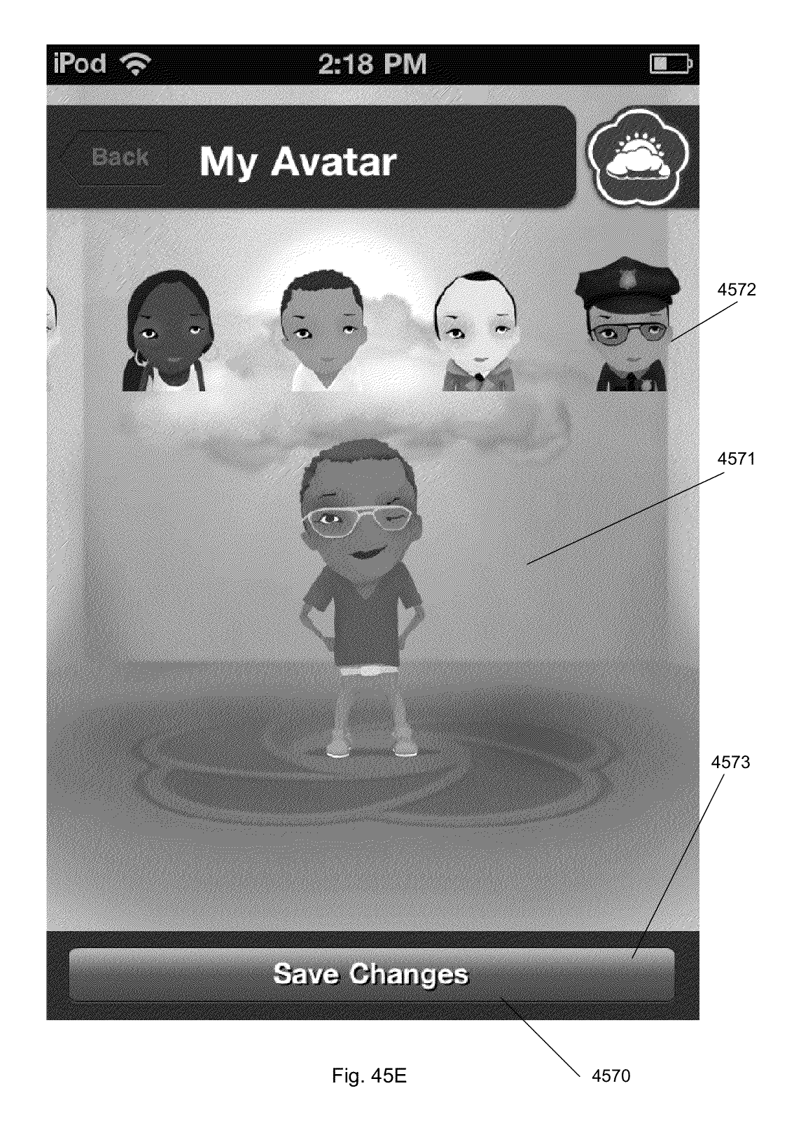

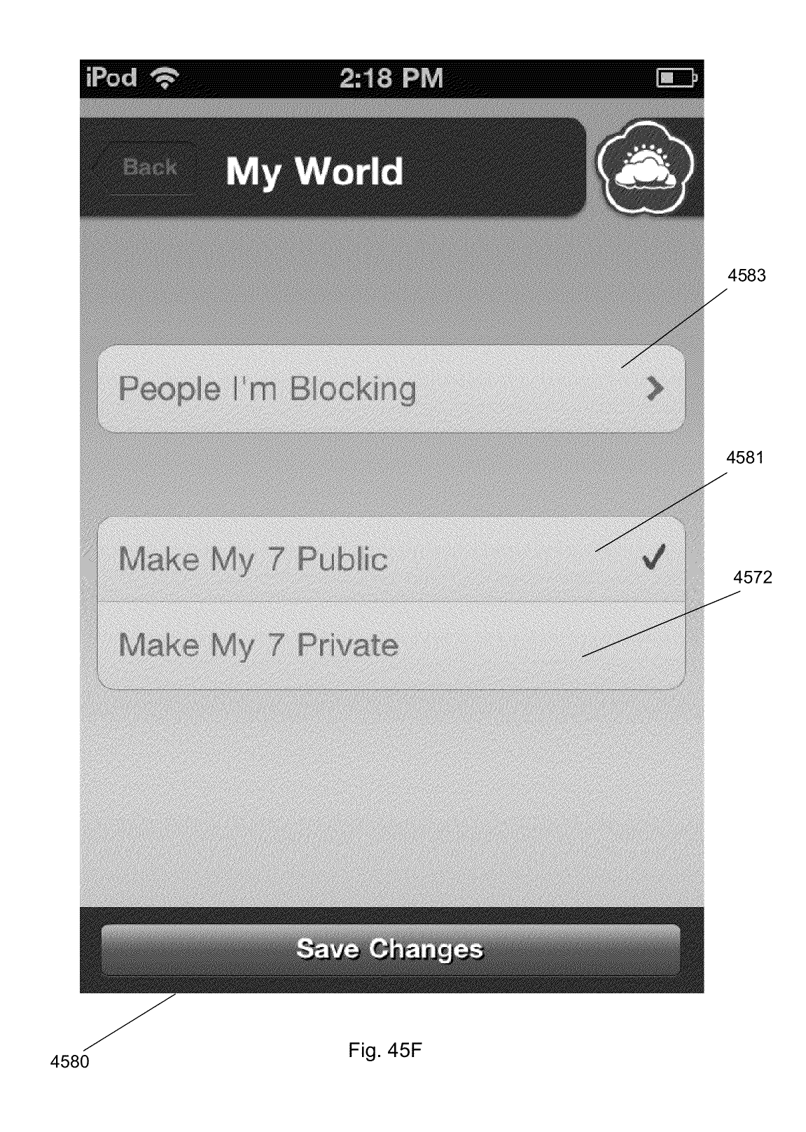

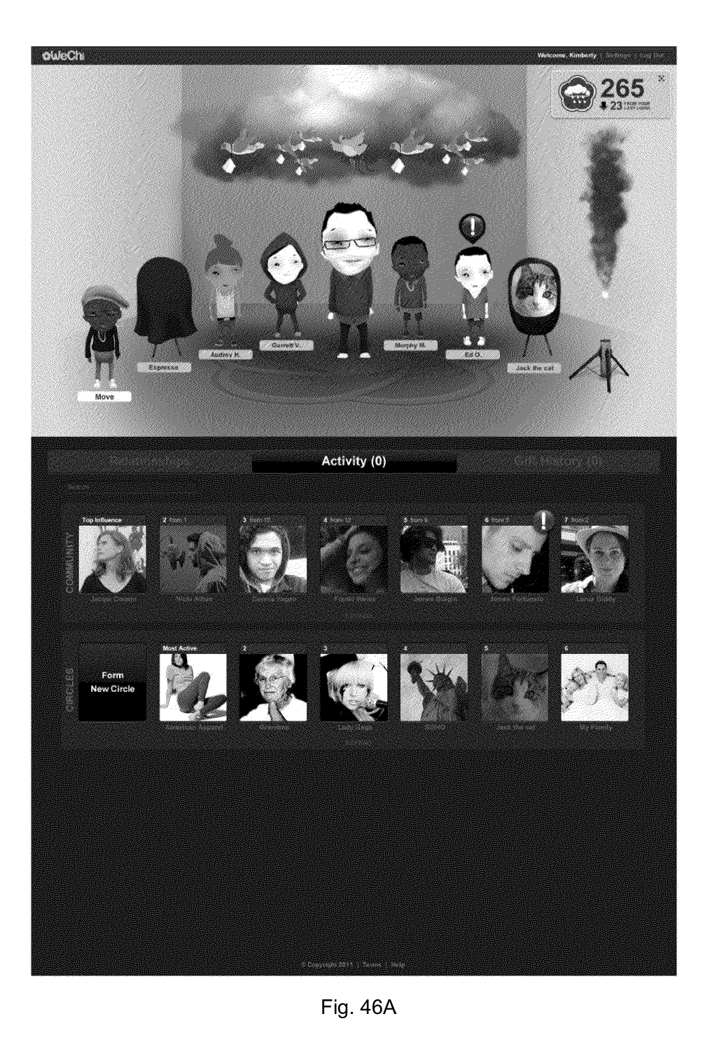

The “What's Up” tab 4501 navigates the user to a page 4500 as illustrated in FIG. 45A. This page 4500 provides graphical fields representing the activities of members of the user's Chi-munity. Graphical fields 4502 and 4503 near the top of the page allow the user to show such graphical fields for “All” peeps (i.e., members of the user's Chi-munity) (field 4502), or only for those members (“Needs Attention”—field 4503) whose activities suggest that the user should respond, or otherwise pay some attention, to those users (e.g., in this case, that activities of members Yas Hawke and Jason Garrett draw the user's attention). The “Needs Attention” tab shows updates from user's 7, threads user's been involved in, and invitations user has received. A right arrow (“>”) on a member graphic, such as arrow 4504, allows the user to drill down to see the activities of the member represented by that member graphic, while the “ignore” 4505 icon associated with a member graphic removes that graphic from the screen.

A lower portion of the screen 4500 illustrated in FIG. 45A is illustrated in FIG. 45B, and includes graphic panels 4520 for postings from other members of the user's Chi-munity. For example, member Rich Levandov posted an alert 4521 (with the quality of “Amazing News”) to report about six-foot waves at Balston beach in Truro 4520. In turn, member Douglas SwagSorek responded 4522 (“Ooowee that sounds like fun”). The user, or any other viewer of this page 4500, can add his or her own comment to a thread by activating the “+” icon 4523 associated with teach graphic panel (e.g., 4520 and 4522).

The screen 4550 illustrated in FIG. 45C allows the user to manage his or her “Settings.” For example, by selecting the “My Profile” graphic 4551, the user will navigate to the screen 4560 illustrated in FIG. 45D. From that screen 4560, the user can, for example, specify segments of his name 4561 (e.g., “Douglas” and “SwagSorek”), specify an email address 4562, or his birthday 4563 or gender 4564. The user can also specify profile photo or other image 4566, or even take a photo 4565 on the spot if his platform (e.g., iPhone or laptop computer, for example) has a camera. Any such changes can be saved by activating the “Save Changes” icon 4567.

Similarly, by selecting the “My Avatar” graphic 4552 in FIG. 45C, the user will navigate to the screen 4570 illustrated in FIG. 45E, from which the user can select an avatar 4571 from a library 4572 of existing avatars, or potentially even create his or her own avatar. Any such changes can be saved by activating the “Save Changes” icon 4573.

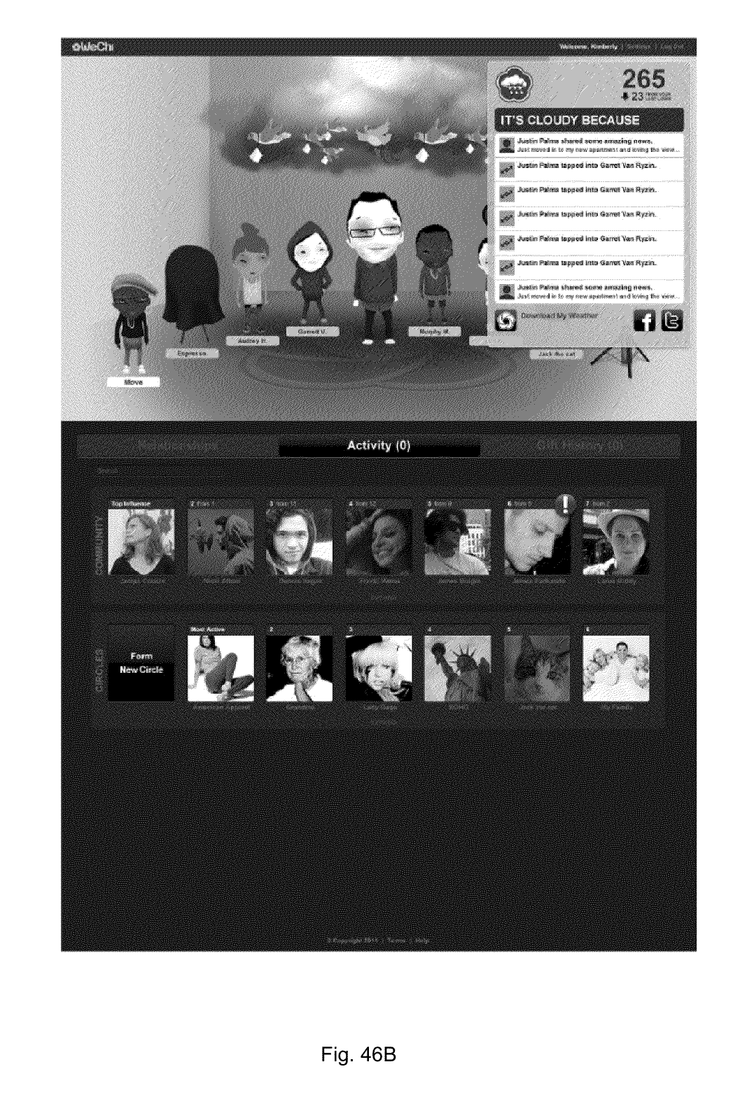

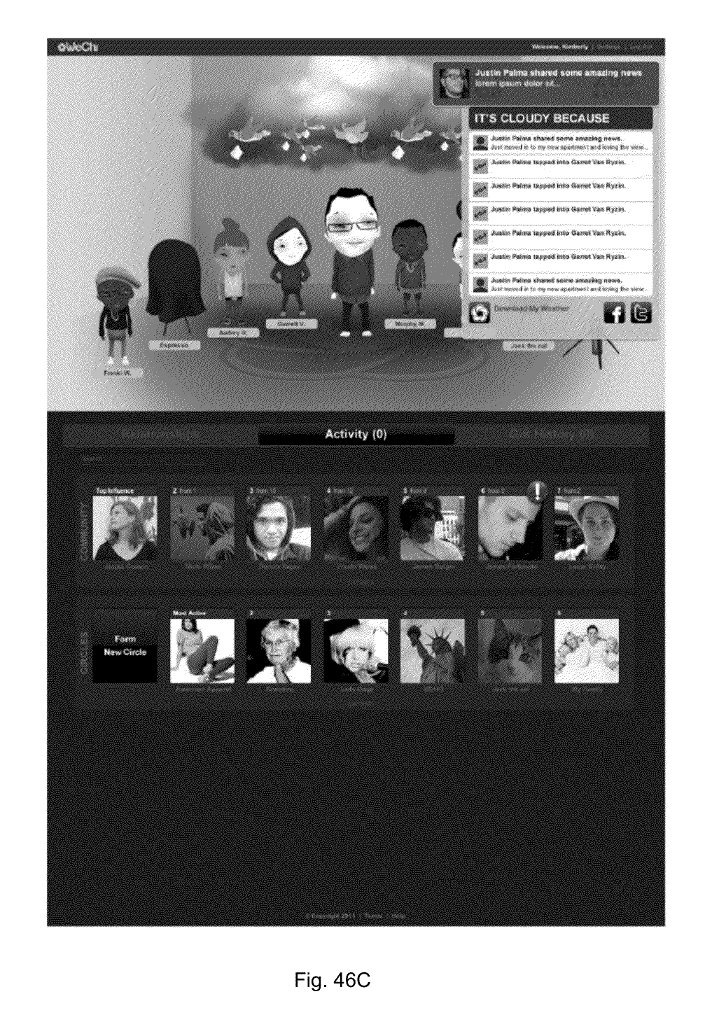

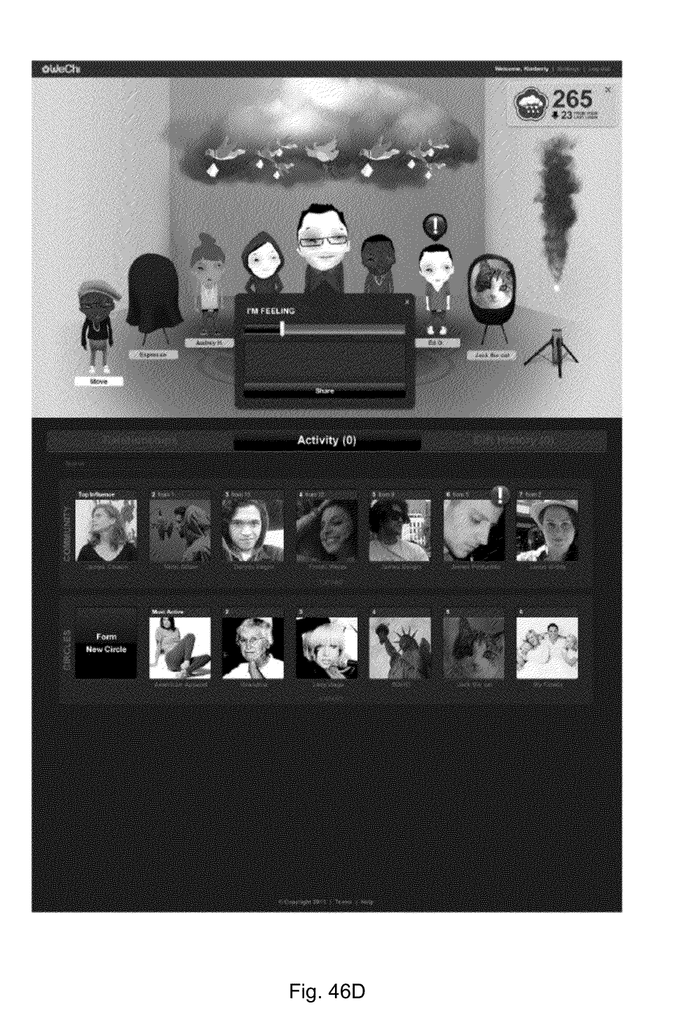

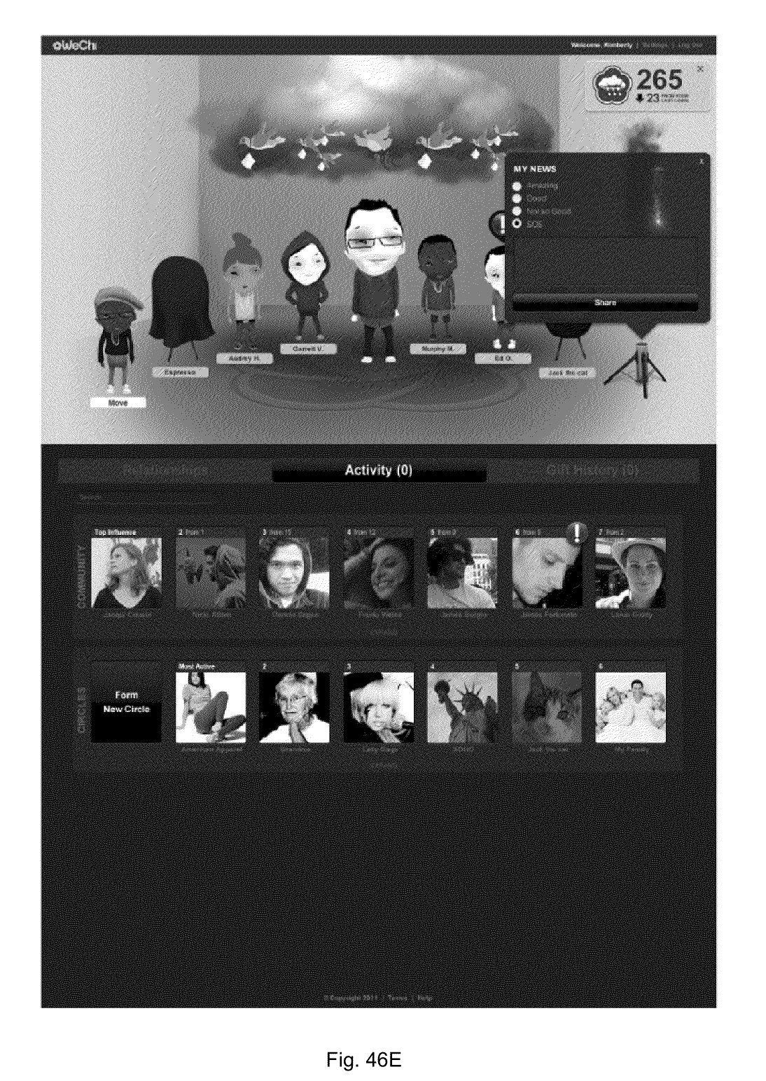

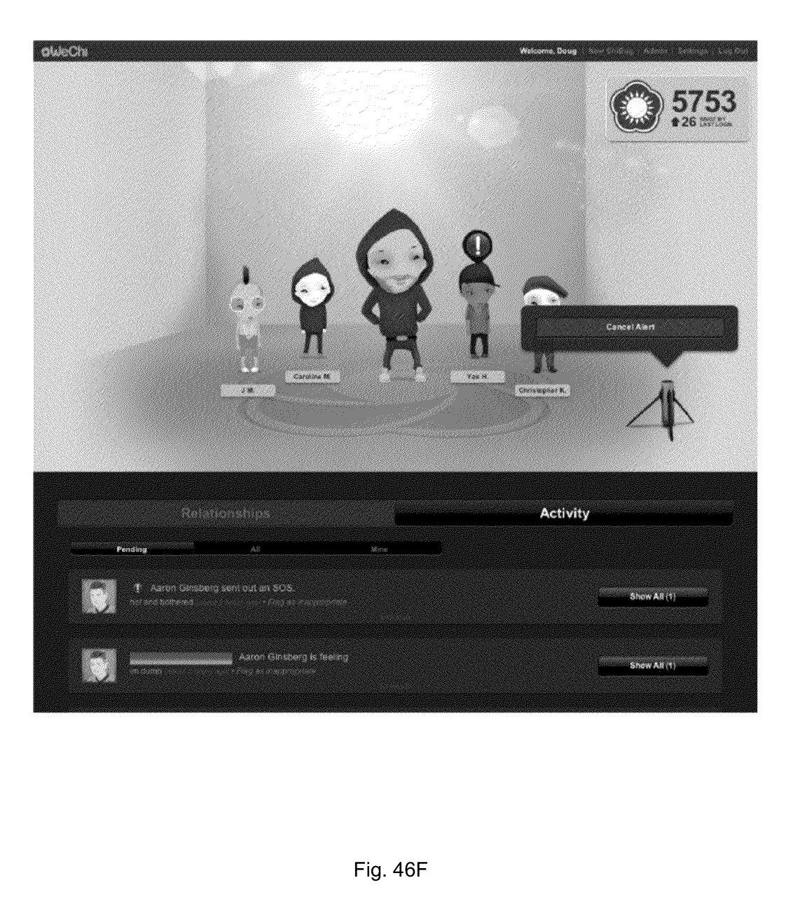

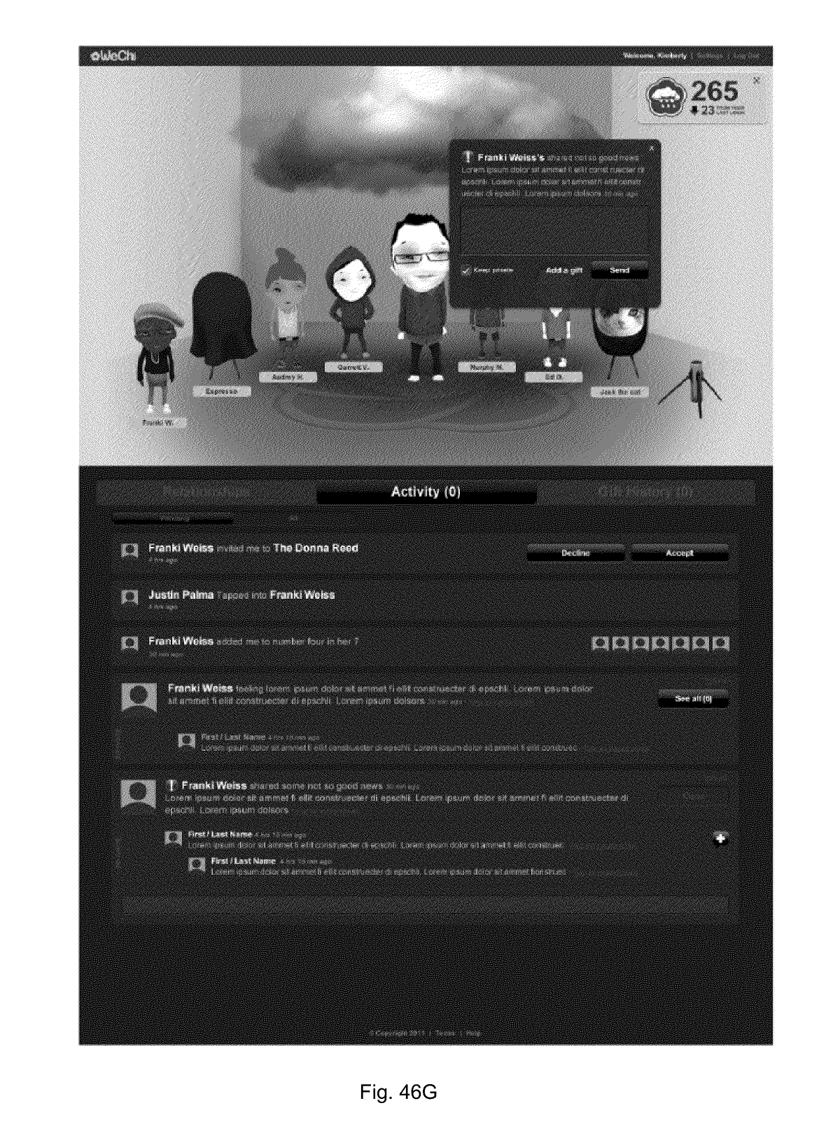

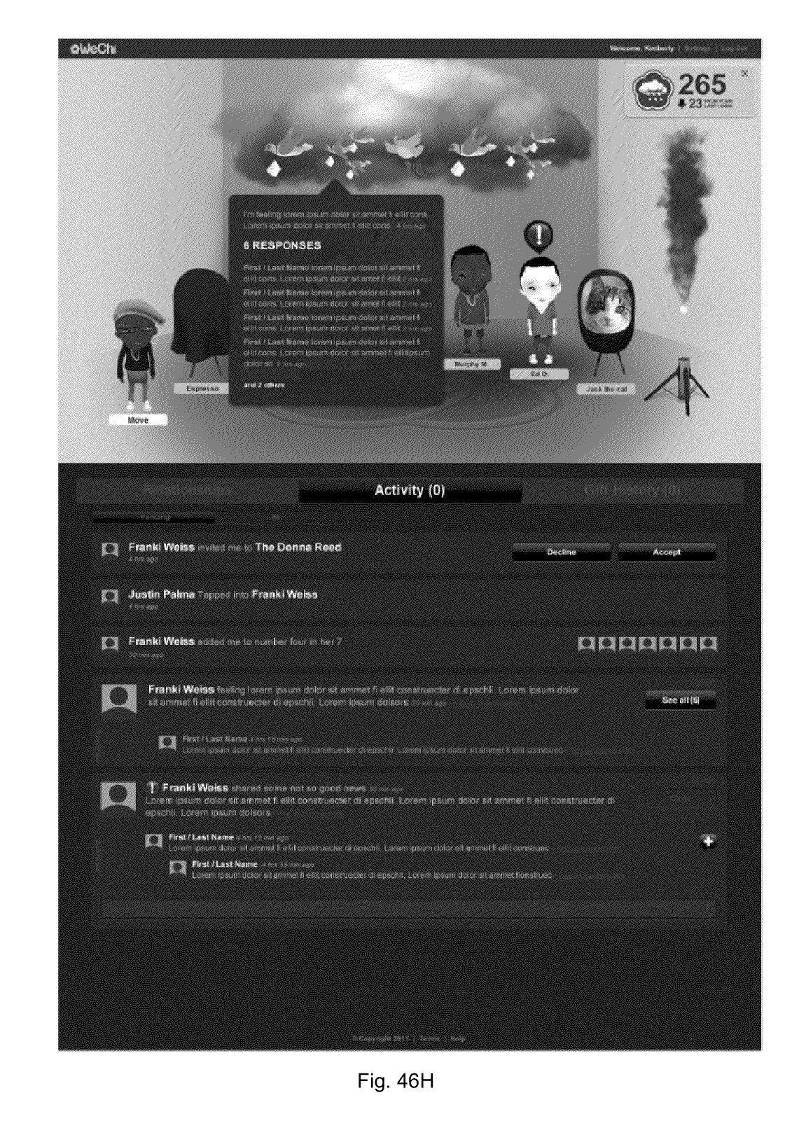

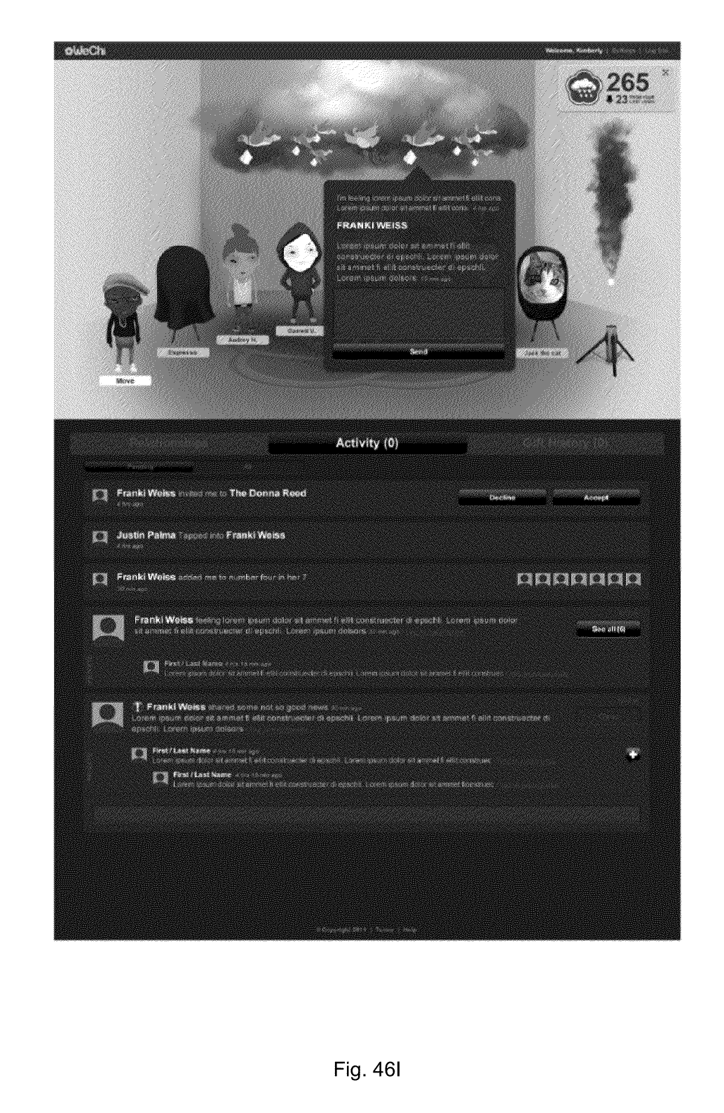

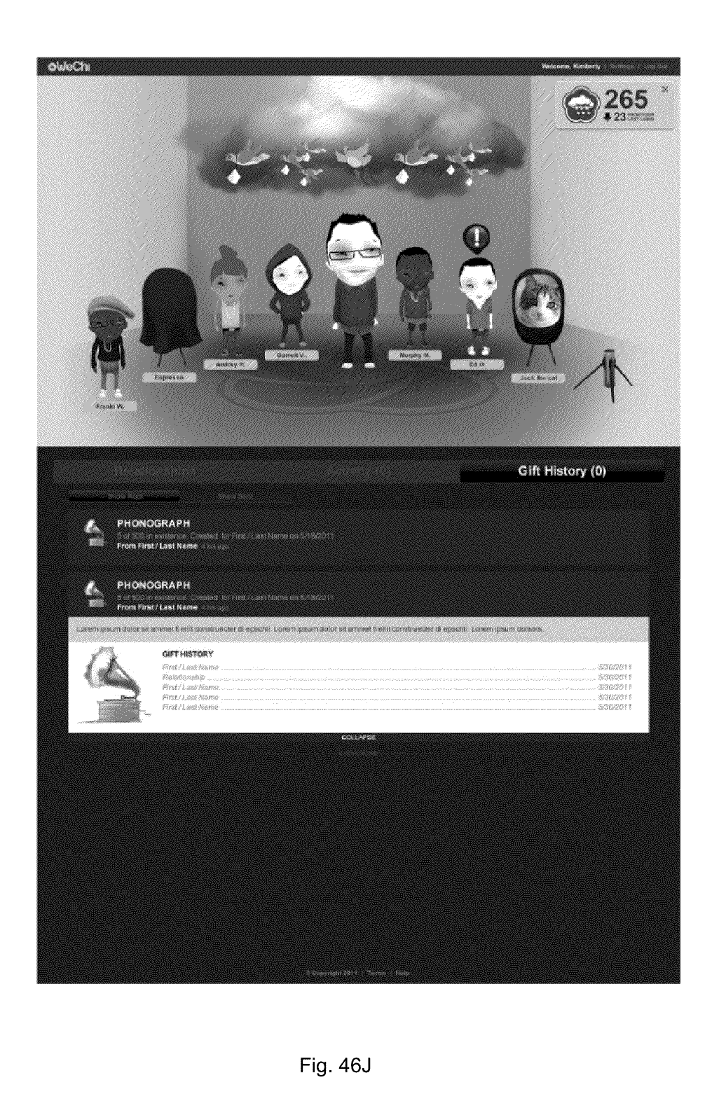

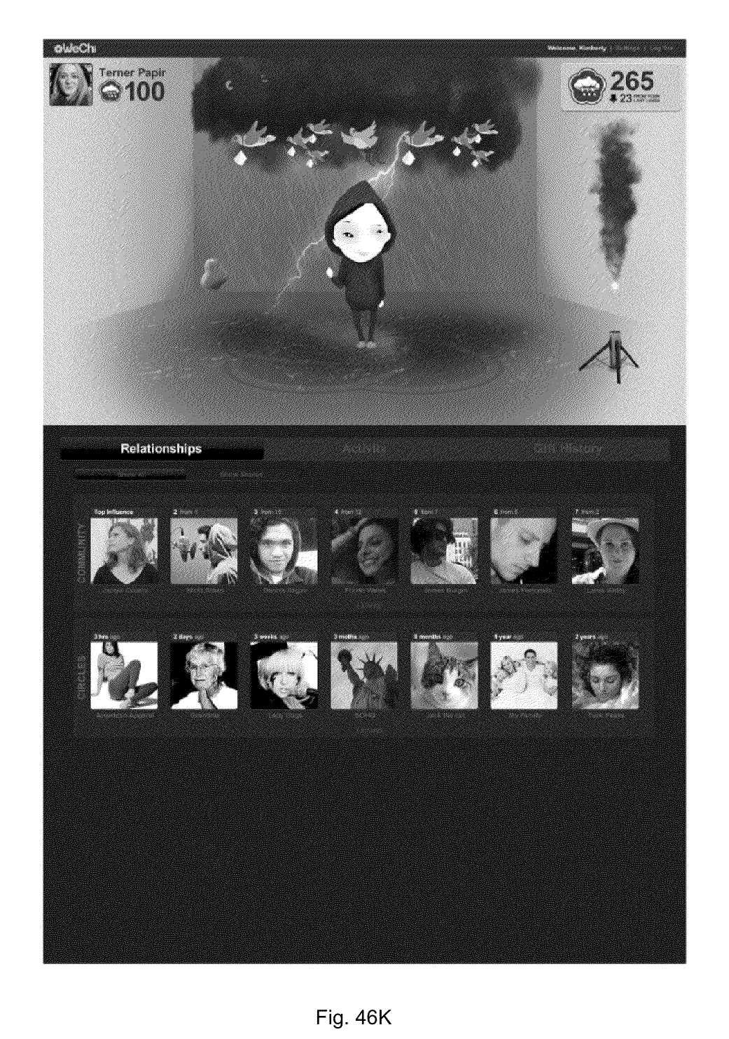

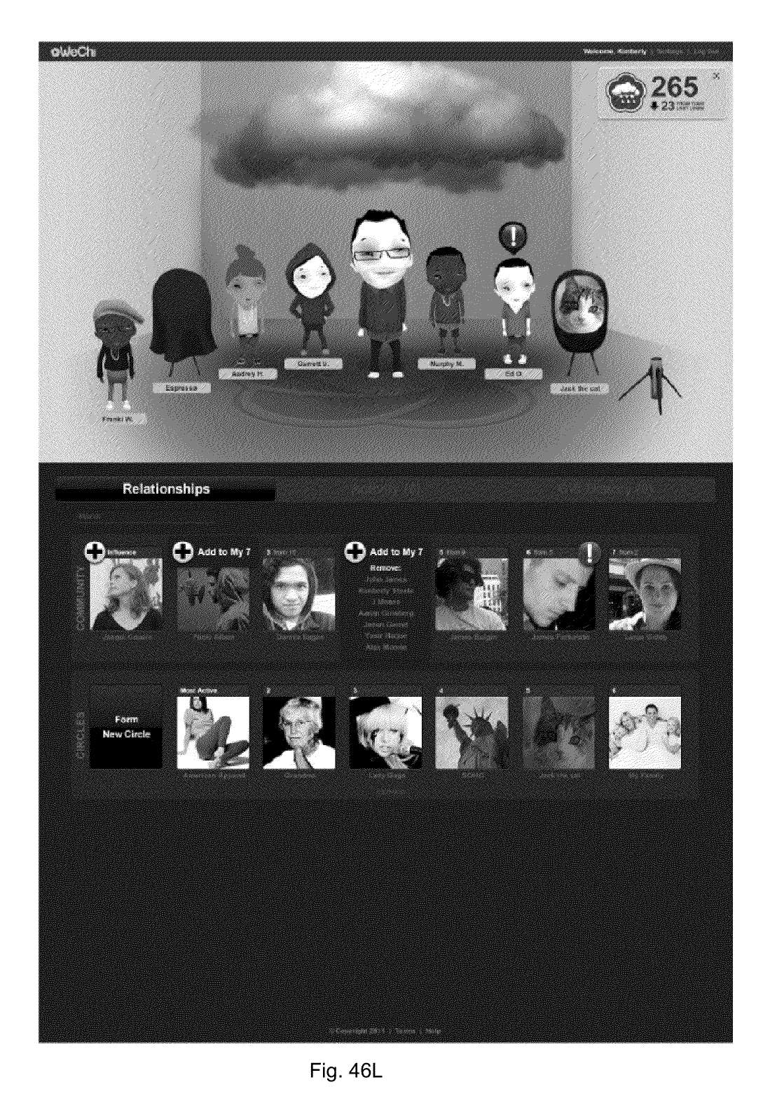

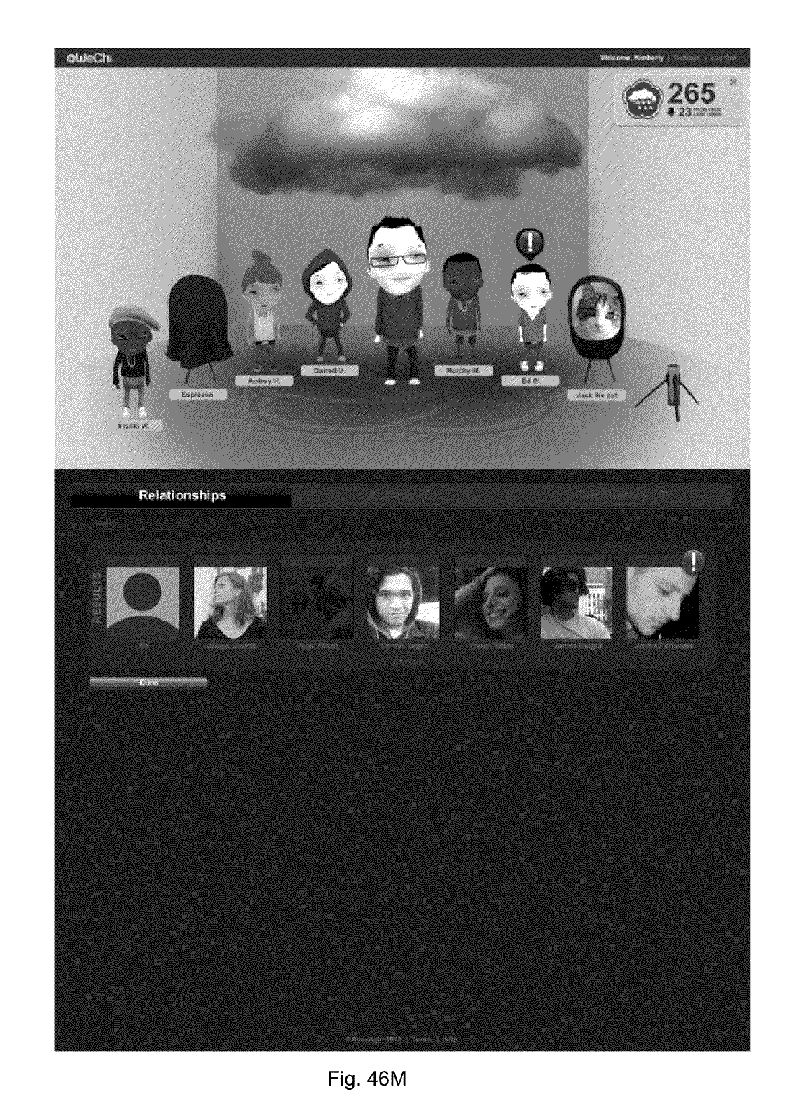

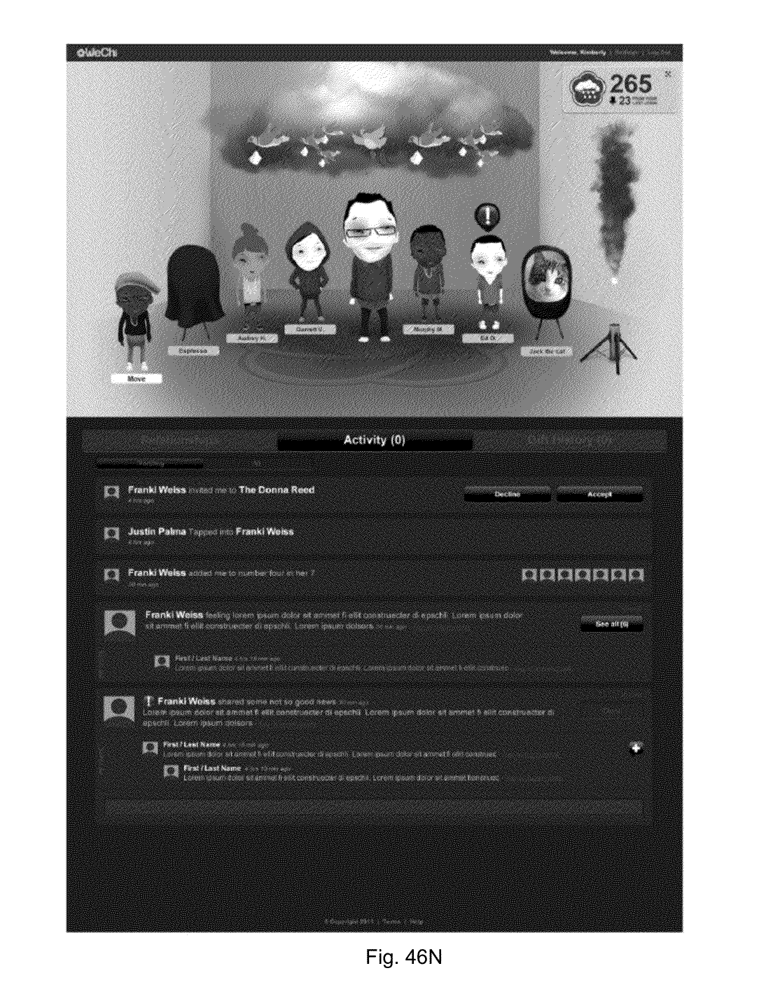

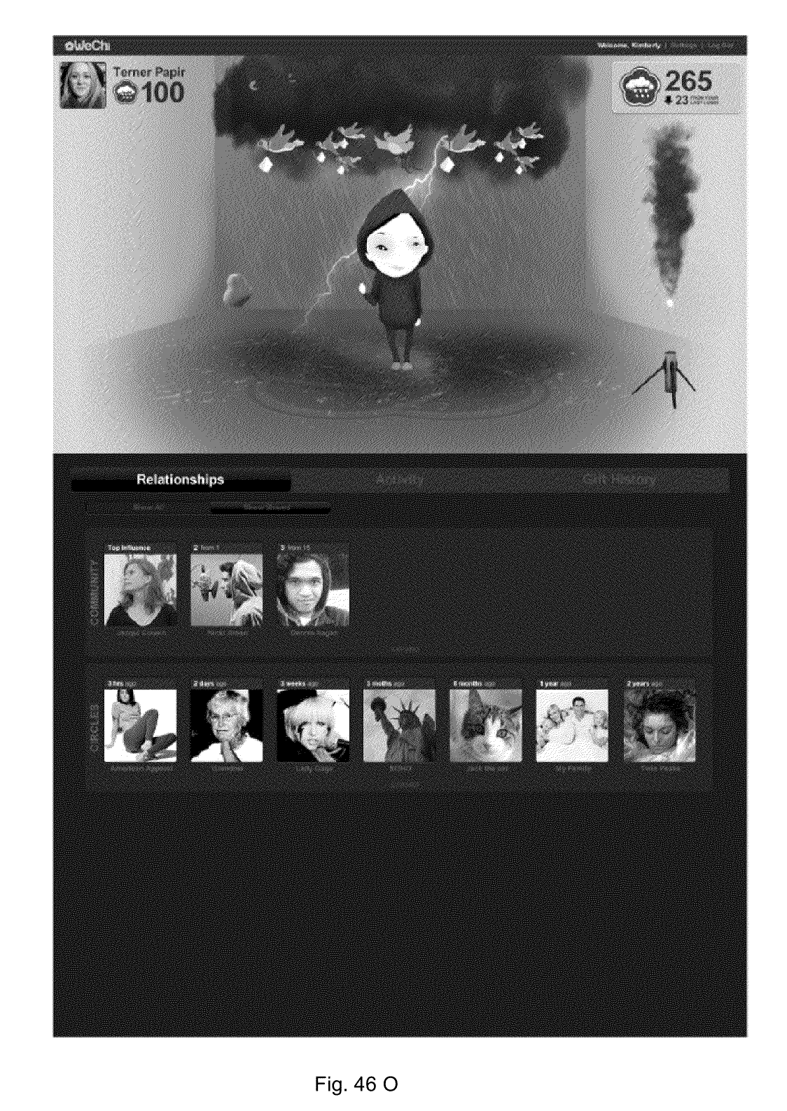

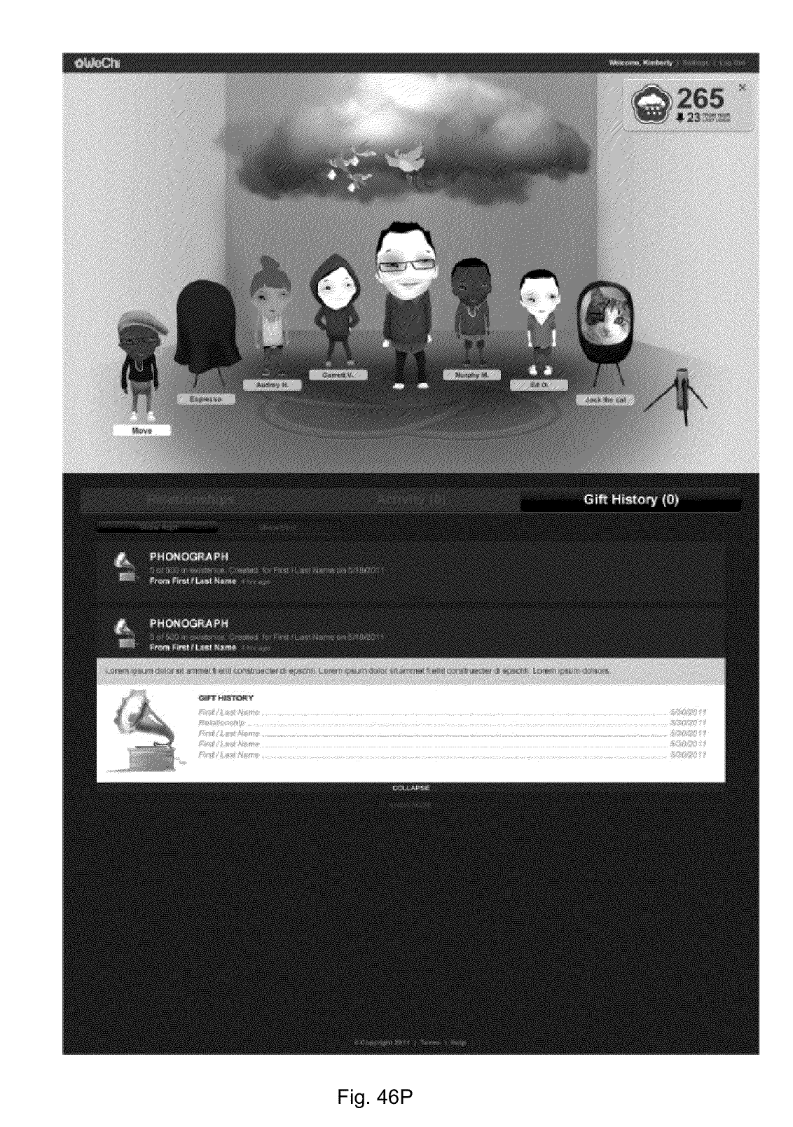

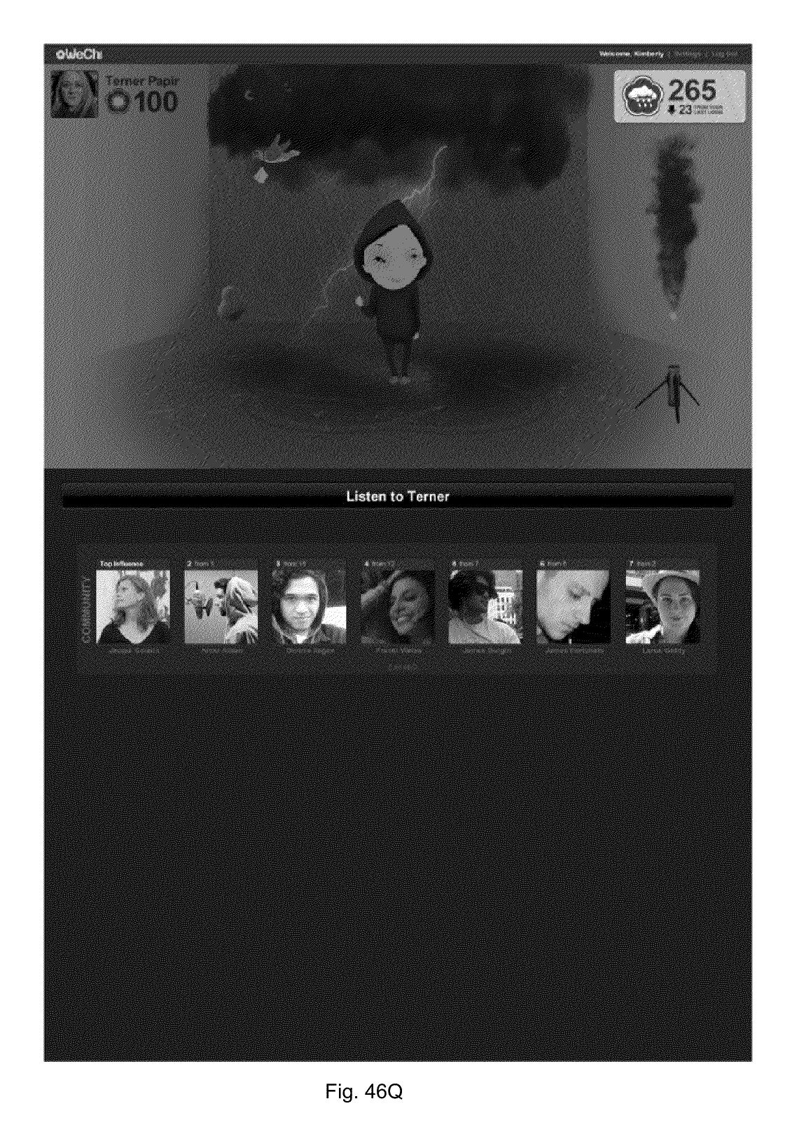

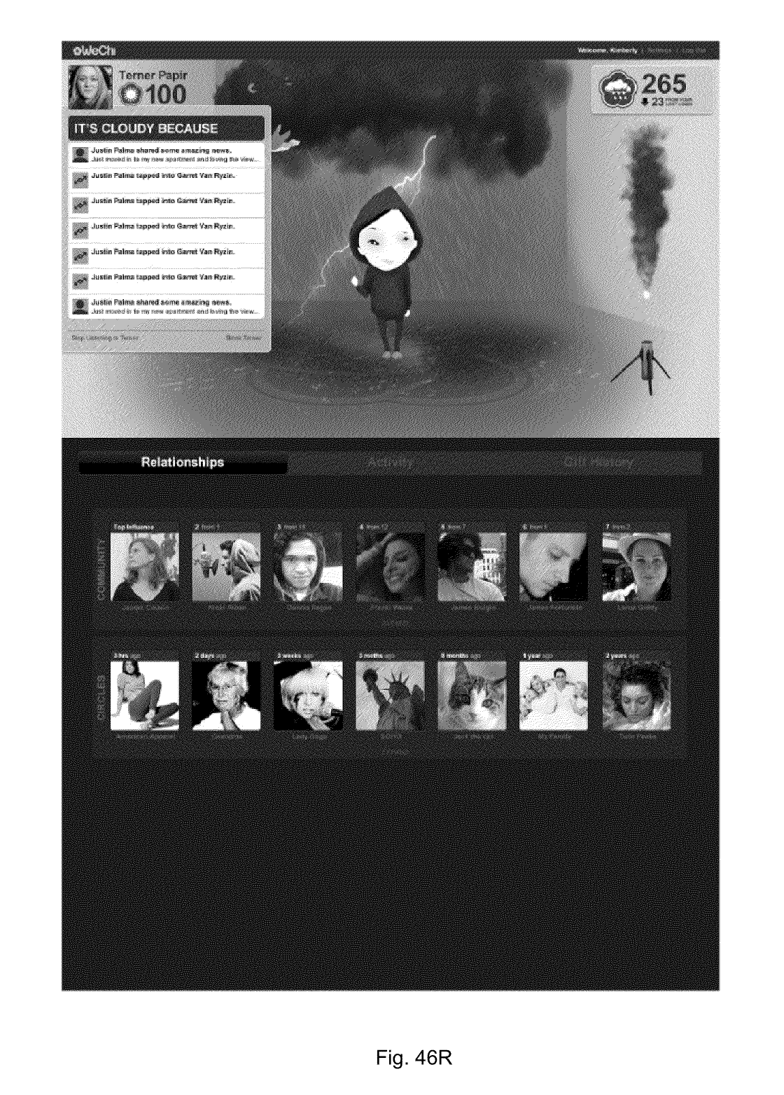

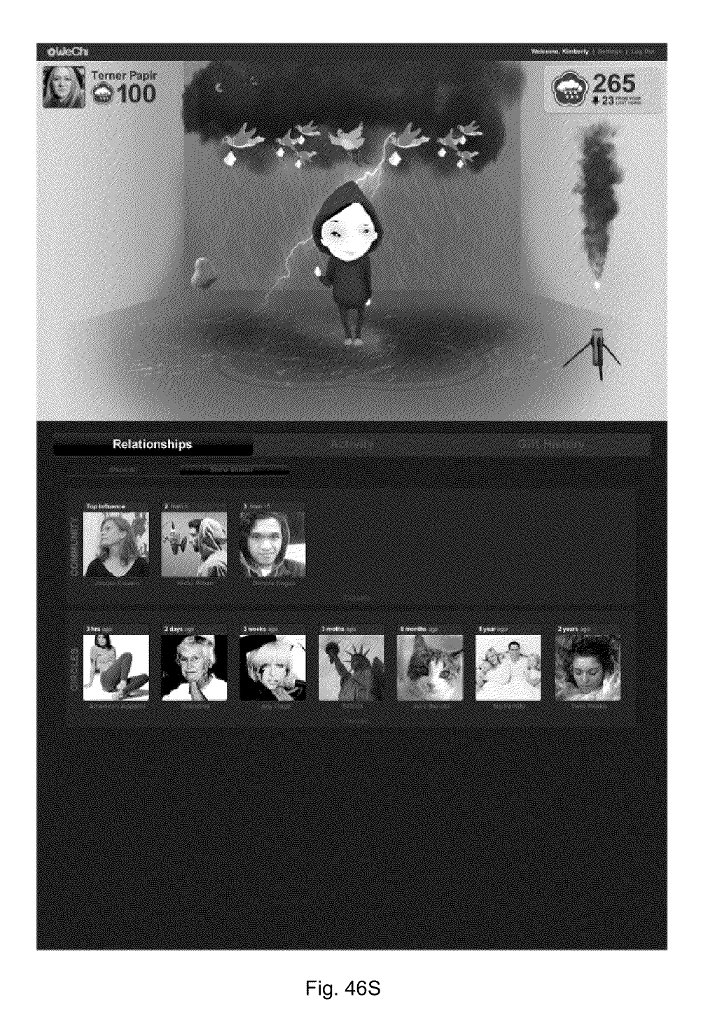

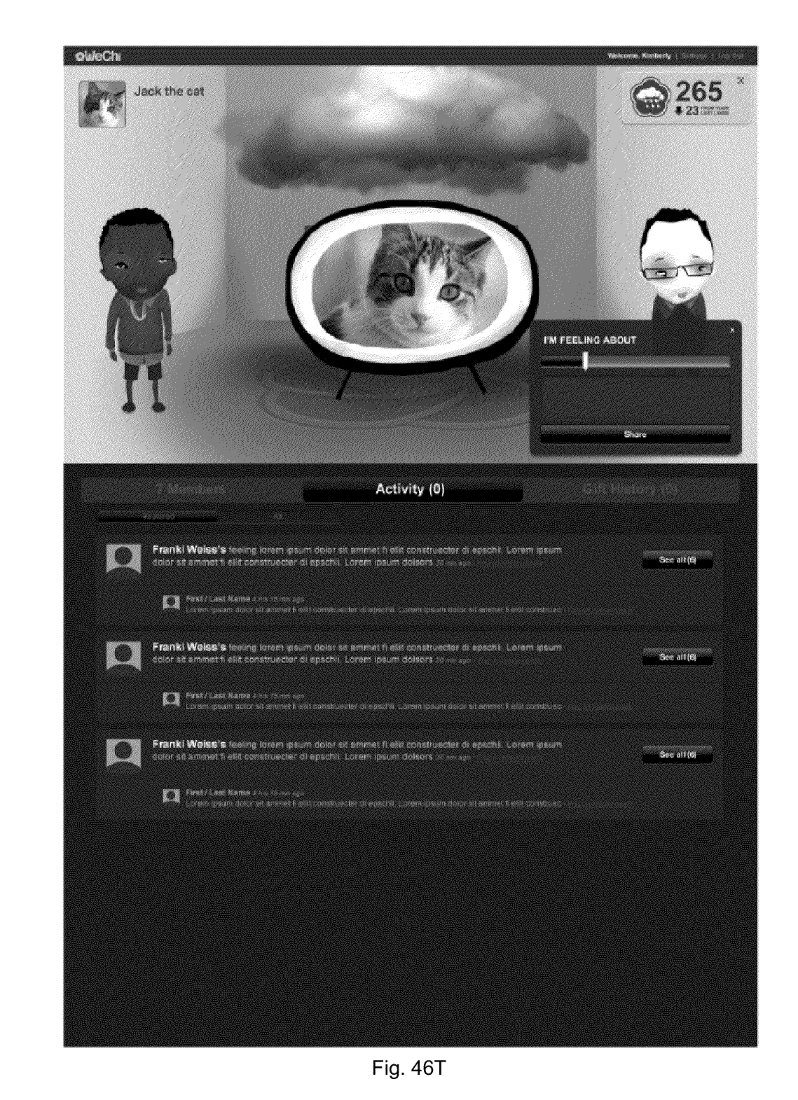

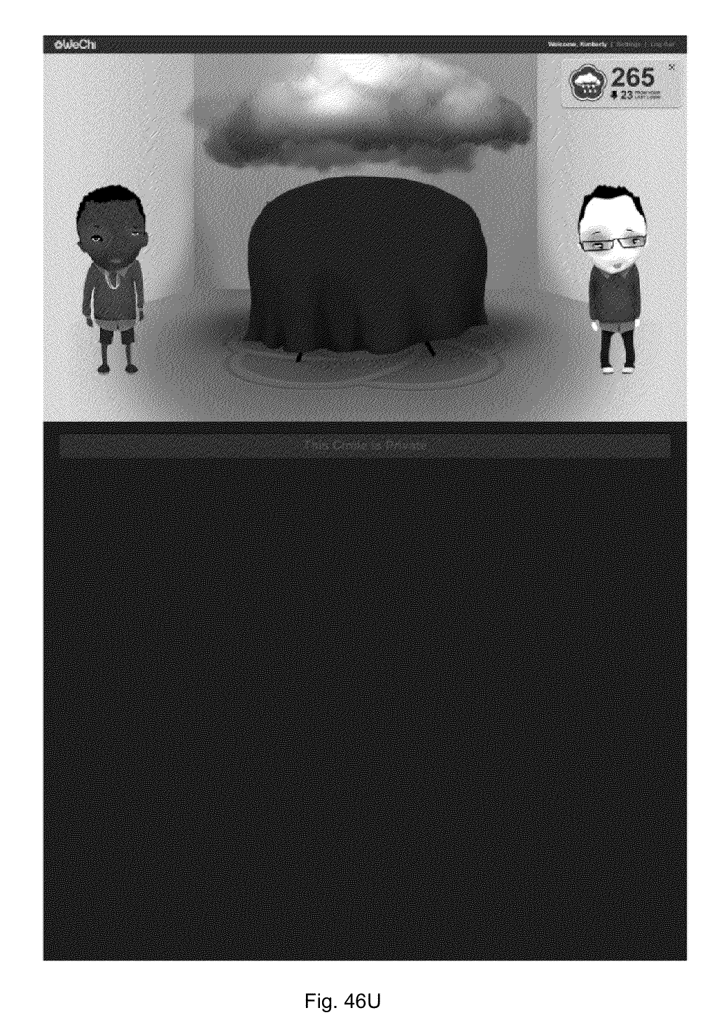

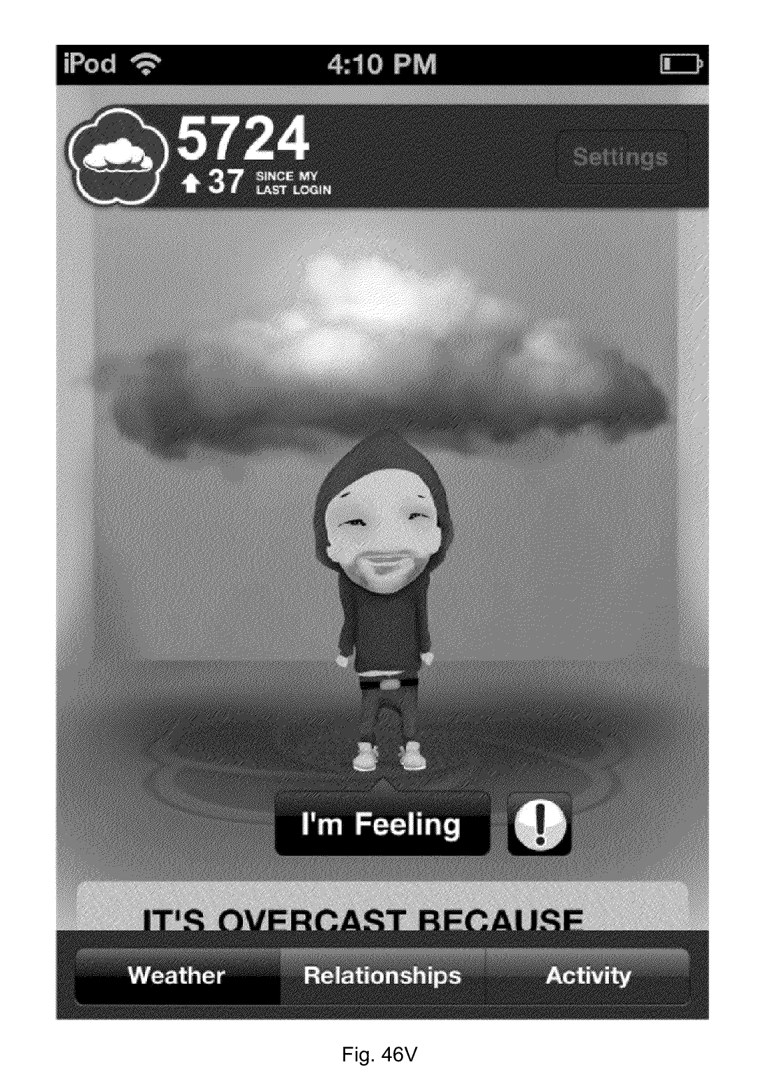

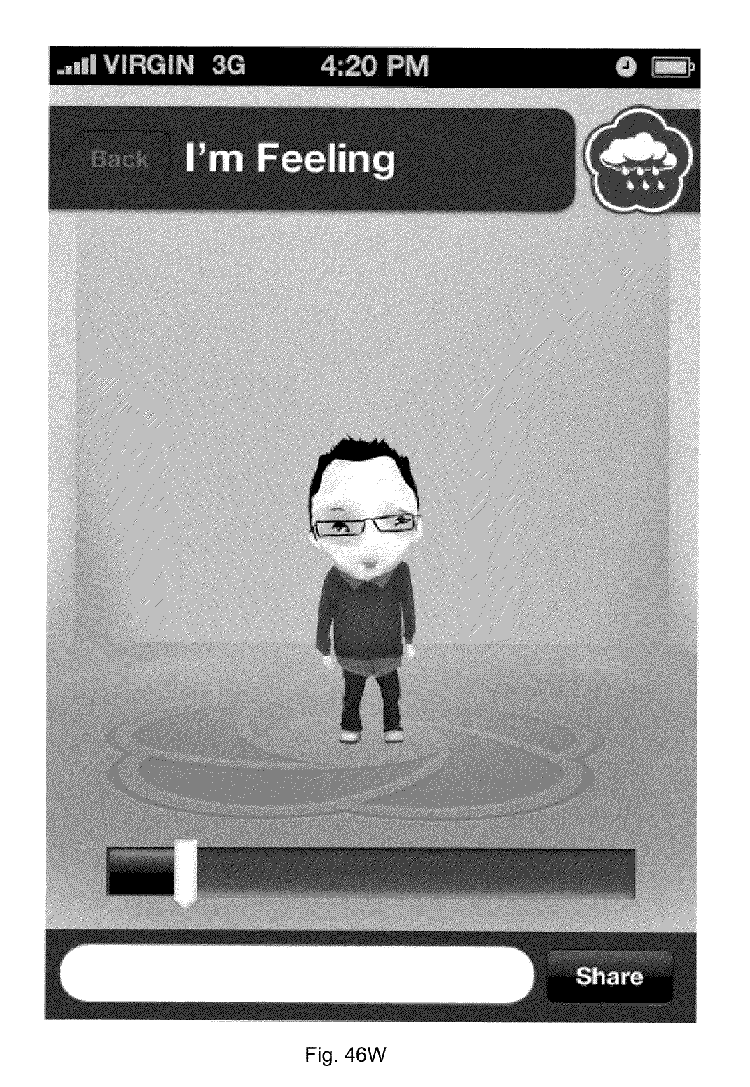

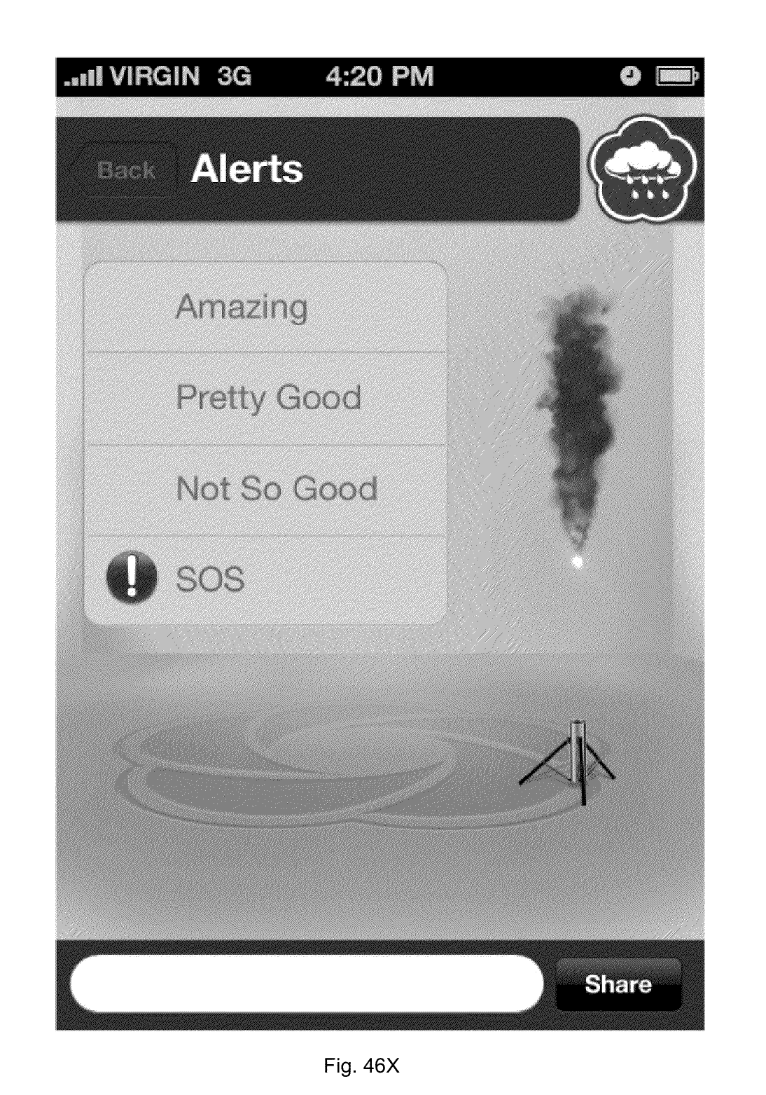

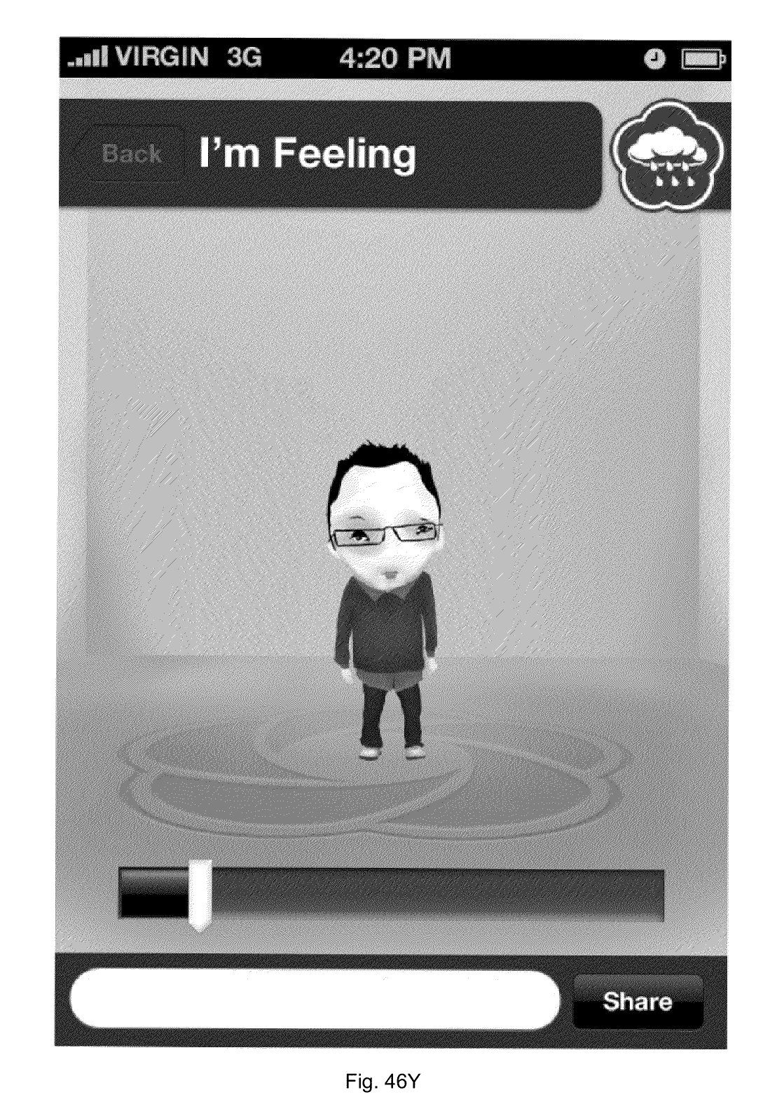

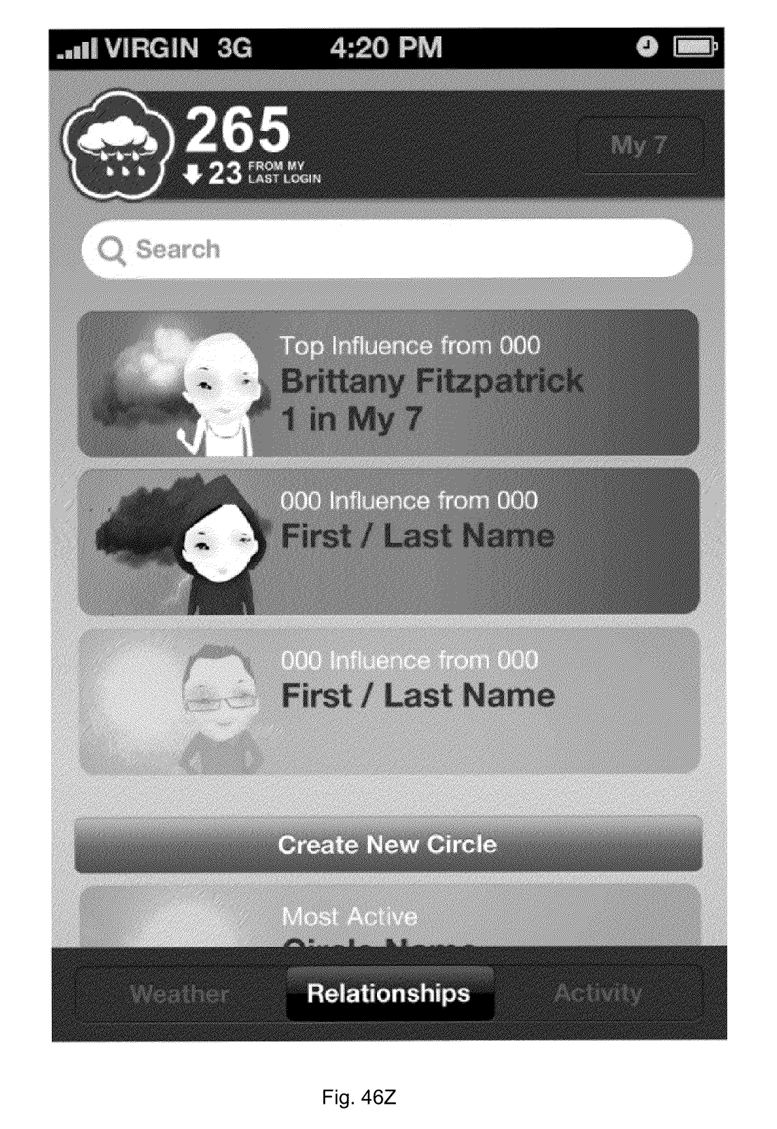

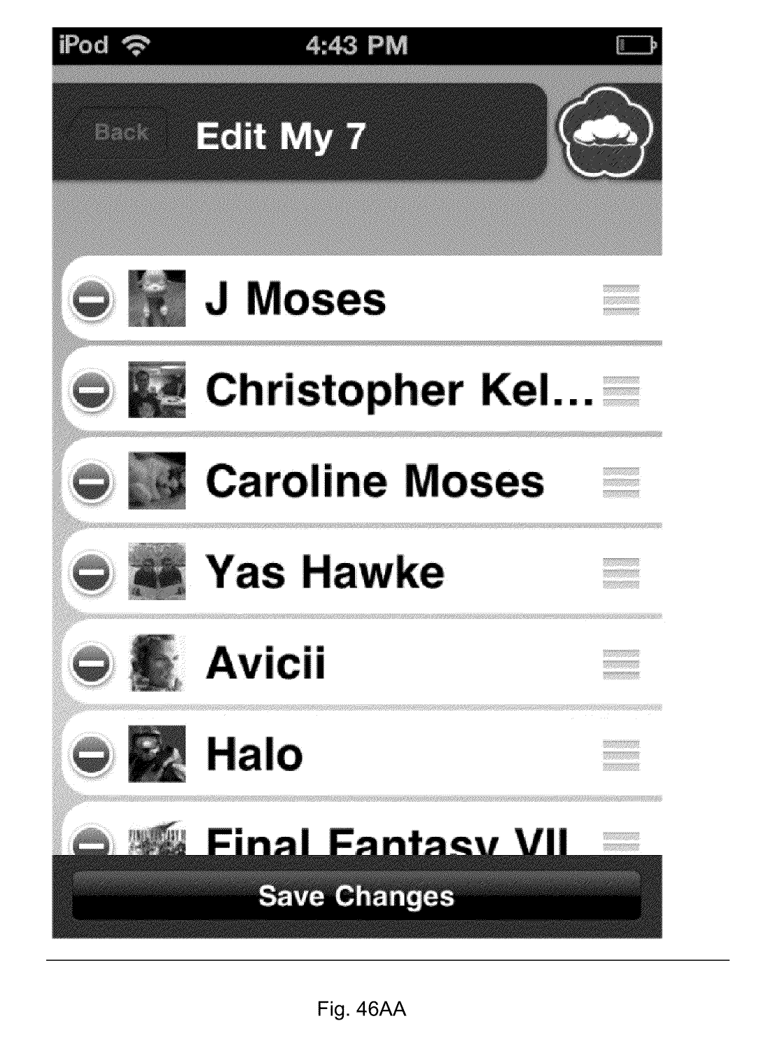

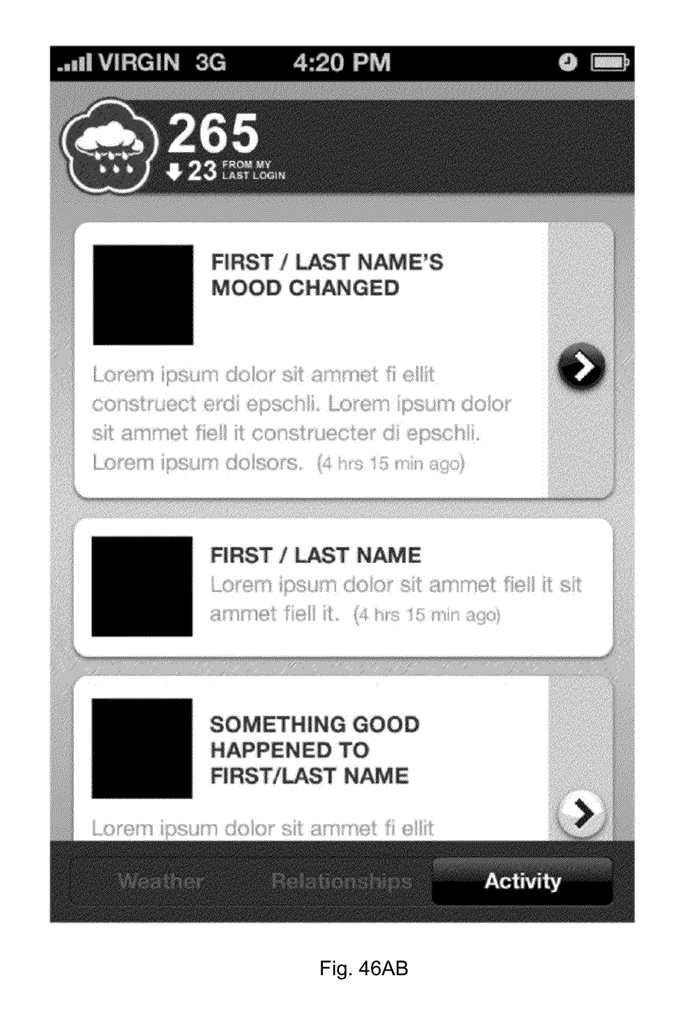

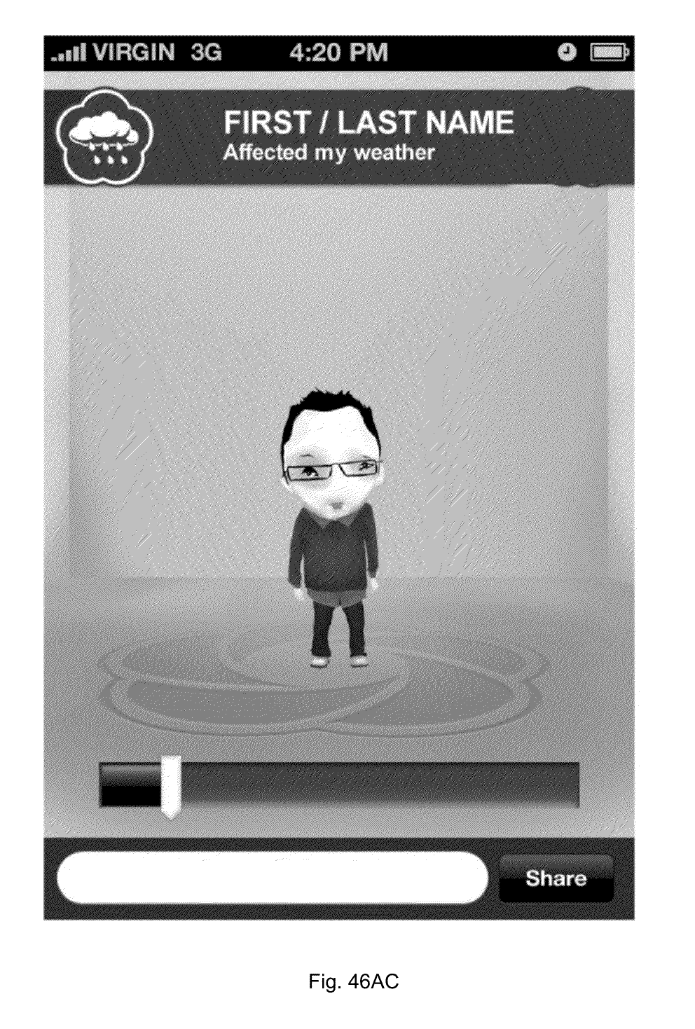

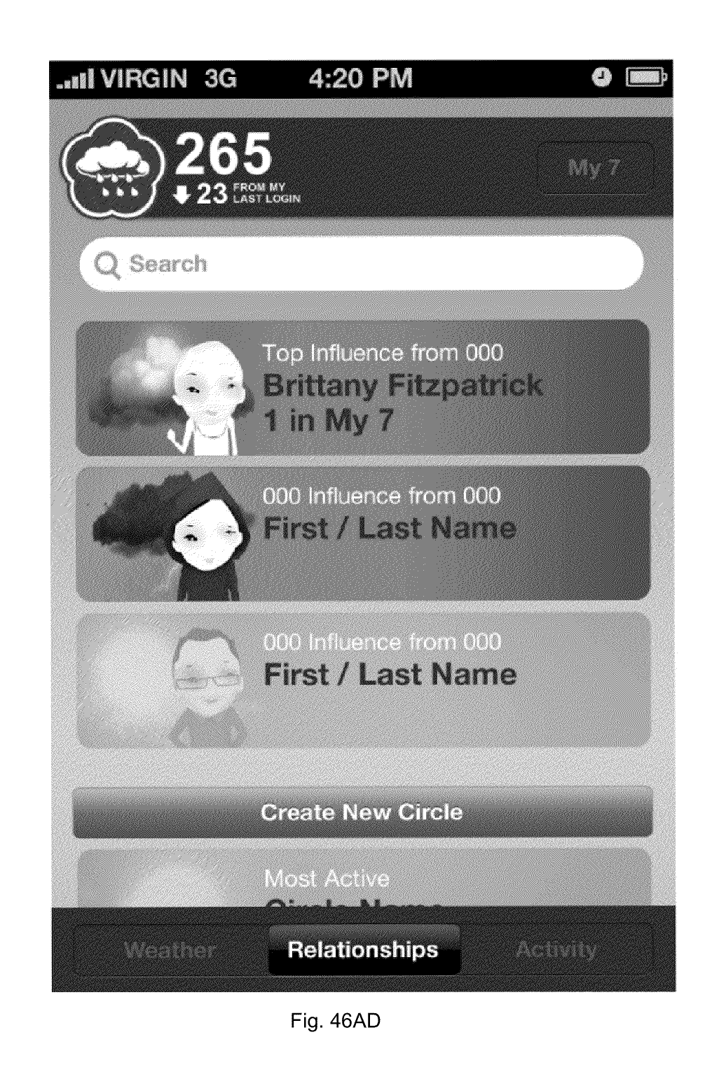

Similarly, by selecting the “My World” graphic 4553 in FIG. 45C, the user will navigate to the screen 4580 illustrated in FIG. 45F, from which the user can select whether to make public the identity of the member of the user's “My 7,” or whether to make the user's “My 7” private (4582) or public (4581). If the user elects to make his or her “My 7” private, any screen showing the user's “My 7” will have the identity of the members on that “My 7” list blocked (for example, by placing a graphic of a curtain over the avatars representing those members; see for example FIG. 46U). From this page, the user can also create, edit and maintain a list of members who the user wishes to block (4582). In some embodiments, a blocked member cannot access the user's pages, or influence the user's Chi.

Another embodiment is illustrated by FIGS. 46A-46AE. Some of these figures are, to some degree, analogous to earlier figures. For example:

FIG. 46A is somewhat analogous to FIG. 4;

FIG. 46B is somewhat analogous to FIG. 5;

FIG. 46C is somewhat analogous to FIG. 7;

FIG. 46E is somewhat analogous to FIG. 9;

FIG. 46F is somewhat analogous to FIG. 10;

FIGS. 46G-46I are somewhat analogous to FIG. 11;

FIG. 46J is somewhat analogous to FIG. 12;

FIG. 46K is somewhat analogous to FIG. 13;

FIG. 46L is somewhat analogous to FIG. 14;

FIG. 46L is somewhat analogous to FIG. 14;

FIG. 46N is somewhat analogous to FIG. 16;

FIG. 46P is somewhat analogous to FIG. 19;

FIG. 46Q is somewhat analogous to FIG. 20;

FIG. 46R is somewhat analogous to FIG. 22;

FIG. 46S is somewhat analogous to FIG. 27;

FIG. 46T is somewhat analogous to FIG. 28;

FIG. 46U is somewhat analogous to FIG. 29;

FIG. 46V is somewhat analogous to FIG. 32;

FIG. 46W is somewhat analogous to FIG. 33;

FIG. 46X is somewhat analogous to FIG. 34;

FIG. 46Y is somewhat analogous to FIG. 35;

FIG. 46Z is somewhat analogous to FIG. 37;

FIG. 46AA is a new screen that relates to allowing a user to edit his “My 7;”

FIG. 46AB is somewhat analogous to FIG. 38; FIG. 46AC is somewhat analogous to FIG. 39;

FIG. 46AD is a new screen that corresponds to FIG. 44A;

FIG. 46AE is somewhat analogous to FIG. 40.

Weather states (for example, in a “Weather” page as described above) may be expressed according to the illustrations in FIGS. 47A-47F, in which various weather states are shown as Sunny, Mostly Sunny, Clouding Up, Overcast, Rainy, and Stormy, respectively. These states and figures are illustrative only; additional states and other figures are possible. The determination of which weather state, and therefore which illustration, is appropriate for a given user (e.g., to show above the user's avatar) is dynamic according to the Chi of the user's Chi-munity.

In some embodiments, the Weather, and the graphical illustration of the Weather, changes (or is changed) dynamically. For example, in some embodiments, alerts and feeling posts are assigned weather values ranging from high to low (1-6) based on the mood bar and alert level user selects. The weather values for these events, as well as the weather values of the peeps the user has listened to, are combined to determine the overall weather value for the user's avatar. The numerical value is then translated into the weather animations that are displayed above user's avatar. So every update a user posts, and every update the user's peeps post are woven together to form the weather output. Each user then has a unique combination of peeps and alerts that cause their weather to fluctuate.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as preprogrammed hardware elements (e.g., application specific integrated circuits, FPGAs, and digital signal processors), or other related components.

In an alternative embodiment, the disclosed apparatus and methods may be implemented as a computer program product for use with a computer system. Such implementation may include a series of computer instructions fixed either on a tangible medium, such as a non-transient computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software.

The embodiments of the invention described above are intended to be merely exemplary; numerous variations and modifications will be apparent to those skilled in the art. All such variations and modifications are intended to be within the scope of the present invention as defined in any appended claims.

Exhibit A

CHI Computation

Overview

This document describes the design of an embodiment of an algorithm to produce a CHI value. It is intended to provide sufficient implementation detail to guide programming of the algorithm within the application. As much as possible, we have attempted to make the algorithm modular—with small, simple functions linking together to execute the entire algorithm. The paradigm is also to maintain various “state variables” about users, connections, postings, etc., which are used as inputs to functions. Every effort is made to ensure updating and maintaining state variables is fast and efficient.

User State Variable

For each user i, the following state variable are maintained in a database

Feeling value: Vᵢ

Numerical value from 0-100 indicating value of “I'm-feeling” tree or slider bars

#connections: N

Def: Current number of connections to other users in the system

Set of connections: J

Def: A list of all the IDs of other users to which user i is connected

Connection status: For each connection j ∈ J

My-Seven Rank: 0, 1, . . . , 7 (zero means not in “my seven”)

Start Date (date person was added to your connections; used to compute longevity)

Posting frequency: Fᵢ^{P}

Def: exponentially smoothed running average rate at which user i makes postings to the system.

Updated as follows, where Tᵢ^{P} is the elapsed time since the last posting

λₚ is a smoothing parameter between zero and one (typically about 0.05)

$${F}_{i}^{p} = {λ}_{p} {F}_{i}^{p} + ( 1 - {λ}_{p} ) \frac{1}{{T}_{i}^{p}}$$

Response frequency: Fᵢ^{r}

Def: exponentially smoothed running average rate at which user i responds to the postings of their connections.

In some embodiments, responses to “my seven” may be processed differently than response to a user who is not in “my seven” (i.e., a regular connection's postings)

Updated as follows, where Tᵢ^{r} is the elapsed time since the last response to a posting.

λᵣ is a smoothing parameter between zero and one (typically about 0.05)

$${F}_{i}^{r} = {λ}_{r} {F}_{i}^{r} + ( 1 - {λ}_{r} ) \frac{1}{{T}_{i}^{r}}$$

Alert frequency: Fᵢ^{a}

Def: exponentially smoothed running average rate at which user i includes alerts in their postings.

Updated as follows after every posting, where Iᵢ^{p} is equal to one if the user used an alert on posting p and is zero otherwise.

λₐ is a smoothing parameter between zero and one (typically about 0.05)

Fᵢ^{a}=λₐFᵢ^{a}+(1−λₐ)Iᵢ^{p}

Usage frequency: Fᵢ^{u}

Def: exponentially smoothed running average rate at which user i interacts with the system

Updated as follows, where Tᵢ^{u} is the elapsed time since the last interaction with the system

λᵤ a smoothing parameter between zero and one (typically about 0.05)

$${F}_{i}^{u} = {λ}_{u} {F}_{i}^{u} + ( 1 - {λ}_{u} ) \frac{1}{{T}_{i}^{u}}$$

Posting Significance Scoring

Each posting is given a significance score, which is intended to measure the “emotional importance” of a posting. In some embodiments, the method weighs postings with alerts more highly than those without alerts. In some embodiments, the method corrects for the frequency with which the user makes postings and attaches alerts, so that users cannot game the system by posting too often and attaching alerts to everything. A key idea is that we also increase the importance of the posting dynamically as other users respond to it, so users are rewarded for making postings that elicit the response of other users.

Inputs

User state variables

Posting time

Set of responses to-date to the posting: R

For each response r ∈ R we have a response significance score Sᵣ

Parameters

Nominal initial posting value: s₀

indicates value of a post before adjusting for alerts, poster's frequency or responses from connections

Posting alert value a₀ (in some embodiments)

The posting alert value is a scalar value the inflates/deflates the posting value

Values:

Fire: 2.0

Dove: 2.0

Owl: 1.5

Gift: 3.0

Frequency scaling coefficients: αₚ, αₐ

between zero and one; zero indicates all posts have same value regardless of user's posting frequency, while one indicates value of post is deflated proportional to the user's posting frequency

Outputs

Posting significance score: Sₚ

Procedure

begin;

% initialize posting significance value

$${S}_{p} ← {{s}_{0} ( \frac{1}{{F}_{i}^{p}} )}^{{α}_{p}}$$

% adjust for alerts

If {a₀<1 or a₀>1} then

$${S}_{p} ← {S}_{p} {{a}_{0} ( \frac{1}{{F}_{i}^{a}} )}^{{α}_{a}}$$

% Now for each response, increment posting value by corresponding response value

For each r ∈ R do;

Sₚ←Sₚ+Sᵣ

Return Sₚ

Response Significance Scoring

Each response is likewise given a significance score, which is intended to measure the “importance” of a connections response to a posting. In some embodiments, the method weighs responses with alerts more highly than those without alerts. We also correct for the frequency with which the user responds and attaches alerts, so that users cannot game the system by responding too often and attaching alerts to every response.

Inputs

User state variables

Response time

Parameters

Nominal initial response value: r₀

indicates value of a response before adjusting for responder's frequency or alert values

Posting alert value a₀

Values:

Crow: 0.5

Dove: 2.0

Owl: 1.5

Gift: 3.0

My-seven premiums: bₙ for n=0, 1, . . . , 7

These inflate importance if response is from someone in your “my seven”; as an illustrative embodiments, some initial trial values could be:

b₀=1

bₙ=1+0.2*n

Frequency scaling coefficients: αᵣ, αₐ

between zero and one; zero indicates all responses have same value regardless of user's response frequency, while one indicates value of response is deflated proportional to the user's response frequency

Outputs

Response significance score: Sᵣ

Procedure

begin;

% initialize response significance value

$${S}_{r} ← {b}_{n} {{r}_{0} ( \frac{1}{{F}_{i}^{r}} )}^{{α}_{r}}$$

% adjust for alerts

If {a₀<1 or a₀>1} then

$${S}_{r} ← {S}_{r} {{a}_{0} ( \frac{1}{{F}_{i}^{a}} )}^{{α}_{a}}$$

Return Sᵣ

### Scoring Feelings and Updates to Feelings

Feeling values are not good or bad themselves; rather, users are rewarded for reporting feelings/changes in mood. We have to be careful how to measure this, since we don't want to require people to “change their mood” just to get rewarded. In some embodiments, the method confirms the current mood setting or change it, so as to differentiate from just ignoring the mood value altogether. In some embodiments, the method makes adjustments to value for usage frequency?

### Inputs

User state variables
Adjustment time

### Parameters

Feeling adjustment reward: f₀
   Reward for making an adjustment to the mood value
Frequency scaling coefficients: α_{f}
   between zero and one; zero indicates all adjustments have same value regardless of user's interaction frequency, while one indicates value of response is deflated proportional to the user's interaction frequency

### Outputs

Feeling interaction score: S_{f}

### Procedure

$${S}_{f} ← {S}_{f} + {{f}_{0} ( \frac{1}{{F}_{i}^{u}} )}^{{α}_{a}}$$

Return S_{f}

### CHI Calculation

CHI is a cumulative function of the scores from feeling adjustments, postings and responses.

### Inputs

User i state variables
Current time: t
Set of user's postings: P
Set of user's responses: R

### Parameters

Component weights
   Posting score weight: wₚ
   Response score weight: wᵣ
   Feeling score weight: w_{f}

### Outputs

CHI of user i: Cᵢ

### Procedure

$${C}_{i} = {w}_{f} {S}_{f} + {w}_{p} {\sum }_{p ∈ P} {S}_{p} + {w}_{r} {\sum }_{r ∈ R} {S}_{r}$$

Return Cᵢ

What is claimed is:

1. A social networking method, implemented over a computer network with respect to (a) a first user operating a client coupled to the network and (b) a set of other users in the user's social network, the set having at least one member, each member of the set operating a client coupled to the network, the method using computer processes comprising:
receiving over the network, from the first user's client, first user data representative of the first user's emotional condition;
receiving over the network, from each client of each of the other users in the set, outside data representative of such other user's emotional condition;
storing the first user data and the outside data;
using the first user data and the outside data in an algorithm to generate a digital output that is representative of a composite emotional condition for the first user; and
communicating the digital output to the first user's client over the network.

2. A method according to claim 1, the computer processes further comprising:
causing the digital output to be represented on the first user's client at least in part by a graphical image.

3. A method according to claim 1, the computer processes further comprising, with respect to each of the other users, generating a digital output that is representative of a composite emotional condition for such other user, such output reflecting in part emotional condition data for users other than such other user, and communicating the digital output to such other user's client over the network.

4. A method according to claim 1, the computer processes further comprising:
communicating the digital output that is representative of a composite emotional condition for the first user to a second set of users with whom the first user has agreed to share the digital output.

5. A method according to claim 1, wherein the digital output that is representative of a composite emotional condition for the first user includes a numerical score therefor.

6. A method according to claim 3, wherein the digital output that is representative of a composite emotional condition for such other user includes a numerical score therefor.

7. A method according to claim 5, wherein the digital output includes data for a graphic representation of the composite emotional condition for the first user.

8. A method according to claim 6, wherein the digital output includes data for a graphic representation of the composite emotional condition for such other user.

9. A method according to claim 7, wherein the graphic representation of the composite emotional condition for such other user comprises a graphical representation of a weather state.

10. A method according to claim 2, wherein the graphical image includes an anthropomorphic portion having characteristics that change dynamically in response to changes in digital output that is representative of a composite emotional condition for the first user.

11. A method according to claim 10, wherein the graphical image includes an image of a person.

12. A method according to claim 11, wherein the anthropomorphic characteristics include facial features.

13. A method according to claim 10, wherein the anthropomorphic characteristics include posture of a person.

14. A method according to claim 1, wherein the first user data representative of the first user's emotional condition is numeric and is based at least in part on an input by the first user that is a self-assessment of the first user's emotional condition.

15. A method according to claim 14, wherein outside data representative of each such other user's emotional condition is numeric and is based on an input by such other user that is a self-assessment of each such other user's emotional condition.

16. A method according to claim 15, wherein the first user data representative of the first user's emotional condition also includes postings and responses by the first user.

17. A method according to claim 16, wherein the outside data representative of each of such other users' emotional condition also includes responses by each such other user to postings and responses by the first user.

18. A method according to claim 16, wherein operation of the algorithm is event-driven, by a new posting or response implicating the first user.

19. A method according to claim 14, wherein the first user data provided to the algorithm includes frequency of changes by the first user of such user's self-assessment as an input.

20. A method according to claim 19, wherein the frequency of the changes by the first user of such first user's self-assessment is an input to the algorithm to the exclusion of the first user's self-assessment itself.
